(19) United States
(12) Patent Application Publication
(10) Pub. No.: US 2025/0197030 A1
(43) Pub. Date: Jun. 19, 2025

(54) SMALL LEO SATELLITE SYSTEMS AND METHODS

(71) Applicant: FLEET SPACE TECHNOLOGIES PTY LTD, Beverley, South Australia (AU)

(72) Inventors: Nicollas Alexandre Vieira de Freitas PEREIRA, Beverley, South Australia (AU); Ian PARTIS, Beverley, South Australia (AU); Flavia TATA NARDINI, Beverley, South Australia (AU); Matthew James PEARSON, Beverley, South Australia (AU); Mohmed SALAH, Beverley, South Australia (AU); Zahra ESMATI, Beverley, South Australia (AU); Abdullah SAED, Beverley, South Australia (AU); Thomas Jacob VERCO, Beverley, South Australia (AU)

(21) Appl. No.: 18/719,757

(22) PCT Filed: Oct. 31, 2022
(86) PCT No.: PCT/AU2022/051310

§ 371 Date: Jun. 13, 2024

(30) Foreign Application Priority Data
Dec. 2, 2021 (AU) 2021903909
Jun. 27, 2022 (AU) 2022901792

(51) Int. Cl. B64G 1/44; B64G 1/10; B64G 1/22

(52) U.S. Cl. CPC B64G 1/443; B64G 1/1007; B64G 1/2222

(57) ABSTRACT

Embodiments generally relate to small satellites. Example small satellites may include a satellite body having a rectangular tile shape, with a substantially flat front side having a length and width and being separated from a substantially parallel back side by a depth, wherein the depth is equal to or less than a third of the length and the width. A patch antenna array may be positioned on the front side and/or a large patch antenna may be positioned centrally on the front side. A solar panel may be positioned on or coupled to the back side.

### TECHNICAL FIELD

Embodiments relate to satellites and satellite communication systems and methods. In particular, embodiments relate to low Earth orbit (LEO) satellite systems.

### BACKGROUND

Positioning sensors in remote environments may provide beneficial information in various economic or environmental contexts. For example, in a remote mining operation, information from sensors positioned in remotely located machinery may be beneficial for managing and improving the remote mining operation. Similarly, for a remotely located farm, information from various sensors positioned on livestock or sensors positioned on the ground may be beneficial in managing and planning operations at the remotely located farm.

Conventional large satellites are typically in geostationary orbit around the Earth. Such satellites are often expensive to build and to launch. LEO satellites can help to fill an increasing need for data communication between terrestrial devices and can be orders of magnitude cheaper than a geostationary orbit satellite to build and launch.

Access to information from remote environments presents several technical challenges. In remote environments, there may be significant connectivity and power supply issues. Prior sensor networks and gateways may not provide reliable and rich access to information generated by sensors positioned in remote environments because of a lack of connectivity and power. If connectivity is possible, for example via a satellite uplink, then the current and anticipated future cost of using such an uplink is typically prohibitively high for many sensor deployment scenarios. A satellite uplink using a LEO satellite may often have significant limitations of bandwidth and may have limited time windows over which communication is feasible. Further, the size, power supply and thermal dissipation limitation in LEO satellites present additional challenges for a LEO satellite.

It is desired to address or ameliorate one or more shortcomings or disadvantages of prior small satellites, such as LEO nanosatellites or microsatellites, or to at least provide a useful alternative thereto.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

Some embodiments relate to a small satellite that includes: a satellite body having a rectangular tile shape, with a substantially flat front side having a length and width and being separated from a substantially parallel back side by a depth, wherein the depth may be equal to or less than a third of the length and the width; an antenna array on the front side; and a solar array including at least one solar panel extendable from the back side in a generally lateral direction.

In some embodiments, the at least one solar panel may be extendable from the back side in a direction generally parallel to a plane of the front side. The at least one solar panel may include multiple solar panels, wherein the multiple solar panels may include a first wing extendable from a first lateral side of the back side and a second wing extendable from an opposite second lateral side of the back side. Each of the first and second wings may include at least one solar panel.

In some embodiments, the first wing may be configured to lie over the back side when the first wing is in a stowed position and the second wing may be configured to lie over the back side when the second wing is in a stowed position. The first wing may be configured to lie over the second wing when the first wing and the second wing are in the stowed position.

In some embodiments, wherein in an extended position of the first wing and the second wing, the first wing and the second wing extend generally laterally from the back side.

Some embodiments relate to a small satellite that includes: a housing containing satellite electronic components for controlling operation of the small satellite, the housing may comprise a chassis and defining a first major face, a second major face opposite the first major face and four minor side faces extending between the first and second major faces; a patch antenna array disposed across or over the first major face; and a solar panel assembly which may comprise multiple panels coupled to the chassis and deployable from a contracted configuration, in which the panels lie over the second major face, to an expanded configuration, in which the panels extend away from the second major face.

In some embodiments, the solar array may include a solar panel fixed to the back side. In a non-extended position of the solar array, one solar panel may face away from the satellite body.

In some embodiments, the antenna array may include a patch antenna array. The patch antenna array may include between 4 and 625 patch antennas. Each patch antenna may have a corrugated patch configuration. Each patch antenna may be a cupped stacked patch antenna. The antenna array may cover substantially a whole of the front side of the small satellite.

In some embodiments, the depth of the satellite body may be between about 90 mm and about 220 mm. The length of the satellite body may be between about 270 mm and about 1050 mm. The width of the satellite body may be between about 270 mm and about 1050 mm. The width may be substantially the same as the length. The width may be within 10% of the length.

In some embodiments, the small satellite may further include a microsatellite or nanosatellite chassis that may house at least one processor, a memory accessible to the at least one processor, the memory may store an orbital schedule of the LEO satellite, and a communication sub-system accessible to the at least one processor; wherein the communication sub-system may comprise a reconfigurable digital logic processing device in communication with the antenna array; wherein the at least one processor may be in communication with the reconfigurable digital logic processing device, and wherein the at least one processor may be configured to dynamically reconfigure the reconfigurable digital logic processing device to perform directional beamforming based on the orbital schedule by applying different transfer functions to signals simultaneously received or transmitted by multiple antenna elements of the antenna array over time.

In some embodiments, the at least one processor may be configured to perform directional beamforming using all antenna elements of the antenna array simultaneously. The at least one processor may be further configured to dynamically reconfigure the reconfigurable digital logic processing device to perform directional beam-nulling based on the orbital schedule by applying different transfer functions to signals received and transmitted by multiple antenna elements of the antenna array over time. The directional beamforming and/or beam-nulling may be performed simultaneously across multiple frequency channels. The directional beamforming and/or beam-nulling may be performed simultaneously in multiple different directions.

In some embodiments, the orbital schedule data may comprise one or more antenna array configuration records, each antenna array configuration record may comprise: an ephemeris record indicating a scheduled position of the LEO satellite in orbit over a period of time; and array factor coefficients associated with each of the two or more antenna elements defined in relation to the ephemeris record.

In some embodiments, the satellite may further comprise a signal channeliser for channelising signals before processing by the reconfigurable digital logic processing device. The reconfigurable digital logic processing device may comprise a Field Programmable Gate Array (FPGA).

In some embodiments, the satellite may receive signals from multiple directions of interest, the at least one processor may dynamically reconfigure the reconfigurable digital logic processing device to level amplitudes of signals received from the multiple directions of interest; and wherein the satellite may transmit signals to multiple directions of interest, the at least one processor may dynamically reconfigure the reconfigurable digital logic processing device to level amplitudes of signals transmitted to the multiple directions of interest.

In some embodiments, the satellite may have a mass in the range of 5 kg to 500 kg. The satellite may have a mass in the range of 10 kg to 100 kg.

In some embodiments, the satellite may be configured for deployment into low Earth orbit.

In some embodiments, each antenna of the antenna array may be 3D printed.

In some embodiments, a method for providing a satellite communication service may include providing the satellite as a payload to a satellite launch vehicle. Wherein the method may further include, before the providing, stacking multiple ones of the satellite in a satellite deployment apparatus that may be sized to fit in a payload space of the satellite launch vehicle. The providing may include providing a stack of multiple ones of the satellite as a payload to the satellite launch vehicle.

In some embodiments, a method for deploying a satellite may comprise launching a satellite launch vehicle containing the satellite that may be configured to release the satellite for travel in a low Earth orbit. The satellite launch vehicle may contain multiple ones of the satellite and may be configured to release each of the multiple satellites for travel in low Earth orbit. The satellite launch vehicle may contain a satellite deployment apparatus releasably securing the multiple satellites and may be configured to sequentially or simultaneously release the multiple satellites for travel in low Earth orbit. The satellite launch vehicle may carry in a payload space of the vehicle at least one satellite.

Some embodiments relate to a small satellite that includes: a satellite body having a rectangular tile shape, with a substantially flat front side having a length and width and being separated from a substantially parallel back side by a depth, wherein the depth may be equal to or less than a third of the length and the width; at least one antenna array of a first type and an antenna array of a second type on the front side; and a solar panel on the back side.

In some embodiments, the at least one antenna array of the first type may be an S band antenna array and the antenna array of the second type may be a UHF antenna array. In some embodiments, the at least one antenna array of the first type may be an X band antenna array. The at least one antenna array of the first type and the antenna array of the second type may be spatially separated from each other on the front side.

In some embodiments, the at least one antenna array of the first type may include two antenna arrays, each of the two antenna arrays may be positioned on opposite sides of the antenna array of the second type.

In some embodiments, the at least one antenna array of the first type and the antenna array of the second type may each include a patch antenna array. The patch antenna array may include between 1 and 4 patch antennas. The patch antenna array of the at least one antenna array of the first type may have a corrugated patch configuration. The patch antenna array of the at least one antenna array of the first type may be a cupped stacked patch antenna array.

The patch antenna array of the antenna array of the second type may be a corrugated patch configuration. The patch antenna array of the antenna array of the second type is a cupped stacked patch antenna array. In some embodiments, each antenna of the at least one antenna array of the first type and each antenna of the antenna array of the second type may be 3D printed.

Some embodiments relate to a small satellite that includes: a satellite body having a rectangular tile shape, with a substantially flat front side having a length and width and being separated from a substantially parallel back side by a depth, wherein the depth is equal to or less than a third of the length and the width; a large patch antenna positioned centrally on the front side; and a solar panel on the back side.

In some embodiments, the large patch antenna may be a UHF patch antenna. The large patch antenna may be 3D printed. The large patch antenna may have a corrugated patch configuration. The large patch antenna may be a cupped patch antenna.

In some embodiments, the small satellite may further include at least one antenna array on the front side.

Some embodiments relate to a small satellite that includes: a satellite body having a rectangular tile shape, with a substantially flat front side having a length and width and being separated from a substantially parallel back side by a depth, wherein the depth is equal to or less than a third of the length and the width; an antenna on the front side, wherein the antenna occupies 50% to 75% of the surface area of the front side; and a solar panel on the back side.

In some embodiment, the antenna may be a UHF patch antenna. The antenna may occupy 55% to 70% of the surface of the front side. The antenna may occupy 60% to 65% of the surface of the front side. The antenna may be a cupped patch antenna.

In some embodiments, the small satellite may further include at least one antenna array, such as an S band antenna array, on the front side.

In some embodiments, the length and the width of the front side and a length and a width of the back side may be substantially the same.

In some embodiments, the satellite body may further include a support structure having a cross-like shape, the support structure may include a plurality of support beams and a first connecting panel and a second connecting panel coupled to the plurality of support beams.

Some embodiments relate to a small satellite that includes: a satellite body having a rectangular tile shape, with a substantially flat front side having a length and width and being separated from a substantially parallel back side by a depth, wherein the depth is equal to or less than a third of the length and the width; a support structure having a cross-like shape, the support structure may include a plurality of support beams and a first connecting panel and a second connecting panel coupled to the plurality of support beams; a plurality of antennae on the front side; and a solar panel on the back side.

In some embodiments the satellite body may further include at least one front panel coupled to at least two of the plurality of support beams and the first connecting panel. The satellite body may further include at least one back panel coupled to at least two of the plurality of support beams and the second connecting panel. The satellite body may further include at least one side panel coupled to the support structure.

In some embodiments, the plurality of support beams may include a first support beam, a second support beam, a third support beam, and a fourth support beam, wherein the first support beam, the second support beam, and the third support beam have a same length and the fourth support beam is of a shorter length than the first support beam, the second support beam, and the third support beam.

In some embodiments, the small satellite may further include a propulsion system internally coupled to one end of the fourth support beam so that an external face of the propulsion system is substantially flush with a side surface of the satellite body.

The satellite body may further include a plurality of mounting points adjacent to respective corners on the front side, each mounting point being configured for releasable coupling of the satellite to a deployment container.

In some embodiments, the solar panel may substantially cover the back side.

Some embodiments relate to a small satellite that includes: a housing containing satellite electronic components for controlling operation of the small satellite, the housing comprising a chassis and defining a first major face having a length and a width, a second major face opposite the first major face having the same length and the same width, and four minor side faces extending between the first and second major faces by a depth, wherein the depth is equal to or less than a third of the length and the width; a first antenna array, a second antenna array, and a third antenna array spatially separated from each other on the first major face; and a solar panel on the second major face.

In some embodiments, the first antenna array and the second antenna array may be S band antenna arrays, and the third antenna array may be a UHF antenna array. The first antenna array and the second antenna array may be disposed on opposite sides of the third antenna array on the first major face.

In some embodiments, the first antenna array, the second antenna array, and the third antenna array each include a patch antenna array. The patch antenna array may include between 1 and 4 patch antennas. The patch antenna arrays may have a corrugated patch configuration. The patch antenna arrays may be a cupped stacked patch antenna array.

In some embodiments, the housing may further include a support structure having a cross-like shape, the support structure may include a plurality of support beams and a first connecting panel and a second connecting panel coupled to the plurality of support beams.

The housing may further include at least one front panel coupled to at least two of the plurality of support beams and the first connecting panel. The housing may further include at least one back panel coupled to at least two of the plurality of support beams and the second connecting panel. The housing may include at least one side panel coupled to the support structure.

In some embodiments, the plurality of support beams may include a first support beam, a second support beam, a third support beam, and a fourth support beam, wherein the first support beam, the second support beam, and the third support beam have a same length and the fourth support beam is of a shorter length than the first support beam, the second support beam, and the third support beam.

In some embodiments, the small satellite may include a propulsion system internally coupled to an end of the fourth support beam so that an external face of the propulsion system is substantially flush with a side surface of the satellite body.

In some embodiments, the housing may further include a plurality of mounting points adjacent to respective corners on the front side, each mounting point being configured for releasable coupling of the satellite to a deployment container.

In some embodiments, the solar panel may substantially cover the second major face.

In some embodiments, the third antenna array may be positioned centrally on the first major face and may be larger than the first antenna array and the second antenna array.

In some embodiments, an area of the first major face and an area of the second major face may be substantially the same.

In some embodiments, each antenna of the first antenna array, the second antenna array, and the third antenna array may be 3D printed.

In some embodiments, the depth of the satellite may be between about 90 mm and about 220 mm. The length of the satellite may be between about 270 mm and about 1050 mm. The width of the satellite may be between about 270 mm and about 1050 mm. The width may be substantially the same as the length. The width may within 10% of the length.

In some embodiments, the satellite may have a mass in the range of 5 kg to 500 kg. The satellite may have a mass in the range of 10 kg to 100 kg, such as 20 kg or 25 kg to 80 kg. For example, the satellite may have a mass in the range of 25 kg to 40 kg.

In some embodiments, the satellite may be configured for deployment into low Earth orbit.

In some embodiments, the small satellite of the aforementioned embodiments may further include a microsatellite or nanosatellite chassis housing at least one processor, a memory accessible to the at least one processor, the memory may store an orbital schedule of the LEO satellite, and a communication sub-system accessible to the at least one processor; wherein the communication sub-system may comprise a reconfigurable digital logic processing device in communication with each antenna array; wherein the at least one processor may be in communication with the reconfigurable digital logic processing device, and wherein the at least one processor may be configured to dynamically reconfigure the reconfigurable digital logic processing device to perform directional beamforming based on the orbital schedule by applying different transfer functions to signals simultaneously received or transmitted by multiple antenna elements of each antenna array over time.

In some embodiments, the at least one processor may configured to perform directional beamforming using all antenna elements of the antenna array simultaneously. The at least one processor may be further configured to dynamically reconfigure the reconfigurable digital logic processing device to perform directional beam-nulling based on the orbital schedule by applying different transfer functions to signals received and transmitted by multiple antenna elements of the antenna array over time.

In some embodiments, the directional beamforming and/or beam-nulling may be performed simultaneously across multiple frequency channels. The directional beamforming and/or beam-nulling may performed simultaneously in multiple different directions.

In some embodiments, the orbital schedule data may comprise one or more antenna array configuration records, each antenna array configuration may comprise: an ephemeris record indicating a scheduled position of the LEO satellite in orbit over a period of time; and array factor coefficients associated with each of the two or more antenna elements defined in relation to the ephemeris record.

The small satellite may further comprise a signal channeliser for channelising signals before processing by the reconfigurable digital logic processing device. The reconfigurable digital logic processing device may comprise a Field Programmable Gate Array (FPGA).

In some embodiments, the satellite may receive signals from multiple directions of interest, the at least one processor may dynamically reconfigure the reconfigurable digital logic processing device to level amplitudes of signals received from the multiple directions of interest. When the satellite transmits signals to multiple directions of interest, the at least one processor may dynamically reconfigure the reconfigurable digital logic processing device to level amplitudes of signals transmitted to the multiple directions of interest.

In some embodiments, the satellite may have a mass in the range of 25 kg to 35 kg.

Some embodiments relate to a method for providing a satellite communication service. The method may include: providing the satellite of any of the aforementioned embodiments as a payload to a satellite launch vehicle.

In some embodiments, the method may further include, before the providing, stacking multiple ones of the satellite in a satellite deployment apparatus that is sized to fit in a payload space of the satellite launch vehicle.

The providing may include providing a stack of multiple ones of the satellite as a payload to the satellite launch vehicle.

In some embodiments the method may comprise launching a satellite launch vehicle containing the satellite of any one of claims 41 to 109 and configured to release the satellite for travel in a low Earth orbit.

The satellite launch vehicle may contain multiple ones of the satellite and is configured to release each of the multiple satellites for travel in low Earth orbit.

The satellite launch vehicle may contain a satellite deployment apparatus releasably securing the multiple satellites and configured to sequentially or simultaneously release the multiple satellites for travel in low Earth orbit.

Some embodiments relate to a satellite launch vehicle. The satellite launch vehicle may carry in a payload space of the vehicle at least one satellite according to any one of aforementioned embodiments.

### BRIEF DESCRIPTION OF DRAWINGS

FIG. 1 is a block diagram of a communication system including a small satellite according to some embodiments;

FIG. 2 is a schematic diagram of a signal processing part of a communication system of a LEO satellite according to some embodiments;

FIG. 3 is schematic diagram of a digital beam forming part of the communication system according to some embodiments;

FIG. 4 is a schematic diagram illustrating signal processing operations performed by a digital logic processing part of the communication system according to some embodiments;

FIG. 5A is a front perspective view of an LEO satellite in a stowed configuration according to some embodiments;

FIG. 5B is a back perspective view of the LEO satellite of FIG. 5A;

FIG. 5C is a bottom end view of the satellite shown in FIG. 5A;

FIG. 5D is a front view of the satellite shown in FIG. 5A;

FIG. 5E is a back view of the satellite shown in FIG. 5A;

FIG. 6A is a front perspective view of the LEO satellite of FIG. 5A to 5E in an extended configuration according to some embodiments;

FIG. 6B is a back perspective view of the LEO satellite shown in FIG. 6A;

FIG. 6C is a plan view of the satellite shown in FIG. 6A;

FIG. 6D is a top elevation view of the satellite shown in FIG. 6A;

FIG. 6E is a plan view of the satellite shown in FIG. 6B;

FIG. 7 is a schematic diagram of a configuration of internal subsystems of the satellite shown in FIG. 5A;

FIG. 8 is a schematic diagram of an example patch antenna array;

FIG. 9 is a plan view of an example stacked patch antenna array of the communication system;

FIG. 10 is a side cross-section view of an example stacked patch antenna of the antenna array shown in FIG. 9;

FIG. 11 is a side cross-sectional view of an antenna element for a stacked patch antenna according to some embodiments;

FIG. 12 is a flowchart of a method of communication between the at least one LEO satellite and the plurality of terrestrial gateway devices;

FIG. 13 is a perspective view of an example LEO satellite deployment apparatus according to some embodiments;

FIG. 14 is a flowchart of a method launching a satellite launch vehicle configured to deploy LEO satellites in orbit;

FIG. 15A is a schematic illustration of a satellite launch vehicle configured to deploy LEO satellites in orbit;

FIG. 15B is a schematic illustration of a satellite launch vehicle preparing to deploy LEO satellites in orbit;

FIG. 15C is a schematic illustration of a satellite launch vehicle ready to deploy LEO satellites in orbit;

FIG. 16 is a side cross-sectional view of a single antenna according to some embodiments;

FIG. 17 is a perspective view of a portion of an antenna array according to some embodiments, showing a tuning element in further detail;

FIG. 18 is a perspective view of a portion of an antenna array according to some embodiments, showing the tuning element in further detail;

FIG. 19 is a schematic illustration of the internal subsystems of an LEO satellite according to some embodiments;

FIG. 20 is a schematic diagram of an antenna array according to some embodiments;

FIG. 21 is a schematic diagram of an antenna array according to some embodiments;

FIG. 22 is a schematic diagram of an antenna array according to some embodiments;

FIG. 23 is a schematic diagram of an antenna array according to some embodiments;

FIG. 24 is a three-dimensional front view of the LEO satellite according to some embodiments;

FIG. 25 is a three-dimensional back view of the LEO satellite according to some embodiments;

FIG. 26A is a back perspective view of an LEO satellite, according to some embodiments;

FIG. 26B is a back perspective view of the LEO satellite of FIG. 26A including solar panels, according to some embodiments;

FIG. 27A is a front perspective view of the LEO satellite of FIG. 26A, according to some embodiments;

FIG. 27B is a front perspective view of the LEO satellite of FIG. 26A including a plurality of antennae, according to some embodiments;

FIG. 28A is a back perspective view of the LEO satellite of FIG. 26A, according to some embodiments;

FIG. 28B is a back perspective view of the LEO satellite of FIG. 26A, according to some embodiments;

FIG. 29 is a perspective view of a support structure of the LEO satellite of FIG. 26A;

FIG. 30 is an exploded-view of an antenna according to some embodiments;

FIG. 31A is a top perspective view of a ground plane of the antenna of FIG. 30, according to some embodiments;

FIG. 31B is a bottom perspective view of a ground plane of the antenna of FIG. 30, according to some embodiments;

FIG. 31C is half-section side view of a ground plane of the antenna of FIG. 30, according to some embodiments;

FIG. 32A is a top perspective view of a first patch of the antenna of FIG. 30, according to some embodiments;

FIG. 32B is a bottom perspective view of a first patch of the antenna of FIG. 30, according to some embodiments;

FIG. 32C is a half-section side view of a first patch of the antenna of FIG. 30, according to some embodiments;

FIG. 33A is a top perspective view of a second patch of the antenna of FIG. 30, according to some embodiments;

FIG. 33B is a bottom perspective view of a second patch of the antenna of FIG. 30, according to some embodiments;

FIG. 33C is a half-section side view of a second patch of the antenna of FIG. 30, according to some embodiments;

FIG. 34A is a top perspective view of a PCB cover of the antenna of FIG. 30, according to some embodiments;

FIG. 34B is a bottom perspective view of a PCB cover of the antenna of FIG. 30, according to some embodiments;

FIG. 34C is a half-section side view of a PCB cover of the antenna of FIG. 30, according to some embodiments;

FIG. 35 is a back perspective view of an LEO satellite, according to some embodiments;

FIG. 36 is a front perspective view of the LEO satellite of FIG. 35, according to some embodiments;

FIG. 37 is a side view of the LEO satellite of FIG. 35, according to some embodiments;

FIG. 38 is an alternate side view of the LEO satellite of FIG. 35, according to some embodiments;

FIG. 39 is a half-section back perspective view of the LEO satellite of FIG. 35, according to some embodiments;

FIG. 40 is an alternate front perspective view of the LEO satellite of FIG. 35, according to some embodiments;

FIG. 41 is an alternate side view of the LEO satellite of FIG. 35, according to some embodiments;

FIG. 42A is a side view of an antenna mounting structure shown in FIG. 40, according to some embodiments;

FIG. 42B is a perspective view of an antenna mounting structure shown in FIG. 40, according to some embodiments; and

FIG. 42C is an alternate perspective view of an antenna mounting structure shown in FIG. 40, according to some embodiments.

### DETAILED DESCRIPTION

Described embodiments generally relate to LEO satellites for communication. Particular embodiments relate to the design and contents of LEO satellites. LEO satellites comprise satellites that orbit the Earth at an altitude of 2000 km or less. LEO satellites have an orbital period (time to complete an orbit around the Earth) of 128 minutes or less, sometimes closer to 90 minutes. The lower altitude and short orbital period of an LEO satellite gives it a field of view that is both small in terms of the area of Earth covered and the duration of coverage of a particular area. Accordingly, there is a need to make LEO satellite systems more efficient and cost effective to best counter the limited field of view and the short duration of the field of view by allowing for greater coverage of LEO satellites over a certain terrestrial area.

Throughout this specification the term “small satellite” will be understood to mean a satellite of a mass less than 500 kg, including minisatellites, microsatellites, and nanosatellites.

The terrestrial communication systems of the embodiments may comprise gateway devices described in PCT Application No. PCT/AU2019/050429 filed 9 May 2019 and titled “Remote LPWAN gateway with backhaul over a high-latency communication system”, the contents of which are hereby incorporated by reference. Such gateway devices may have limited uplink power and so efficient communication with the LEO satellite is important in order to be able to conserve power and maximise data transmission.

The communication systems of the embodiments may comprise technology and methods described in PCT Application No. PCT/AU202/050395 filed 30 Apr. 2021 and titled “LEO Satellite Communications Systems and Methods”, the contents of which are hereby incorporated by reference.

The antennae of the embodiments may comprise technology and methods described in PCT Application No. PCT/AU2021/050399 filed 30 Apr. 2021 and titled “Beamforming Antennas for LEO Satellite Communication”, the contents of which are hereby incorporated by reference.

Launching satellites involves significant costs and the costs of launching are significantly higher for LEO satellites with greater mass. Accordingly, the mass of a LEO satellite is often limited by the costs of launching the LEO satellite into orbit. LEO satellites are often powered by solar cells arranged to charge one or more batteries. Because of the mass and volume limitations of small satellites, the capacity to generate power by the solar cells is also limited. The availability of solar power is also constrained by the position of the satellite in its orbit and the exposure to solar power available to the satellite as it orbits the Earth. This in turn limits the power available to the various electronic components of the LEO satellite. The power limitations impose restrictions on the nature and number of electronic components that may be incorporated in a LEO satellite.

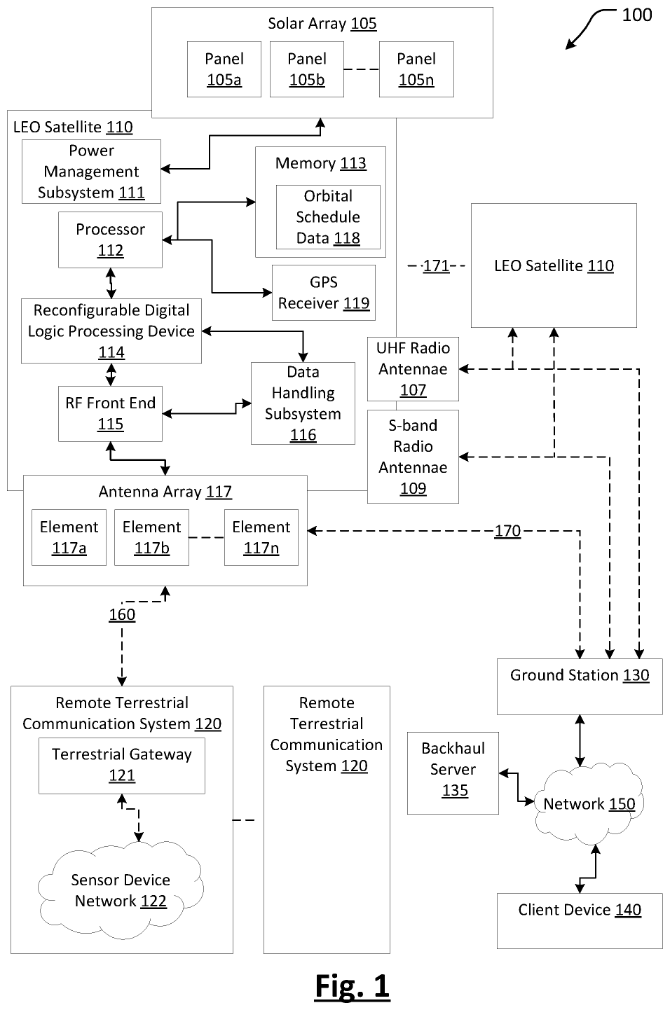

FIG. 1 shows a satellite communication system 100 according to various embodiments. The satellite communication system 100 includes at least one, and possibly many, satellite 110, which in various embodiments is intended for deployment in low Earth orbit. For example, the low Earth orbit altitude may be within a range of about 500 km to 600 km, optionally around 582 km, from the Earth's surface. LEO satellite 110 of some embodiments comprise a chassis and housing panels for housing the various electronic and communication components of the LEO satellite 110. The configuration and dimensions of the chassis are selected to enable the efficient utilisation of space and efficient thermal dissipation. LEO satellites also have a limited capacity to radiate thermal power to cool down the various components of the satellite that generate heat. Average per-orbit thermal dissipation capability may be approximately 40-45 W. In some embodiments, the various power-consuming components may be turned on or off to manage the overall consumption of power and the need for thermal dissipation by the satellite.

LEO satellite 110 may keep track of their position using a GPS signal receiver 119 fitted on the LEO satellite 110. In some embodiments, LEO satellite 110 comprises orbit scheduling data 118 provided in a memory 113 on the LEO satellite 110. The orbit scheduling data may be executable by a processor 112 on board the LEO satellite 110 to determine a coordinate position of the LEO satellite 110 at any instance of time. Orbit scheduling data 118 may relate to acceleration and initial velocity information. Using the position information available, the LEO satellite 110 may adaptively turn on or off the various power-consuming components to manage the overall consumption of power and the need for thermal dissipation by the satellite, such as reconfigurable digital logic processing device 114, RF front end 115, data handling subsystem 116, antenna array 117, and GPS receiver 119.

The various components within the LEO satellite 110 may have different requirements for thermal dissipation. Some components may generate more heat in comparison to the rest of the components. In some embodiments, the components generating more heat may be located closer to the chassis (i.e. an outer frame) of the LEO satellite 110 to improve thermal dissipation. Components requiring a lower rate of thermal dissipation may be placed internally away from the chassis. In some embodiments, thermal straps may be used to improve thermal dissipation. Thermal straps may assist in conducting heating from within the LEO satellite 110 to its chassis. In particular, components positioned away from the chassis may be provided with heat straps to conduct heat away from the components.

Embodiments may rely on communication protocols that are designed for low power consumption. The terrestrial communication systems transmitting signals to the LEO satellite 110 may be located in remote locations where power supply or availability thereof may be limited. The communication protocols employed by the terrestrial communication systems may be specifically selected to reduce the power consumption in transmission, reception, and processing of the signals in the LEO satellite 110.

The mass of the LEO satellite 110 of various embodiments may be within a range of about 1 kg to 100 kg, 10 kg to 50 kg, or 10 kg to 100 kg, for example. The mass of the LEO satellite 110 of various embodiments may be within a range of 20 kg to 50 kg, for example. Example masses further include 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 and 50 kg. A satellite with a mass between 10 kg to 100 kg may be referred to as a microsatellite. A satellite with a mass between 1 kg to 10 kg may be referred to as a nanosatellite.

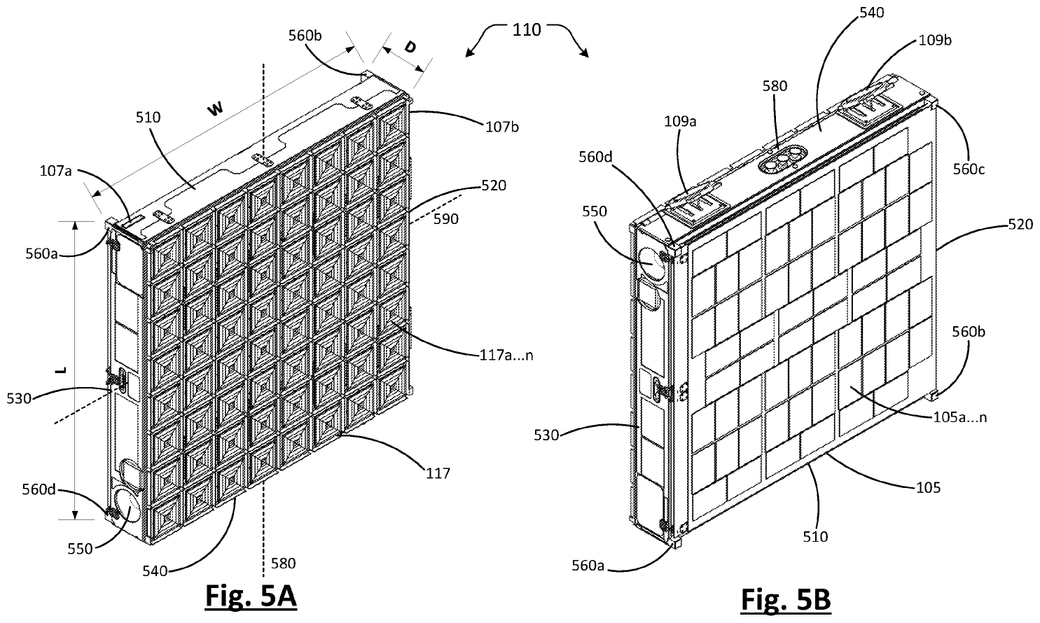

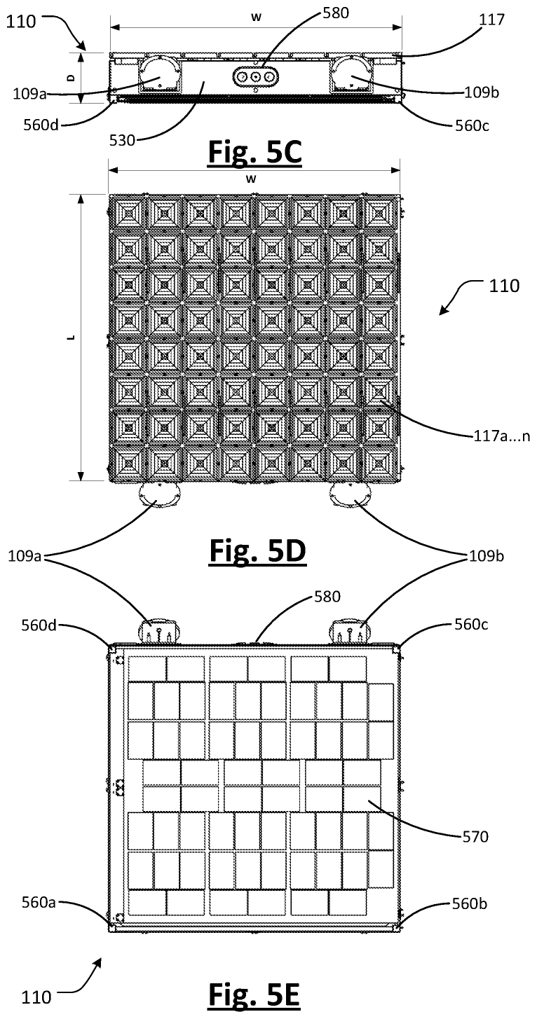

The length (L as shown in FIG. 5A) of the LEO satellite 110 of various embodiments may be within a range of about 270 mm to 1050 mm, 400 mm to 800 mm, or 500 mm to 600 mm, for example. Example lengths further include 275, 325, 350, 375, 425, 450, 475, 525, 550, 575, 625, 650, 675, 725, 750, 775, 825, 850, 875, 925, 950, 975, 1000 and 1025 mm.

The width (W as shown in FIG. 5A) of the LEO satellite 110 of various embodiments may be within a range of about 270 mm to 1050 mm, 400 mm to 800 mm, or 500 mm to 600 mm, for example. Example widths further include 275, 325, 350, 375, 425, 450, 475, 525, 550, 575, 625, 650, 675, 725, 750, 775, 825, 850, 875, 925, 950, 975, 1000 and 1025 mm.

The depth (Z as shown in FIG. 5A) of the LEO satellite 110 of various embodiments may be within a range of about 90 mm to 210 mm, 125 mm to 175 mm, or 140 mm to 160 mm, for example. Example depths further include 95, 105, 110, 115, 120, 125, 130, 135, 140, 145, 150, 155, 160, 165, 170, 175, 180, 185, 190, 195, and 205 mm. The depth of the LEO satellite 110 of various embodiments may be equal to or less than a third of the length or the width of the LEO satellite 110.

In some embodiments, the length (L) may be around half of the width (W) of LEO satellite 110. The length may be around 300 mm and the width around 600 mm, for example. In some embodiments, the width (W) may be around half of the length (L) of LEO satellite 110. The width may be around 300 mm and the length around 600 mm, for example.

The depth, length, and width of the LEO satellite 110 of various embodiments may be configured to have a surface area to volume ratio selected to allow efficient heat transfer. LEO satellite 110 may have surface area to volume ratio of between about 40:1 and about 10:1. Some embodiments may have a surface area to volume ratio of between about 35:1 and about 12:1. For example, some embodiments may have surface area to volume ratio of between of about 33:1 for a satellite with length of 300 mm, width of 300 mm, and depth of 100 mm. In another example, some embodiments may have surface area to volume ratio of between of about 20:1 for a satellite with length of 600 mm, width of 600 mm, and depth of 150 mm. In another example, some embodiments may have surface area to volume ratio of between of about 14:1 for a satellite with length of 1000 mm, width of 1000 mm, and depth of 200 mm, for example.

The LEO satellite 110 of various embodiments may include reflective foil to minimise heat absorption from the sun, and/or may include heat radiating fins in order to dissipate excess heat via radiation. A satellite is considered to have both a hot side and a cold side of operation. The hot side is the side of the satellite that is intended to be directed towards the sun and primarily used for power generation by means of solar energy. The cold side is the side of the satellite that is intended to be directed away from the sun and to face an opposite direction to the hot side, typically toward the Earth.

The LEO satellite 110 may also include a means of transferring heat within the satellite. In some embodiments, the LEO satellite 110 may include heat transfer pipes comprised of highly thermally conductive material, allowing for the transfer of heat from the back, or hot side, of the LEO satellite 110 to the front, or cold side, of the LEO satellite 110 to be dissipated via radiation, for example. This can also serve as a means of maintaining structural integrity by keeping the temperature difference between different sections of the LEO satellite 110 low to reduce mechanical stress. The hot side of the LEO satellite 110 may expand due to the heat absorbed by the sun, whereas the cold side of the LEO satellite 110 is not exposed to the same heat and does not expand, causing increased mechanical stress, for example.

FIG. 1 is a block diagram of a LEO satellite communication system 100 according to some embodiments. The LEO communication system 100 comprises both terrestrial and satellite components that are configured to communicate with each other to provide a communication service. The LEO communication system 100 comprises one or more LEO Satellites 110; one or more remote terrestrial communication systems 120, and at least one ground station 130 in communication with a network 150 through which a backhaul server 135 or a client device 140 may interact with the communication system 100. One goal of the communication system 100 is to make the data gathered by the remote terrestrial communication system 120 readily available (although at high latency) to the client device 140, while dealing with the communication constraints of conveying information from remote locations through the LEO satellite 110 to the client device 140.

The remote terrestrial communication system 120 comprises a sensor device network 122 that may be configured to wirelessly communicate with a terrestrial gateway 121, for example. The sensor device network 122 may comprise several or many sensor devices located in a remote area where conventional communication networks, such as the internet or cellular networks, may not be available, for example. Such remote areas may include mines, remote agricultural land, remote scientific research stations, for example. The sensor devices may be configured to sense various environmental conditions, the status of machinery or may be used to track the movement of cattle, for example. The sensor devices network 122 may extend over an area of approximately 700 km², for example. The terrestrial gateway device 121 receives and stores information transmitted by the sensor devices of the sensor device network 122. The terrestrial gateway device 121 also serves as an information relay device between devices in the sensor device network 122 and the LEO satellite 110.

The LEO Satellite 110 comprises a communication system comprising an antenna array 117, UHF radio antennae 107, S band radio antennae 109, a radio frequency front end 115, a digital logic processing device 114, a processor 112, a memory 113 in communication with the processor 112, and a data handling subsystem 116.

The antenna array 117, primarily used for commercial communications, comprises four or more, and possibly tens or hundreds of antenna elements. Each antenna element 117a to 117n being an independent antenna capable of receiving or transmitting or both receiving and transmitting radio waves or signals.

The number of antenna elements 117a to 117n of antenna array 117 of the LEO satellite 110 of various embodiments may be within a range of 4 to 300, 36 to 256, 81 to 196, or 121 to 169, for example. The LEO satellite 110 may include an antenna array of 64 antenna elements 117a to 117n, for example. The antenna array 117 may be an 8 by 8 (8×8) array, for example. The antenna array 117 of LEO satellite 110 of various embodiments may be in a 2×2 antenna element configuration, for example. Example configurations further include 2×3, 3×3, 2×6, 4×4, 3×7, 3×8, 5×5, 9×10, 10×13, 12×12, 13×13, 15×15, 15×17, and 17×17.

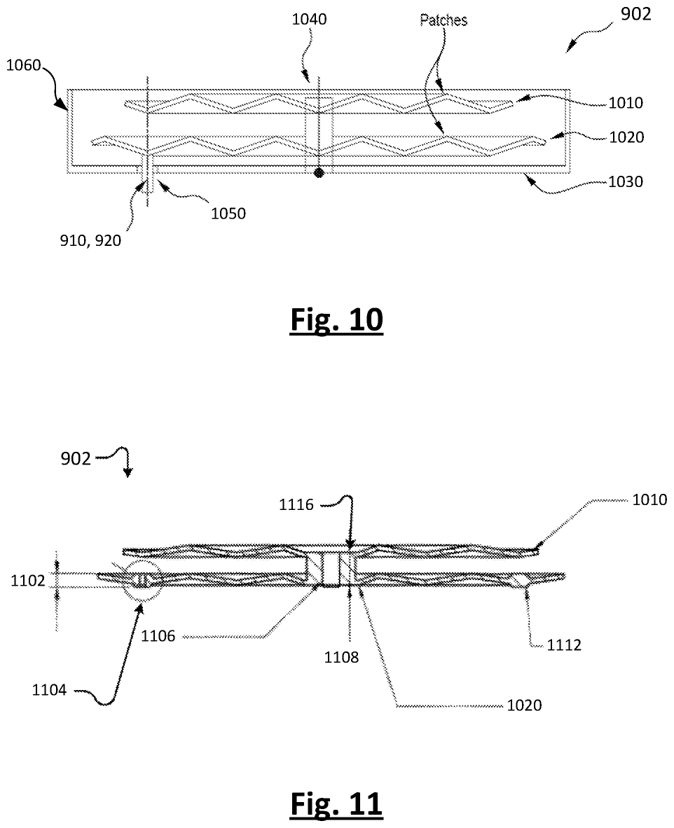

In some embodiments, the antenna elements 117a to 117n of antenna array 117 are contiguous. The antenna array 117 may comprise antenna elements 117a to 117n adjacent to one another that share a wall 1060 of cup 1030 (FIG. 10). In some embodiments, not all of the antenna elements 117a to 117n of antenna array 117 are contiguous. The antenna array 117 may comprise antenna elements 117a to 117n that each have an individual cup 1030. In alternate embodiments, the antenna elements 117a to 117n of antenna array 117 may be both contiguous and non-contiguous. That is, antenna array 117 may comprise contiguous subarrays that are non-contiguous with one another. The antenna array 117 is preferably a two-dimensional array.

The multiple antenna elements 117a to 117n enable spatial filtering capabilities of the communication system of the LEO satellite 110. UHF radio antennae 107 and S band radio antennae 109, primarily used for control of LEO satellite 110 and backend communications, each comprise two or more antenna elements 117a to 117n, each antenna element being an independent antenna capable of receiving or transmitting or both receiving and transmitting radio waves or signals.

The LEO satellite 110 also comprises a power management subsystem 111 including a power supply, such as one or more rechargeable batteries, and a solar array 105 to charge the power supply. The solar array 105 comprises two or more solar panels, each including a panel substrate, a number of individual solar photovoltaic cells optimised for use in space and coupled to the substrate. In some embodiments, the solar photovoltaic cells may use close-packed solar cell rectangles that cover most or substantially all (e.g. 90-100%) of the back (hot) surface of the solar panels. In some embodiments, the solar array 105 may be configured to generate power within a range of about 200 W to 500 W, for example. The solar array 105 may be configured to generate power suitable for powering the various power-consuming components within the range of 200 W to 500 W, for example.

The LEO satellite 110 also comprises a radio frequency front end 115 that performs pre-processing of signals received by the antenna array 117 or processing of signals provided to the antenna array 117 for transmission. The processing may comprise conversion of analogue signals to digital signals or vice versa, channelization of signals, and selection or rejection of particular frequency bands of signals, for example.

The reconfigurable digital logic processing device 114 comprises a matrix of configurable logic blocks (CLBs) connected via programmable interconnects. The reconfigurable digital logic processing device 114 may be dynamically reprogrammed to provide desired application or functionality required to provide a communication service through the communication system 100. The CLBs may be reconfigured to implement various digital logic processing capabilities. The CLBs may be configured to operate in cooperation with each other by appropriately programming the interconnects to implement complex logical operations. Advantageously, the reconfigurable digital logic processing device 114 may be reconfigured dynamically to account for changes in the location of the LEO satellite during orbit and consequential changes in the need for spatial filtering to be performed by the communication system of the LEO satellite. In some embodiments, the reconfigurable digital logic processing device 114 may be or include a field-programmable gate array (FPGA).

The LEO satellite 110 also comprises at least one processor 112 that is in communication with a memory 113 and the reconfigurable digital logic processing device 114. The processor 112 has the capability to reconfigure the reconfigurable digital logic processing device 114 according to instructions and data stored in the memory 113. In some embodiments, the LEO satellite 110 may receive commands or instructions from ground station 130 over the link 170. In some embodiments, the LEO satellite 110 may receive commands or instructions from an alternate LEO satellite 110 over the link 171. The commands may include instructions to reconfigure the reconfigurable digital logic processing device 114 to meet changing communication requirements between the LEO satellite 110 and one or more remote terrestrial communication systems 120. The capability to reconfigure the reconfigurable digital logic processing device 114 while the LEO satellite 110 is in orbit provides significant flexibility in providing a satellite communication service using described embodiments.

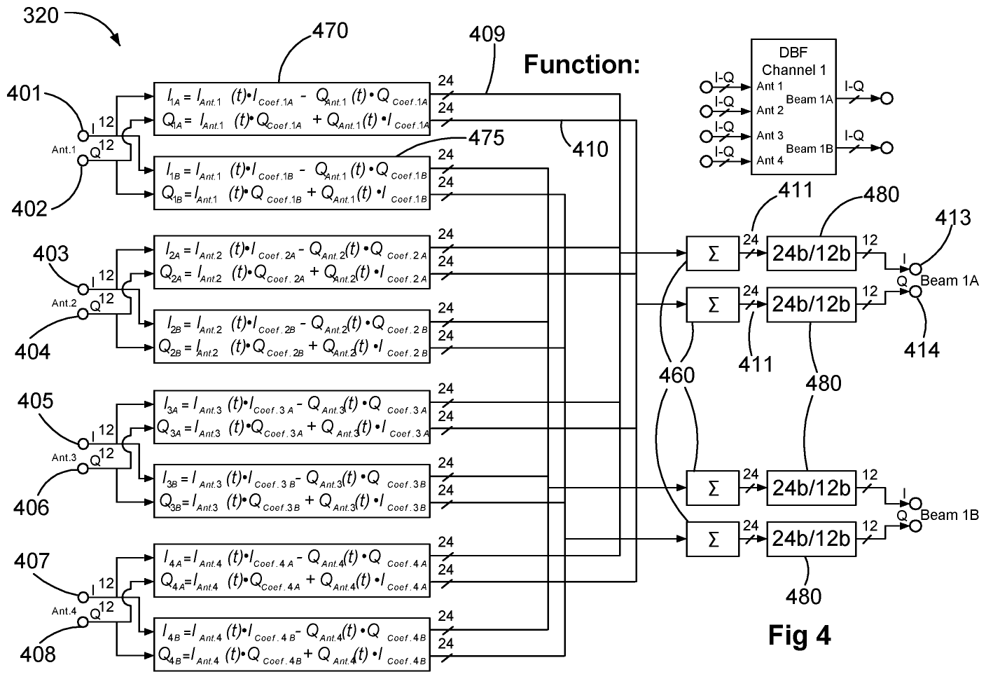

Memory 113 comprises orbital schedule data 118 relating to the LEO satellite 110. Orbital schedule data 118 includes data relating to the scheduled position of the LEO satellite 110 over time with respect to the Earth and the various remote terrestrial communication systems 120 as the LEO satellite 110 traverses its orbit. The orbital schedule data 118 also comprises antenna array configuration records that reference an ephemeris record (stored in memory 113) indicating a scheduled position of the LEO satellite 110 in orbit over a period of time, together with array factor coefficients or weights associated with each antenna element defined in relation to the ephemeris record. The array factor coefficients or weights associated with each antenna element (at a particular time) define the mathematical operations to be performed by the reconfigurable digital logic processing device 114 to process the signals received by each antenna element or process signals provided to each antenna element for transmission. The array factor coefficients or weights are complex numbers comprising a real coefficient and an imaginary coefficient. The mathematical operations performed by the reconfigurable digital logic processing device 114 using the array factor coefficients or weights are explained further below with reference to FIG. 4.

The at least one processor 112 is configured to execute software program code stored in memory 113 to periodically check the current scheduled orbital position and/or the actual determined orbital position of the LEO satellite 110 and then access the orbital schedule data associated with the current (determined) orbital position to determine the array factor coefficients to be provided to the reconfigurable digital logic processing device 114 for signal transmission and/or reception over a next (succeeding) time period. The resetting of the array factor coefficients (and thus redirection of digitally formed beams or nulled beams) can happen frequently according to the ephemeris data corresponding to the determined position of the LEO satellite 110. This means that, during a pass of the LEO satellite 110 over a particular terrestrial area, the array factor coefficients can be reset multiple times in a pass-over period (e.g. 200-250 seconds, optionally around 240 seconds) while the LEO satellite is in range of that particular area. Resetting the array factor coefficients multiple times in a pass-over period for a particular area causes the one or multiple formed or nulled beams of the LEO satellite 110 to be angularly adjusted to account for the satellite movement relative to the particular area. This allows the formed or nulled beams of the satellite to be adjusted to better track and target the particular terrestrial area for improved communication efficiency. In some embodiments, the array factor coefficients can be set according to the ephemeris data for a pass over a known terrestrial area (containing a field of target devices for communication) and the array factor coefficients are maintained for a scheduled time (e.g. the entire pass-over period for that target terrestrial area) while the digitally formed or nulled beams pass over that area. The array factor coefficients can then be reset according to the ephemeris data for the next target terrestrial area that the LEO satellite is scheduled to pass over.

Ground station 130 is a terrestrial radio station designed for receiving and transmitting signals or radio waves from each of the LEO satellites 110. Ground station 130 comprises suitable antennas to communicate with the LEO satellites 110 and suitable network interface components to convey data received from the LEO satellites 110 to a network 150. Network 150 may be or include a data network, such as the Internet, over which backhaul server 135 and the client device 140 may receive or access the data received by the ground station 130. The backhaul server 135 may be a computer server, for example, primarily used for backend operation of LEO satellite 110. The client device 140 may be a computer server or an end user computing device such as a desktop, laptop, smartphone or tablet, for example.

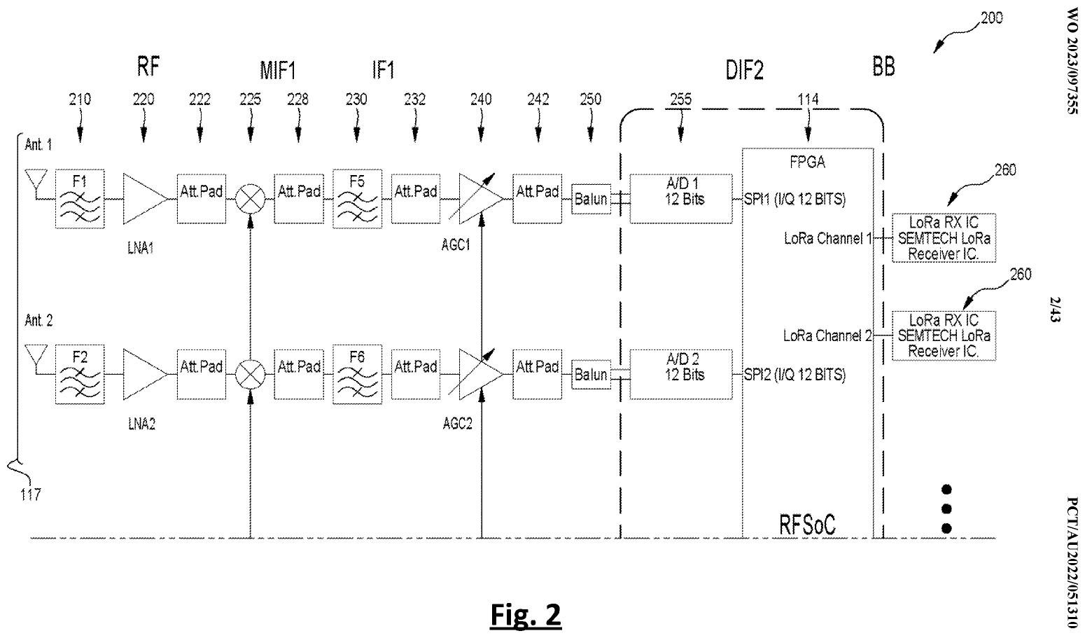

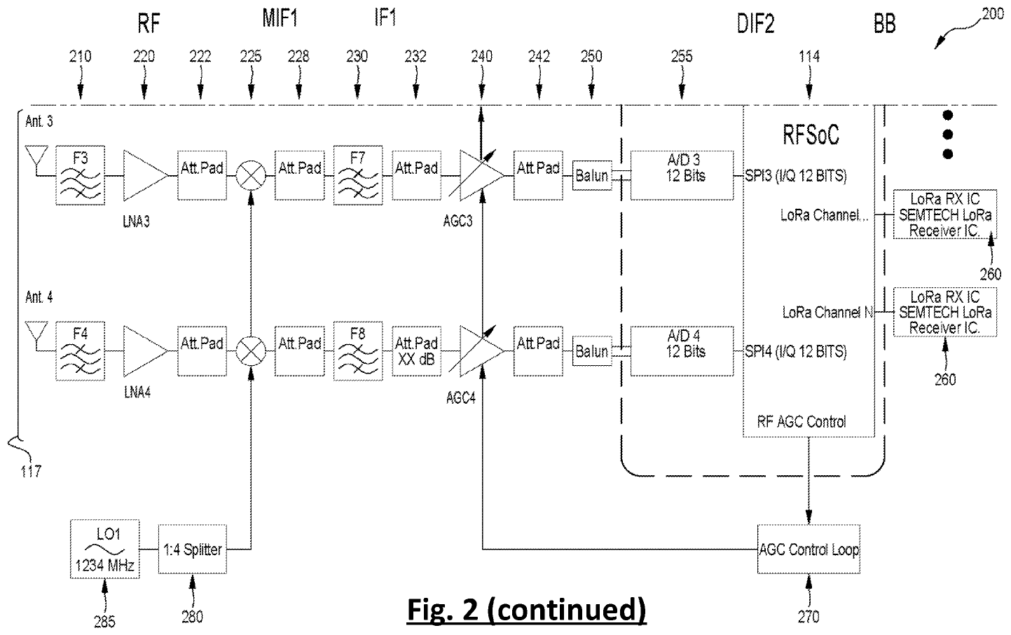

FIG. 2 is a schematic diagram of a part 200 of the communication system of a LEO satellite 110. FIG. 2 illustrates parts of the RF front end 115 and the reconfigurable digital logic processing device 114. In the exemplary embodiment of FIG. 2, the antenna array 117 has four elements. However, embodiments contemplate more than four antenna elements. For example, the antenna array may include 5, 6, 7, 8, 9, 10, 12, 15, 20 or more antenna elements. In described embodiments, a minimum of two antenna elements is required to perform the described digital beamforming.

Signals received by each antenna element pass through a band pass filter 210 that removes signals received at frequencies that are not of interest for the LEO satellite 110. In some embodiments, the band pass filter may allow signals of frequencies between about 2170 MHz and about 2200 MHz to pass through, for example. Subsequently, the received signals pass through a radio frequency (RF) amplifier 220. The RF amplifier front-end may provide a total gain in the range of 40 to 60 dB, for example, as additional amplification can be provided in the Intermediary Frequency (IF) stage (228 to 242). The RF amplifier in combination with other components (including the input filter) processing the RF signal may have a noise figure lower than 2 dB from the antenna port, for example.

The radio frequency amplifier 220 increases the sensitivity of the receiver by amplifying weak signals without contaminating them with noise so that they can stay above the noise level in succeeding stages. The RF front end 115 comprises a local oscillator 280 that generates a local RF signal at an offset from the signal received by the antenna array 117. The local RF signal in some embodiments may have a frequency in the range of 1000 to 1200 MHZ, for example.

In some embodiments, the local RF signal may have a frequency in S band (2 to 4 GHZ), or in C band (4.5-6 GHz), or in X band (8 to 12 GHz), or in Ku band (13 to 14.5 GHZ), or in Ka band (27.5 to 31 GHz), for example.

A splitter 280 splits the local RF signal into four different split local RF signals. Each of the split local RF signals are mixed with the signals received by each of the antenna array elements by mixers 225 to generate a mixed phase and amplitude synchronous intermediate frequency signal (MIF1) for all the array elements 117a to 117n. The MIF1 signal may have a range of frequencies between 750 to 950 MHz, for example. The MIF1 frequency has a lower frequency than the frequency of the signal received by the antenna array 117 and is more conveniently processed by the rest of the components of the RF front end 115. The components necessary to process signals at lower frequencies are less sophisticated, less expensive and often more power efficient. Further, the antenna array 117 may receive signals at different frequencies. Converting the various signals received by the antenna array 117 to the MIF1 signals simplifies the processing of all the received signals by the rest of the components of the RF front end 115.

The MIF1 signal is subsequently passed through band pass filters 230 to generate an intermediate frequency signal (IF1). In some embodiments, the band pass filter 230 may retain signals within the frequency range of 900 MHz to 930 MHz, for example. In some embodiments, a signal conditioning unit, such as muRata™ SF2098H, may be used to implement the band pass filters 230. The IF1 signal subsequently passes through variable gain amplifiers 240. The antenna array 117 may receive signals from multiple remote terrestrial communication systems 120 simultaneously. The strength of the signals received by the antenna array 117 from two remote terrestrial communication systems 120 may vary significantly. Significant differences in signal strength may make numerical operations over the received signals infeasible or complicated for the reconfigurable digital logic processing device 114. The variable gain amplifiers 240 perform the function of signal levelling based on the commands or signals received from an automatic gain control loop 270. The automatic gain control loop 270 receives feedback from the reconfigurable digital logic processing device 114 regarding the strength of the received signals. The automatic gain control loop 270 working in combination with the variable gain amplifiers 240 maintains a suitable signal amplitude, despite variation of the signal amplitude of the IF1 signal.

In embodiments wherein the signals received by the antenna array 117 are dominated by noise, the RF front end 115 may be implemented with fixed gain (without variable gain amplifiers 240). In noise dominated received RF signals, the power level of transmissions by remote terrestrial communication system 120 may be similar to the power level of the noise component in the noise dominated received RF signal. Accordingly variable gain amplifiers 240 may not be necessary in processing noise dominated received RF signals as they may not meaningfully separate the noise component from the transmissions by remote terrestrial communication system 120. Similar signal levelling operations may be performed on signals transmitted by the LEO Satellite 110 in multiple directions of interest. Levelling of the signals transmitted by the LEO Satellite 110 in multiple directions of interest may be performed by the reconfigurable digital logic processing device 114 generating a signal provided to the RF front end 115 for transmission by the antenna array 117.

After the variable gain amplification, the signal IF1 passes through baluns 250. The baluns 250 convert the unbalanced signal UBIF1 to a balanced signal BIF1 suitable for downstream transmission and processing by the rest of the RF front end 115. The BIF1 signal is subsequently processed by an analogue to digital converter 255 to convert the analogue signals into a digital signal DIF2 suitable for processing by the reconfigurable digital logic processing device 114. The DIF2 signals may be 12-bit digital signals in some embodiments.

As illustrated in FIG. 2, the reconfigurable digital logic processing device 114 (among other operations) channelises the DIF2 signal into a plurality of spread spectrum modulated signals suitable for processing by spread spectrum receiver integrated circuits (ICs) 260. In some embodiments, the spread spectrum modulated signals may be signals encoded according to the LoRa™ protocol and the spread spectrum receiver integrated circuits 260 may be LoRa™ receiver ICs, such as Semtech™ SX1301 or SX1302 ICs, for example. In alternate embodiments, the reconfigurable digital logic processing device 114 (among other operations) may use a digital modulation technique, such as frequency-shift keying (FSK) modulation or phase-shift keying (PSK) modulation techniques. PSK modulation techniques may include quadrature phase-shift keying (QPSK), and quadrature amplitude modulation (QAM) techniques of varying constellations sizes ranging between 4-QAM and 64-QAM. In alternate embodiments, the reconfigurable digital logic processing device 114 (among other operations) may use a digital modulation technique as well as a spread spectrum modulated technique, such as the LoRa™ protocol.

Blocks 222, 228, 232, 242 labelled “att.pad” in FIG. 2 are attenuation pads. In some embodiments, the attenuation pads may comprise three resistors arranged in a π configuration between the input and output points. The attenuation pads are configured to attenuate a signal by a fixed power level, for example 3 dB. The various attenuator pads in FIG. 2 allow adjustment of the power levels between the various signal processing stages to adjust the gain of a received signal to a desired overall gain level. The attenuator pads also attenuate signals rejected by one or more filters 230. For example, attenuation pad 228 may attenuate signals rejected by filter 230. By attenuating signals rejected by the one or more filters, the attenuator pads provide an improved impedance matching between the filters. The one or more filters of FIG. 2 may be reflective filters, i.e. the signals that do not pass through the filter get reflected. and could create stationary waves if a preceding component in the signal processing chain of FIG. 2 is not capable of absorbing the reflected signal. Such stationary waves could distort the frequency response of the various filters in FIG. 2. The attenuation pads 222, 228 and 242 of FIG. 2 address the effects of the stationary waves by adjusting power levels between the various signal processing stages to adjust the gain of a received signal to a desired overall gain level.

The RF front end 115 may also process signals generated by the reconfigurable digital logic processing device 114 to enable transmission of the signals by the antenna array 117. The RF front end 115 may control a feeder signal provided to the antenna array 117 based on the signals provided by the reconfigurable digital logic processing device 114. Based on the feeder signal provided to the antenna array 117, the antenna array 117 may transmit signals in a pattern comprising one or more beams based on constructive and/or destructive interference of the radio frequency transmission. The directivity or direction of the one or more beams may be controlled by the signal provided by the reconfigurable digital logic processing device 114. The directivity or direction of the one or more beams may be controlled to correspond to the location of one or more remote terrestrial communication systems 120, thereby enhancing the quality of signals received by the remote terrestrial communication systems 120. In this way, multiple transmission beams can be simultaneously created and directed in multiple different terrestrial target directions.

In some embodiments, the LEO satellite 110 may comprise a separate reconfigurable digital logic processing device and a separate RF front end, both dedicated to transmission beamforming. In some embodiments, the reconfigurable digital logic processing device 114 and RF front end 115 may be configured to perform both transmission and reception beamforming. In some embodiments, there may be a common reconfigurable digital logic processing device 114 performing both transmission and reception beamforming and two separate RF front ends, one dedicated for transmission beamforming and another dedicated for reception beamforming.

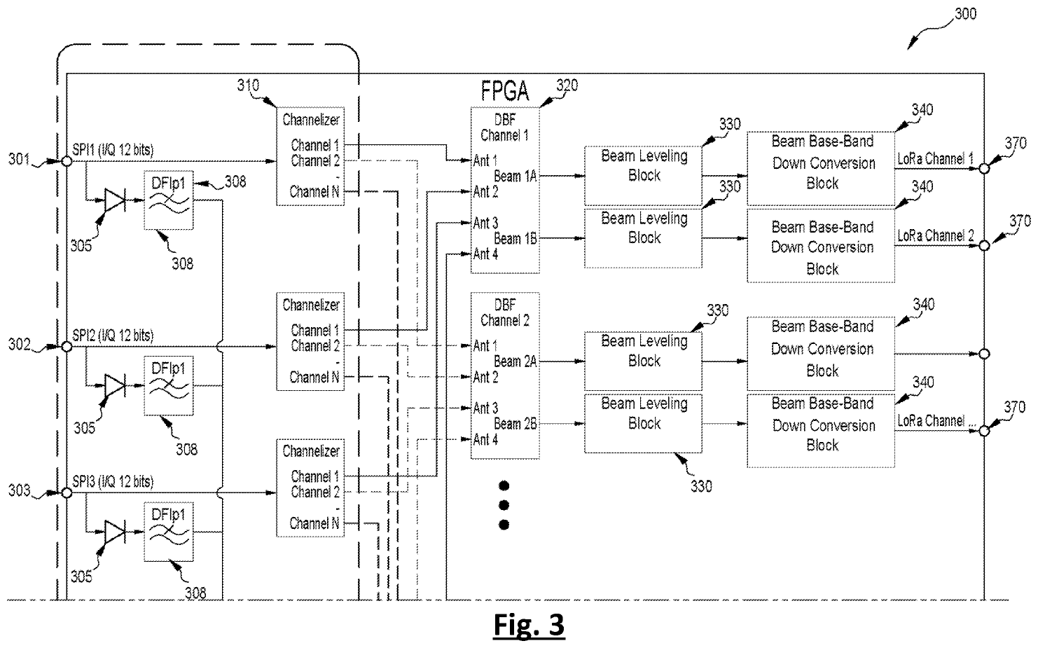

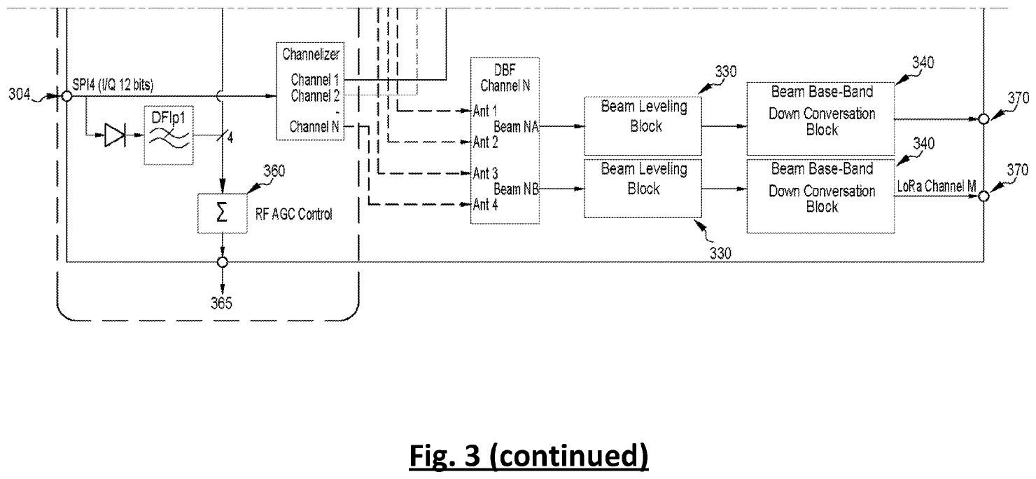

FIG. 3 is a schematic diagram illustrating a part 300 of the reconfigurable digital logic processing device 114 according to some embodiments. At input points 301, 302, 303 and 304, a digital signal is received. Each input point corresponds to a signal received by a particular antenna element of the antenna array 117. This example corresponds to an exemplary antenna array with four elements. The signals received at input points 301 to 304 are the DIF2 signals described above with reference to FIG. 2. The DIF2 signal is transmitted to a channeliser 310 to channelise the received signal into a number of separate channels. In some embodiments, the channeliser may separate the signal into 8 channelised signals, for example. The channelised signals are transmitted to multiple beamforming blocks 320. A separate beamforming block 320 is provided for each channel. Each beamforming block 320 processes the channelised signals received from each antenna element of the antenna array 117 to generate two beamformed signals for each channel. The number of beamformed signals in a channel depends on the number of antennas in the antenna array 117. By increasing the number of antennas in the antenna array, the number of beamformed signals for each channel may be increased to scale up the satellite communication service provided by the LEO satellite 110. In FIG. 3, the beamformed signals are labelled 1A, 1B . . . NA, NB. In some embodiments, each beamformed signal corresponds to an independent channel of data modulated using a spread spectrum protocol, for example such as LoRa™. In some embodiments, each beamformed signal corresponds to an independent channel of data modulated using a digital modulation technique, such as FSK and PSK, for example. In alternate embodiments, each beamformed signal corresponds to an independent channel of data modulated using either a spread spectrum protocol, such as LoRa™, or a digital modulation technique, such as FSK and PSK, for example.

The beamformed signals are then processed by a beam levelling block 330. Each beamformed signal is expected to have been received from a particular remote terrestrial communication system 120. Depending on the relative location of the remote terrestrial communication system 120 with respect to the LEO satellite 110, the signal received from the various remote terrestrial communication systems 120 may have different amplitude levels. The beam levelling blocks 330 perform the function of levelling the amplitude levels across the various beams corresponding to signals generated by different remote terrestrial communication systems 120. The beam levelling blocks 330 may perform beam levelling by dynamically adjusting a multiplication coefficient applied to the beamformed signals. Signal levelling through the beam levelling blocks 330 may be used alone or if necessary may be applied in combination with the signal levelling performed by the variable gain amplifiers 240 described with reference to FIG. 2.

After beam levelling, the levelled beam signals are processed by beam base band down-conversion blocks 340. The beam base band down-conversion blocks 340 convert the levelled beamformed signals to a lower frequency signal at a lower sampling rate to meet the requirements of downstream signal processing components. The downstream signal processing components may include components that expect a spread spectrum modulated digital signal, for example a signal according to the LoRa™ protocol. In some embodiments, the beam base band down-conversion blocks 340 may generated a LoRa™ based signal 370 as output. The downstream signal processing components may include components that expect a signal suitable for digital modulation techniques, such as FSK and PSK, for example.

The reconfigurable digital logic processing device 114 also comprises diodes 305 and low pass filters 308 corresponding to each input point 301, 302, 303 and 304. In some embodiments, the low pass filters 308 pass signals with a frequency lower than 1 kHz or lower than 10 kHz, for example. The low pass filters 308 are configured to have a cut-off frequency significantly lower than the lowest frequency of the signals received or transmitted by the antenna array 117. In some embodiments, the low pass filters 308 may have a cut off frequency of around 5-6 kHz. The signals processed by the low pass filters 308 are added using a summing block 360 and a summed signal 365 is generated. The summed signal serves as an input to drive the automatic gain control loop 270 of FIG. 2 in embodiments that rely on the automatic gain control loop 270 for signal levelling.

FIG. 4 is a detailed block diagram of the beamforming block 320 of FIG. 3, illustrated based on an example antenna array comprising four antennae. The signal processing structure and functions described in relation to FIGS. 2 to 4 can be readily extrapolated to antenna arrays with more than 4 antennae. Further FPGAs can be included as necessary to provide the necessary increased signal processing capacity for larger antenna arrays. The beamforming block 320 receives phase and amplitude synchronous input signals in the IQ form from the channeliser 310 for each one of the antenna array elements 117a to 117n. A signal in an IQ form is a complex signal broken down into a real (in-phase) and imaginary (quadrature) components. The real component (I) corresponds to a cosine of the amplitude of a signal at a particular point in time (X axis component). The imaginary component (Q) corresponds to a sine of the amplitude of a signal at a particular point in time (Y axis component). In FIG. 4, inputs 401, 403, 405, 407 correspond to the I component of the signals received from the respective antenna elements for a particular frequency channel as channelised by the channeliser 310. Inputs 402, 404, 406, 408 correspond to the Q component of the signals received from the respective antenna elements for the particular frequency channel corresponding to the inputs 401, 403, 405, 407 for the I component.

Processing blocks 470 and 475 define the mathematical operations that are performed on the signals received at inputs 401 and 402. The mathematical operations are performed by appropriately configuring the logical blocks and the interconnects of the reconfigurable logic processing device 114. For example, processing block 470 implements the operations in complex numbers:

$${I}_{1 A} = {I}_{Ant \text{.1}} ( t ) \cdot {I}_{Coef 1 A} - {Q}_{Ant \text{.1}} ( t ) \cdot {Q}_{Coef 1 A}$$

$${Q}_{1 A} = {I}_{Ant \text{.1}} ( t ) \cdot {Q}_{Coef 1 A} + {Q}_{Ant \text{.1}} ( t ) \cdot {I}_{Coef 1 A}$$

In the above mathematical operations, I_{Ant.1}(t) is a function corresponding to I component of the signal received by antennal element Ant. 1 that corresponds to the input at 401. Similarly Q_{Ant.1}(t) is a function corresponding to Q component of the signal received by antennal element Ant. 1 that corresponds to the input at 402. I_{Coef1A} and Q_{Coef1A} are coefficients that control the result of the mathematical operation on the received signals. Processing block 470 performs similar operations of the signals 401 and 402 using the coefficients I_{Coef1B} and Q_{Coef1B}. The rest of the processing blocks within the beamforming block 320 perform similar operations to the rest of the signals received at inputs 403 to 408 using a distinct set of coefficients stored in memory 113. These coefficients may also be described as weights corresponding to each antenna element.

Each antenna element has at least 4 coefficients or weights labelled I_{Coef1A}, Q_{Coef1A}, I_{Coef1B} and Q_{Coef1B}. These coefficients or weight are dynamic and are varied by the beamforming block 320 on instructions from the processor 112. The processor 112 varies these coefficients based on the orbital schedule data 118 and information regarding a current position of the LEO satellite 110. In some embodiments, the LEO satellite 110 may receive command instructions from ground station 130 over the communication link 170. In some embodiments, the LEO satellite 110 may receive command instructions from an alternate LEO satellite 110 over the intersatellite link 171. The command instructions may comprise instructions to the processor 112 to vary the coefficients depending on a change in the needs from the communication system 100. The change in communication needs may include the addition or removal of particular remote terrestrial communication systems 120 to the communication schedule. The change in the communication needs may also include identification of a source of interference or noise along certain parts of the LEO path and implementing beam nulling at appropriate times or time periods along the LEO path to address the source of interference or noise.

The orbital schedule data 118 includes antenna array configuration records. Each antenna array configuration record comprises an ephemeris record or an ephemeris zone record and weights or coefficients associated with each antenna array element in relation to the ephemeris record. The ephemeris record defines a zone or part of the orbit of the LEO satellite 110. Given a current position of the LEO satellite 110, the processor 112 is able to determine which ephemeris record the current position of the satellite corresponds to. After determining the ephemeris record that the current position of the satellite corresponds to, the processor 112 retrieves the weights or coefficients associated with each antenna array element in relation to the ephemeris record. The processor 112 subsequently reconfigures the coefficients of the beamforming block 320 based on the retrieved weights. Once the weights or coefficients of the beamforming block 320 are reconfigured, the reconfigurable digital logic processing device 114 processes the signals received by the antenna array 117 to best amplify the signals transmitted by the one or more remote terrestrial communication systems 120 that are part of the communication system 100 and currently fall within the field of view of the antenna array 117 of the LEO satellite 110.

Processing block 470 processes the input signals 401 and 402 to generate output signals 409 and 410. The output signals produced by the various mathematical operations illustrated in FIG. 4 are added by the summation block 460 to produce intermediate signals 411 and 412. If the processing by block 470 is performed using 12 bit integers as input signals, for example, the output may be a 24 bit integer signal in order to not lose any information in the determination of intermediate signals 411 and 412. The intermediate signals 411 and 412 are divided by the division blocks 480 to obtain output signals 413 (I component) and 414 (Q component) that together are described as beam 1A. Each division block 480 transforms a 24 bit input signal into a 12 bit output signal. Beamforming block 320 also generates an output signal described as beam 1B. Each of the beams 1A and 1B comprise an I and Q component. Each beam may correspond to signals transmitted by (and received from) a specific remote terrestrial communication system 120. In some embodiments, the processing block 470 may be configured to perform fixed point operations whereby the number of bits generated from the multiplication operations with the I and Q components of the weight may be fixed. In such embodiments, the block 480 may not be necessary for reducing the number of bits in the output signal.

The reconfigurable digital logic processing device 114 may similarly comprise transmission beamforming blocks that generate a signal provided to the RF front end 115 based on transmission beamforming coefficients or weights stored in the memory 113 to enable transmission beamforming using the antenna array 117.

The described beamforming technology provides a substantial increase in throughput of customer Internet of Things (IoT) data. The beamforming technology can service a higher number of customer terminals at once than satellites without such capabilities. The beamforming technology does this by generating a high number of highly-directional low-interfering beams in point-to-point satellite communications. This achieves a high spectral efficiency, which improves quality of service through enhanced data re-use, faster data rates and more link robustness.

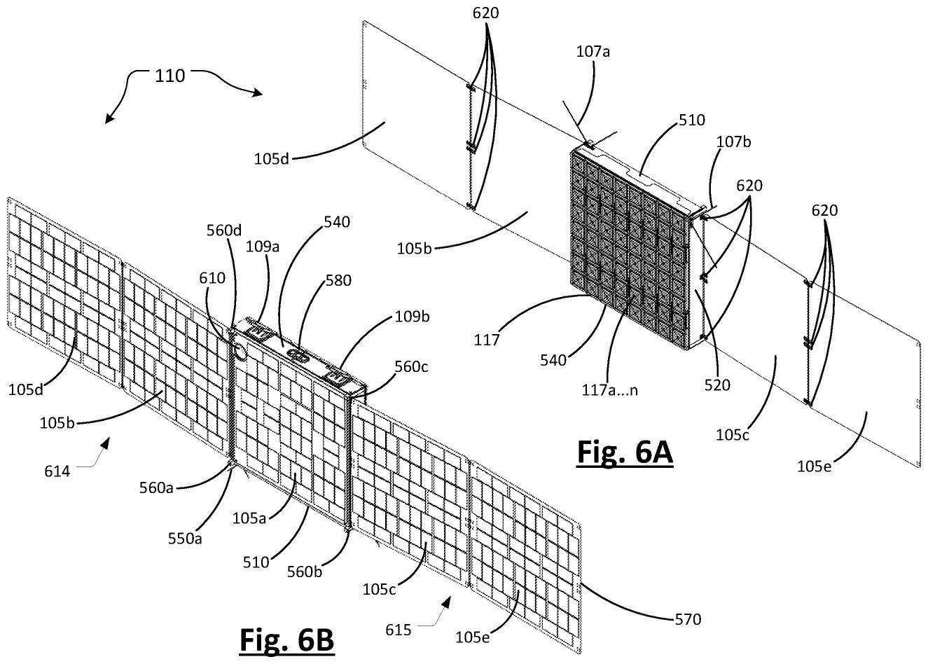

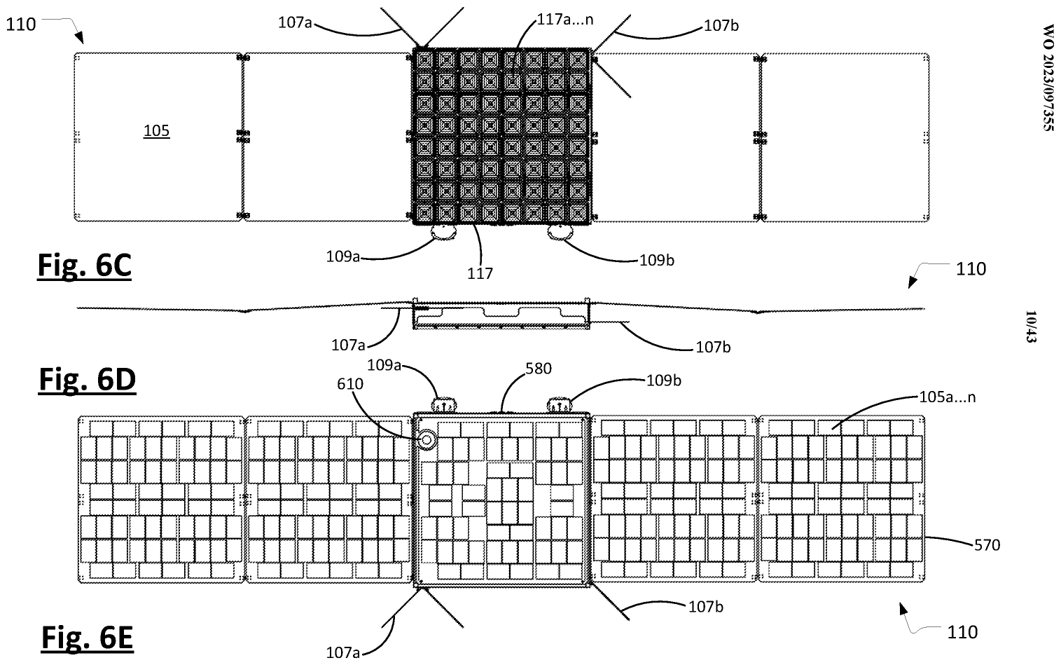

FIGS. 5A, 5B, 5C, 5D, and 5E show an example LEO satellite 110 in a stowed configuration according to some embodiments. The stowed configuration is one in which first and second wings 614, 615 (FIG. 6B) of the solar panels 105 are stowed for compact transport in a launch vehicle prior to deployment. When the satellite 110 is deployed into low Earth orbit, the wings 614, 615 are caused or allowed to move into an extended configuration, as shown in FIGS. 6A-6E.

A main body of the satellite is defined by a housing supported by a chassis. In some embodiments, the main body of the LEO satellite 110 may have an approximate rectangular tile shape. The housing of the satellite 110 may have a length (L) and width (W) being of a similar or same dimension or be within 10% of each other, for example. A depth (D) of the housing of the satellite 110 (in its stowed configuration or its extended configuration) may be no more than one third of either the length L or width W. In various embodiments, the depth D may be between about one third and one eighth of either the length L or the width W.

In alternative embodiments, the housing of the satellite 110 may have a width (W) half that of the length (L), of within 10% of half the length (L).

FIGS. 5A and 5B illustrate a first housing panel 510, a second housing panel 520 adjacent to the first housing panel 510, a third housing panel 530 adjacent to the first housing panel 510 and opposite the second housing panel 520, and a fourth housing panel 540 opposite the first housing panel 510 and adjacent to the second housing panel 520 and the third housing panel 530. Each housing panel 510, 520, 530, and 540 includes an externally directed outer face and an internally directed inner face.

Adjacent to all four housing panels, 510, 520, 530, and 540, on the front side of the LEO satellite 110 is antenna array 117. Mounted on first housing panel 510 and second housing panel 520 are two UHF radio antennae 107a and 107b in a stowed configuration. In some embodiments, UHF radio antennae 107a and 107b may include a commercially available deployment mechanism. The first housing panel 510 may also contain an aperture defining an area for a propulsive burst to be released from a propulsion system 580.

Adjoining all four housing panels, 510, 520, 530, and 540, on the back side of the LEO satellite 110 opposite the front side, is solar array 105 in a stowed configuration, which comprise at least three individual solar panels 105a-105n. Solar panels 105b-105n may be coupled to the chassis of the LEO satellite 110 via standoffs or posts 560a, 560b, 560c, and 560d. This allows the panels to be stowed in a compact configuration and to space and protect them from one another when stowed.

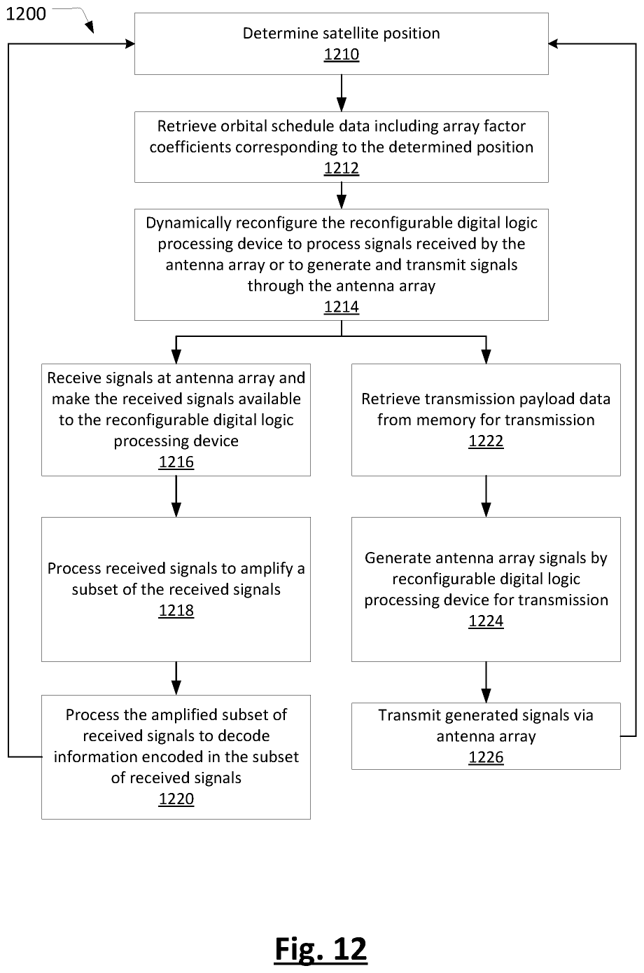

In some embodiments, mounted on the fourth housing panel 540 are two S band radio antennae 109a and 109b for transmitting and receiving control information for the satellite. As illustrated in FIG. 12, S band radio antennae 109a and 109b can be stowed in a flattened or compact configuration when not in use. The fourth housing panel 540 may also contain an aperture defining an area for a propulsive burst to be released from a propulsion system 580. In some embodiments, the propulsion system 580 may comprise an electric propulsion mechanism which would provide a small amount of thrust for repositioning the satellite 110. In some embodiments, the propulsion system 580 may alternatively or additionally comprise a chemical propulsion mechanism which would provide a relatively high amount of thrust for repositioning the satellite 110.

FIGS. 6A, 6B, 6C, 6D, and 6E show the LEO satellite 110 with the solar array 105 in an extended position according to some embodiments. In the embodiments illustrated in FIGS. 6A to 6E, the solar array includes two solar panels 105b, 105d on the first wing 614 and two solar panels 105c, 105e on the second wing 615. A further solar panel 105a is fixed to the back face or wall of the satellite housing. In some embodiments, each wing has one solar panel.

FIG. 6A shows an example location of UHF radio antenna 107b on the second face 520 whilst also showing it and UHF radio antenna 107a in a deployed configurations.

FIG. 6B illustrates a number of unfurled solar panels 105b, 105c, 105, 105e extending from the LEO satellite 110. Solar panels 105b, 105c, 105, 105e generally extend laterally from a back edge of the second housing panel 520 and a back edge of the fourth housing panel 530. Solar panel 105b may be coupled to the chassis via posts or standoffs 560a, and 560d. Solar panel 105c may be coupled to the chassis via posts or standoffs 560b, and 560c. Alternatively, solar panels 105b, 105c may be coupled to the chassis via a different coupling mechanism, such as may be carried on housing panels 520 and 530. In some embodiments, LEO satellite 110 may have five solar panels 105a-105e, one fixed to the chassis, and two extending from each opposing side in a winged configuration, for example.

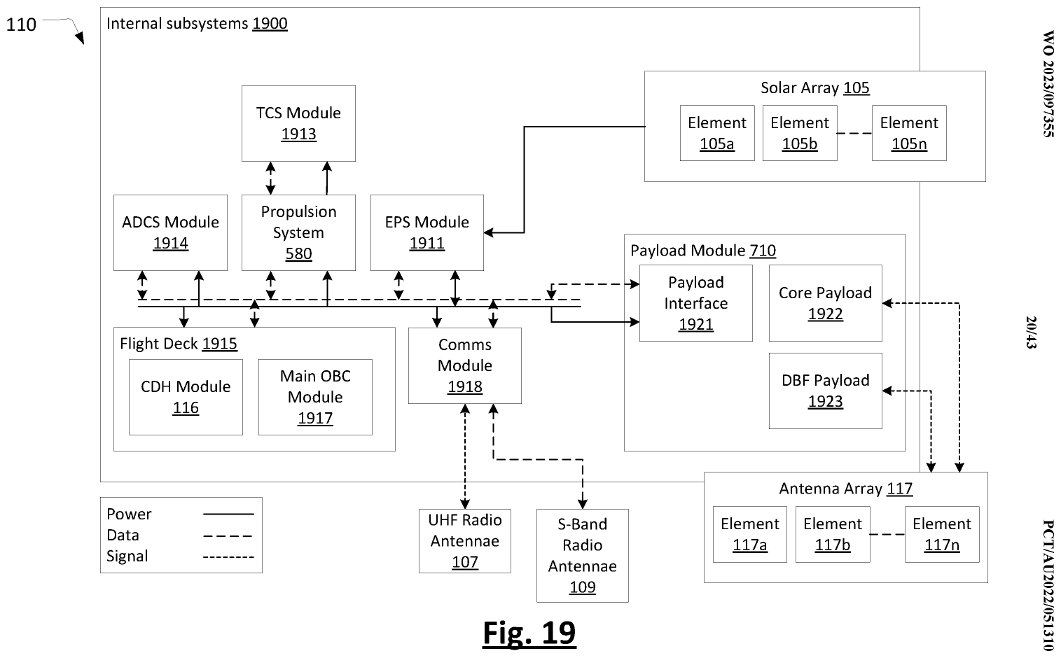

Solar panels 105b and 105d and solar panels 105c and 105e are coupled to one another by hinges 620. The hinges 620 may be spring-biased toward an open, extended position so that the panels 105b-105e can unfurl to the extended position once released to do so by a release mechanism (not shown) on the chassis. Each hinge 620 may include one or more conductors allowing electrical energy to pass from the solar panels 105b-105e to the electrical power system module 1911 (FIG. 19).

FIG. 6B also illustrates a star tracker 610 disposed on a back side of the chassis. The star tracker 610 comprises an optical device that measures the positions of stars using photocells or a camera. The star tracker 610 may be used to determine the attitude of the LEO satellite 110 with respect to the stars.

LEO satellite 110 may be generally configured to have an external bilateral symmetry relative to a longitudinal axis 580 running through, the centre of first face 510 and centre of fourth face 540. LEO satellite 110 may be generally configured to have an external bilateral symmetry relative to a lateral axis running perpendicular to, and through, the centre of second face 520 and centre of third face 530. Solar array 105 extends in a lateral direction along or parallel to the lateral axis.

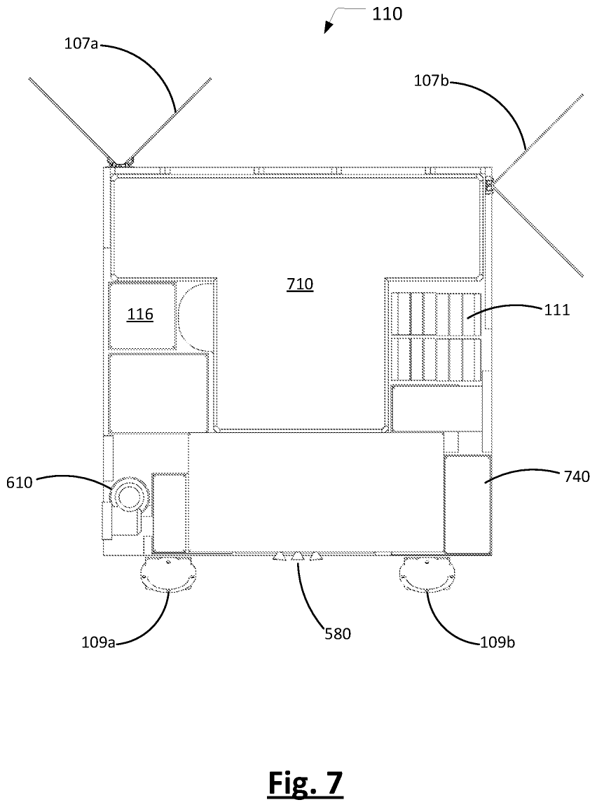

FIGS. 7 and 19 illustrate example hardware components and functions. FIG. 7 shows a general configuration of the internal subsystems of the LEO satellite 110, according to some embodiments. For example, the internal subsystems of the satellite may comprise communications payload 710, command and data handling (CDH) 116, power management subsystem 111, and guidance, navigation, and control (GNC) subsystem 740. FIG. 7 further illustrates the deployed configurations of UHF radio antennae 107a and 107b, and S band radio antennae 109a and 109b.

FIG. 19 is a detailed schematic diagram of the internal subsystems 1900 described in FIG. 7 comprising an electric power system (EPS) module 1911, a propulsion module 580, a thermal control system (TCS) module 1913, an attitude determination and control system (ADCS) module 1914, a flight deck 1915, communications module 1918, and payload module 710. Internal subsystems 1900 may alternatively be known as a satellite bus, comprising the infrastructure or subsystems of the satellite to enable satellite operation.

The EPS module 1911 functions to supply other systems in the LEO satellite 110 with the necessary electrical power to operate effectively. EPS module 1911 receives power supply from solar array 105. The TCS module 1913 is responsible for maintaining the various components of the LEO satellite 110 within desired thermal ranges, varying depending on the component and its work load. The ADCS module 1914 is responsible for controlling the orientation of the satellite based on information acquired from ground station 130 and various sensors on-board, such as the star tracker 610 or the GNC subsystem 740, for example. Communications module 1918 acts to transmit and receive signals via UHF radio antennae 107 and S band radio antennae 109.

Flight deck 1915 comprises a command and data handling (CDH) module 116 and a main on-board computer (OBC) module 1917. CDH module 116 functions to manage all forms of data on the LEO satellite 110, preparing it for transmission and processing received transmissions from external sources. The main OBC module 1917 is the brain of the satellite, functioning to control and manage the subsystems of LEO satellite 110. Thus, OBC module 1917 includes the processor 112.

Payload module 710 comprises a payload interface 1921 and a communications payload. In some embodiments, the communications payload may comprise a core payload 1922, and/or a digital beamforming (DBF) payload 1923. The payload interface 1921 is the interface between the main data bus of the internal subsystems and the payload module. DBF payload 1923 functions to perform the digital beamforming communication method of communications system 200 of the LEO satellite 110. Core payload 1922 and DBF payload 1923 both transmit and receive signals via antenna array 117.

FIG. 8 is a schematic diagram of an antenna array 800 comprising antenna elements 810a, 810b, 810c and 810d according to some embodiments. The antenna array 800 is a phased antenna array. FIG. 8 also illustrates the Z and Y axis used as a reference for the calculations performed by the reconfigurable digital logic processing device 114 and the RF front end 115. The X axis (not shown) is perpendicular to the Y and Z axis. Other orientations of the X, Y and Z axes may be used in other embodiments.

In some embodiments, the antenna array 117 or 800 may be a patch antenna array suitable for positioning or mounting on a flat surface. Each element of the antenna array may be a patch of metal mounted on a larger sheet of metal 890 serving as a ground plane for the antenna array. In other embodiments, the antenna array 117 or 800 may include multiple ones of other forms of radiating element, such as a whip radiating element or a horn radiating element, for example. However, the antenna elements of the antenna array 117 or 800 are not configured to move relative to each other, nor does the antenna array rely on a diversity setup.

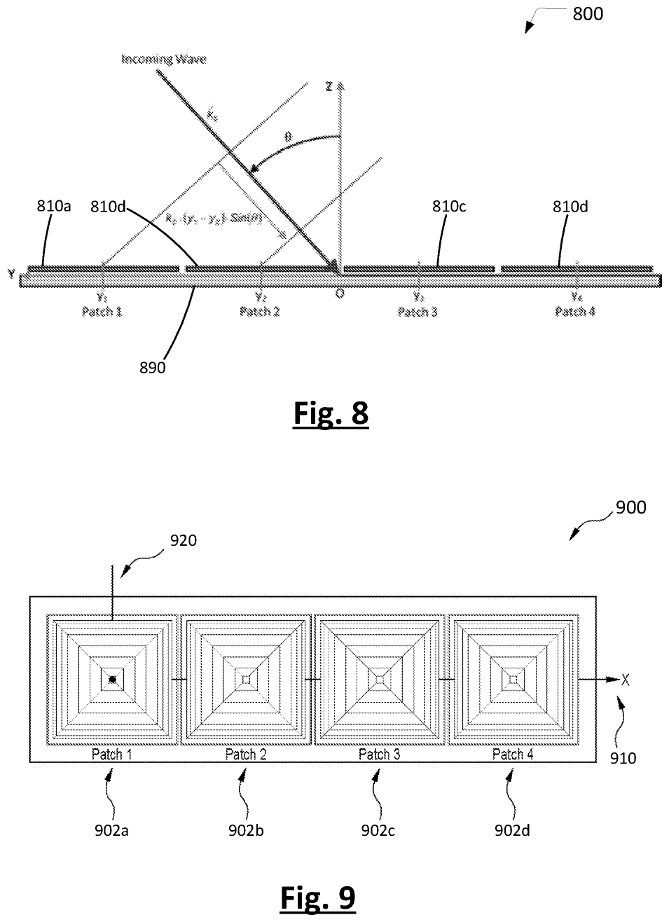

FIG. 9 is an example plan view of an antenna array 117 or 800 in the form of a patch antenna array 900 of the communication system according to some embodiments. The patch antenna array 900 is shown as a linear array. Antenna elements of a linear array are positioned along one linear dimension, i.e. the antenna elements are positioned along one line to form the patch antenna array. The patch antenna array 900 is shown as an array of antenna elements situated on a common base plane defined by the chassis. Each antenna element or patch 902a, 902b, 902c, 902d of the patch antenna array 900 has a cupped stacked patch configuration. In some embodiments, the spacing between adjacent antenna element/patch 902a, 902b, 902c, 902d remains substantially uniform. The antenna array 900 also comprises two coaxial probes 910 and 920. The probes 910 and 920 are orthogonal to each other (i.e. angularly separated by about 90 degrees relative to a centre post 1040) and may be axially fixed to withstand vibrations during a launch of the LEO satellite 110. In some embodiments, the antenna array 900 may have the dimensions of 81 mm×301 mm×15 mm, for example. In some embodiments, the antenna array 117 may alternatively be implemented using a rectangular array, multiple linear arrays or a circular or other non-linear array, for example. A uniform or non-uniform distance may be used to space the antenna elements of the rectangular array or the circular array.

FIG. 10 is a side cross section view of the antenna array element 902 shown in FIG. 9 according to some embodiments. FIG. 10 illustrates a first (upper) parasitic element/patch 1010, a second (lower) excitation element/patch 1020 and a cup 1030. Each cup 1030 is embedded in or positioned on or incorporated in an outer part or subframe of a chassis of the LEO satellite 110, for example. The cup 1030 has an opening 1050 through which both the probes 910, 920 pass towards the patches 1010 and 1020. The patches 1010 and 1020 may be embossed with a thinner patch for greater mechanical stability. The two patches 1010 and 1020 are mechanically supported by a centre post 1040. The lower patch 1020 is galvanically excited via the two orthogonal coaxial probes 910 and 920. In some embodiments, the lower patch can be excited by contactless electromagnetic couplings either by a proximity probe (capacitive coupling excitation) or through a slot manufactured in the ground plane (aperture coupled excitation).

In some embodiments, underneath patch 1020 lies a microstrip hybrid network (not shown). The microstrip hybrid network may create two ports, one Right Hand Circular Polarised (RHCP) port and another Left Hand Circular Polarised (LHCP) port. Accordingly, some embodiments use left hand or right hand circular polarisation of transmissions. Incorporation of left hand or right hand circular polarisation of transmissions allows for a simultaneous transmission of two independent signals, a first signal using the RHCP port and a second signal using the LHCP port. The two simultaneously transmitted signals comprise oscillations in planes orthogonal to each other, as opposed to oscillation in a singularly polarised transmission. Circularly polarised transmissions are more robust in response to problems associated with signal reflection or lack of a clear line of sight to a transmission target.

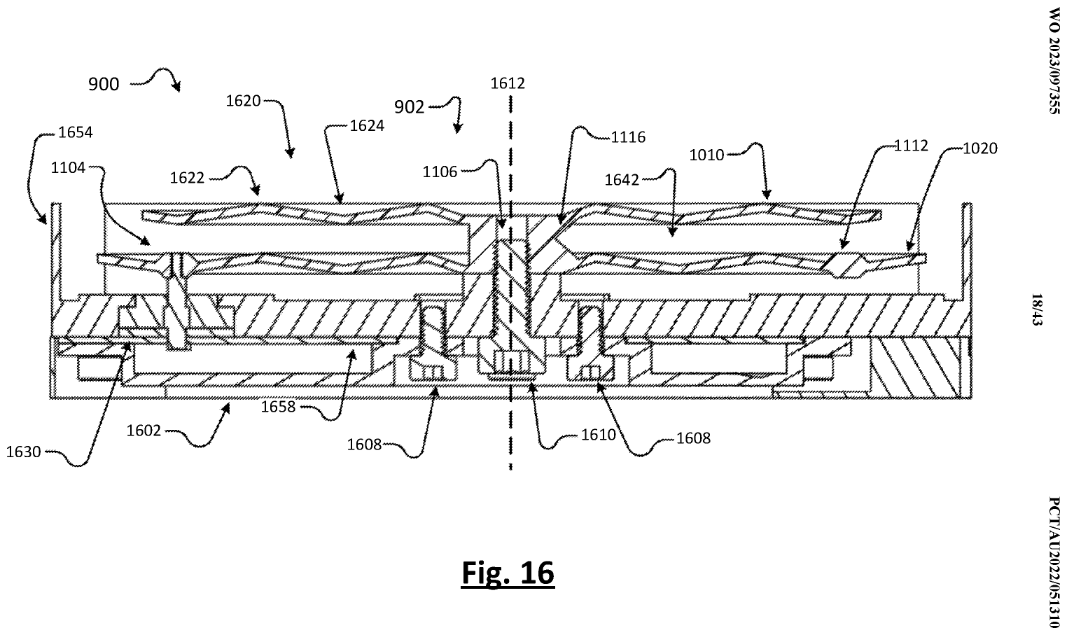

FIG. 11 is another cross-section view of the antenna element 902 according to some embodiments, illustrating the parasitic element or parasitic antenna patch body 1010 and an excitation element or excitation antenna patch body 1020. Provided in excitation element 1020 is a probe region 1104. A thickness 1102 of the probe region in the direction of a central axis 1612 (FIG. 16) may be about 2 mm. Thickness 1102 may be marginally greater than a peak-to-peak depth (distance from highest point to lowest point) of the corrugations of each patch body 1010, 1020. The probe region 1104 allows the connection of a feeding probe to the excitation element 1104 to transmit feed signals from the RF front end 115 or convey signals received by the antenna element 902 to the RF front end 115. The antenna element 902 also comprises a threaded aperture 1106 to receive a support screw to mount the antenna element 902 on a ground plane (shown in FIG. 16). The excitation element 1020 may also comprise RF balancing elements 1112. The RF balancing elements 1112 mimics the structure and RF characteristics of the probe region 1104 to balance RF transmissions or reception by the entire excitation element 1020. The thickness of the cross-section 1108 of the antenna element may be 4.8 mm in some embodiments.

The excitation element 1020 may be longer in cross-section than the parasitic element 1010. The cross-sectional orientation or pattern of the excitation element 1020 and the parasitic element 1010 may closely mirror each other to allow the two elements to resonate during transmission or reception of signals. Positioned between the parasitic element 1010 and the excitation element 1020 is a connecting element or central portion 1116. The connecting element 1116 has a square-shaped cross-section. The square shape of the connecting element or central portion 1116 is diagonally aligned with the square shape of the excitation element 1020 and the parasitic element 1010 for improved 3D printing manufacturing efficiency.

The body of the antenna element 902 may be 3D printed. However, the complex stacked patch structure of the antenna element 902 may make it challenging to 3D print the entire antenna element 902 as a single unit. Printing disjoint elements of the antenna separately, for example, printing or otherwise forming the parasitic element 1010 and the excitation element 1020 separately, may alleviate the manufacturing challenges of forming the elements as a single unit. However, separate printing or manufacturing of the two elements 1010 and 1020 and combining them to form the antenna element 902 may introduce undesirable RF characteristics in the antenna element 902 and unnecessary assembly and part alignment complexity. Combining separately manufactured or printed elements 1010 and 1020 may also make the assembly and calibration process of the antenna array 900 more complex. The introduction of additional parts in the antenna array 900 makes the overall array less robust.

3D printing the entire antenna element 902 allows the use of a uniform or continuous metal material which provides more optimal RF characteristics for transmission or reception of signals. The connecting element 1116 may be so shaped to allow the 3D printing of the entire antenna element 902 as a single part. 3D printing by extrusion of metal requires a continuous support structure to allow the entire antenna element 902 to be printed. In some embodiments, the antenna element 902 may be printed whereby the excitation element 1020 is printed first, followed by the connecting element 1116. After printing of the connecting element 1116, the parasitic element 1010 may be printed using the connecting element 1116 as a support structure for the rest of the printing. In some embodiments, the aperture or bore 1106 or the aperture in the probe region 1050 may be formed as part of the 3D printing process. The bore 1106 allows the coupling of the antenna 902 to an antenna base. The apertures may be subsequently threaded to allow screws to be received in the apertures for the antenna assembly. In some embodiments, the antenna patch bodies 1010 and 1020 may be substantially square or rectangular.

FIG. 12 is a flowchart of a method 1200 of communication between the LEO satellite 110 and the plurality of terrestrial communication systems 120. Various steps of method 1200 are performed by the various components of the LEO satellite 110 including the antenna array 117, reconfigurable digital logic device 114 and processor 112. At 1210, a current position of the LEO satellite is determined. In some embodiments, the current position may be determined using data from the GPS receiver. In some embodiments, a current position of the LEO satellite may be determined using an initial satellite state vector comprising position and velocity data provided by the satellite launch provider at the point of time the LEO satellite 110 was launched from a launch vehicle.

At 1212, the processor 112 determines array factor coefficients based on the satellite position determined at 1210. The array factor coefficients may be retrieved from memory 113 storing orbital schedule data 118. The array factor coefficients may be suitable for allowing transmission or reception beamforming operations.

At 1214, the processor 112 reconfigures the reconfigurable digital logic processing device 114 using the array factor coefficients determined at 1212. The schematic diagram of FIG. 4 illustrates signal processing operations performed by a digital logic processing device 114 of some embodiments. At step 1214, the various coefficients illustrated in FIG. 4 may be updated based on the array factor coefficients determined at 1212. The table below illustrates an example of the records stored in memory 113 that may be used to configure reconfigurable digital logic processing device 114, in particular to configure the I and Q array factor coefficients that determine the beamforming or beam steering operations performed by the LEO satellite 110.

TABLE 1

| Flight Path Coordinates | | |
|---|---|---|
| of LEO Satellite | I, Q coefficient values for | |
| (latitude, longitude) | each antenna element | Comments |
| (−26.298283646981687, | Antenna 1[−872, 540] | This example corresponds to the LEO |
| 103.49188047624469) to | Antenna 2 [−223, −2035] | satellite being positioned westward |
| (−15.225829293439313, | Antenna 3 [1933, 674] | off the western coast of Australia. |
| 117.37859865239922) | Antenna 4 [−722, 729] | The coefficients allow the beams to |
| | | be directed eastwards with respect to |
| | | the satellite to cover remote terrestrial |
| | | communication systems positioned in |
| | | Western Australia. |
| (−34.48717708853079, | Antenna 1[−1003, 214] | This example corresponds to the LEO |
| 14.09200067105491) to | Antenna 2[1767, 1033] | satellite being positioned south off |
| (−34.97309413652626, | Antenna 3[−610, −1954] | the southern coast of South Africa. |
| 30.203706711591614) | Antenna 4[−434, 930] | The coefficients allow the beams to |
| | | be directed northwards with respect |
| | | to the satellite to cover remote |
| | | terrestrial communication systems |
| | | positioned in South Africa. |

The orbital schedule data 118 of the LEO satellite 110 may comprise the flight path coordinates as exemplified in table 6 above. Ephemeris records stored in memory 118 indicating a scheduled position or a portion of a flight path of the LEO satellite 110 may also include the flight path coordinates as exemplified in Table 1 above.

At 1216, the antenna array 117 may receive signals. The received signals are processed by the RF front end 115 and made available to the digital logic processing device 114. At 1218, the digital logic processing device 114 processes the signals received by the antenna array 115 to amplify a subset of received signals corresponding to terrestrial communication system 120. At 1218, the digital logic processing device 114 may also simultaneously attenuate signals that are not of interest or signals corresponding to known sources of noise. At 1220, the amplified subset of signals determined at 1218 are processed to determine information encoded in the signals received at 1216 by the antenna array 117. Step 1220 may be performed in its entirety by the digital logic processing device 114 or the processor 112. In some embodiments, step 1220 may be performed by the digital logic processing device 114 and the processor 112 in coordination with each other. The decoded information may be stored in memory 113. When the LEO satellite 110 establishes communication with ground station 130, the decoded information may be transmitted to the ground station 130 over the radio communication link 170 to be made available to client device 140.

In some embodiments, the LEO satellite 110 may be an element of a satellite constellation. The satellite constellation may comprise a plurality of LEO satellite 110 in communication with one another via intersatellite link 171. The satellite constellation may enable an LEO satellite 110 that is not in view of ground station 130 to communicate with ground station 130 indirectly via a secondary LEO satellite 110 within the satellite constellation that is in view of ground station 130.

In some embodiments, the LEO satellite 110 may communicate indirectly with ground station 130 via at least one secondary LEO satellite 110 through intersatellite link 171. That is to say, that LEO satellite 110 may transmit information to a secondary LEO satellite 110 via intersatellite link 171. If the secondary LEO satellite 110 is in view of ground station 130, the secondary LEO satellite 110 may transmit the received information over radio communication link 170. If the secondary LEO satellite 110 is not in view of the ground station 130, the secondary LEO satellite 110 may transmit the information to another secondary LEO satellite 110 via intersatellite link 171 until a secondary LEO satellite 110 in view of the ground station 130 is reached.

Steps 1222, 1224 and 1226 correspond to steps for transmission of information from the LEO satellite 110 to a remote terrestrial communication system 120. At 1122, the processor 112 retrieves the information/payload to be transmitted from memory 113. The retrieved information/payload is made available to the reconfigurable digital logic processing device 114. At 1224, the reconfigurable digital logic processing device 114 processes the information/payload to generate a feed signal for the antenna array 117. The generated feed signal is determined based on the array factor coefficients used to dynamically reconfigure the digital logic processing device 114 to allow transmission beam forming in a desired direction of interest for transmission corresponding to the remote terrestrial communication system 120 or ground station 130. The feed signal is made available to the antenna array 117 through the RF front end 115. At step 1226, the antenna array 117 transmits the signal based on the feed signal generated by the reconfigurable digital logic processing device 114.

The method 1200 as performed by the various components of the LEO satellite 110 may be continuously or repeatedly performed at regular intervals. After completion of step 1220 or after completion of the step 1226, the method 1200 may continue at step 1210 by determining a change in the position of the satellite followed by the rest of the steps of the method 1200 as described.

FIG. 13 illustrates a LEO satellite deployment container 1300 used for the storage and transport of LEO satellite 110, as well as deployment of LEO satellite 110 into orbit from a satellite launch vehicle. According to some embodiments, a number of stowed LEO satellite 110 may be packed in a stack like configuration on top of one another on top of a deployment container base 1320. Containment members 1310a, 1310b, 1310c, and 1310d attached to the deployment container base 1320 may be used to contain a plurality of LEO satellite 110. On deployment of LEO satellite 110, any one of containment members 1310 may be activated to allow the removal of the LEO satellite 110 from the stack.

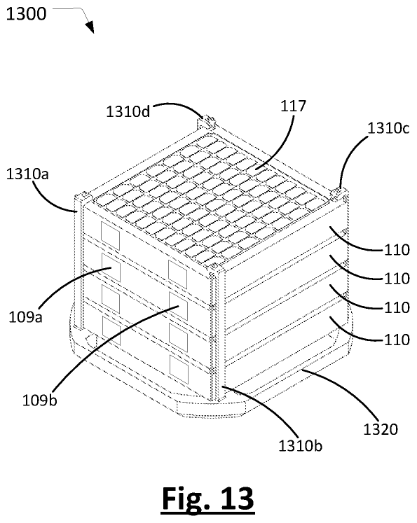

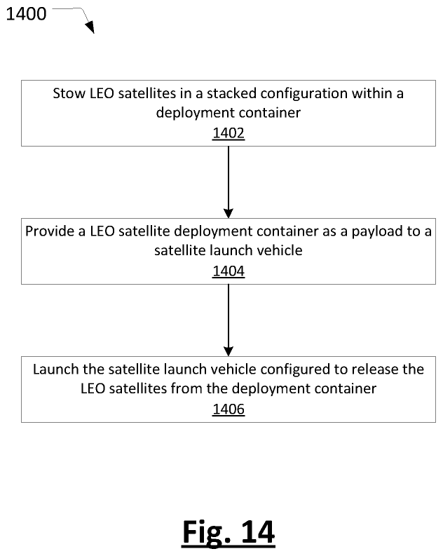

FIG. 14 is a flowchart of a method 1400 of launching a satellite launch vehicle configured to deploy in orbit a number of LEO satellite 110. At step 1402, a number of LEO satellite 110 according to embodiments are stowed within a deployment container 1300 as shown in FIG. 13. At step 1404, at least one deployment container 1300 according to embodiments is provided to a satellite launch vehicle. The deployment container 1300 may be integrated in a dispenser system which provides an interface between the deployment container 1300 and the launch vehicle, protecting the LEO satellite 110 during flight and allows the deployment of the LEO satellite as commanded by the launch vehicle. At step 1406, the satellite launch vehicle configured to release the LEO satellite 110 is launched from the surface of the Earth, following which LEO satellite 110 can be deployed for travel in a particular orbit.

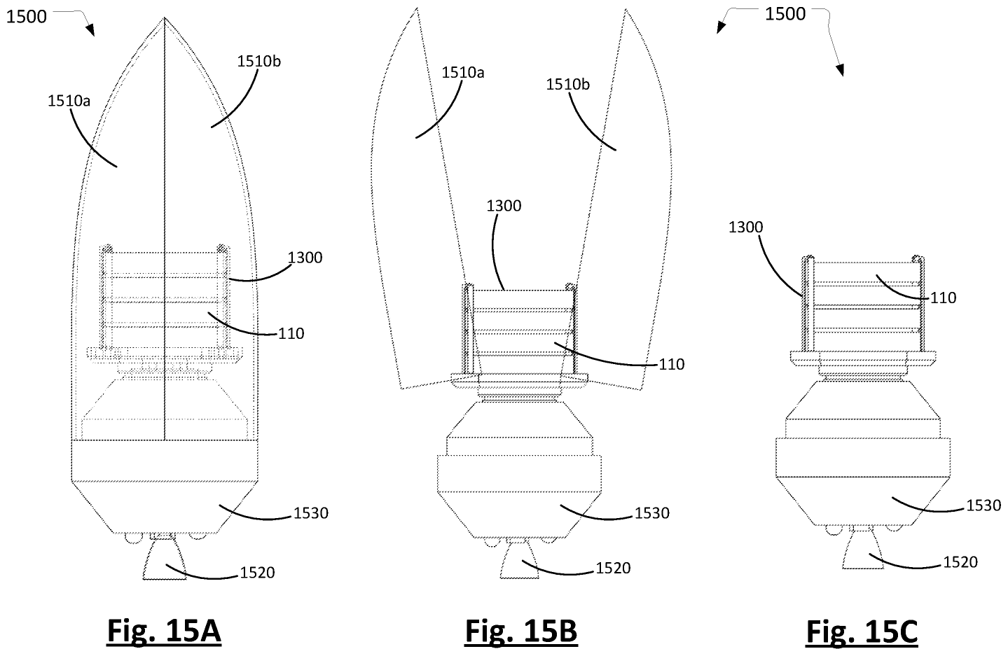

FIGS. 15A, 15B, and 15C show a satellite launch vehicle 1500 carrying satellite deployment container 1300 in preparation for deployment of at least one LEO satellite 110 and preferably multiple LEO satellites 110. FIG. 15A illustrates how a deployment container 1300 may be carried in some embodiments. In some embodiments, the launch vehicle 1500 may comprise a propulsion system 1520, a main body 1530 comprising components suitable for a satellite launch vehicle, and a detachable body 1510 for deployment of LEO satellite 110 as shown in FIG. 15B, wherein body parts 1510a and 1510b are able to be dislodged from the satellite launch vehicle, for example. FIG. 15C illustrates a satellite launch vehicle 1500 after dislodgment of detachable body 1510, carrying satellite deployment container 1300.

Some embodiments relate to installation in and/or on a microsatellite or nanosatellite chassis or housing: at least one processor, a memory accessible to the at least one processor, the memory storing an orbital schedule of a LEO satellite, and a communication sub-system accessible to the at least one processor. The communication sub-system comprises: an antenna array comprising two or more antenna elements; and a reconfigurable digital logic processing device in communication with the antenna array. The at least one processor is in communication with the reconfigurable digital logic processing device, and the at least one processor is configured to dynamically reconfigure the reconfigurable digital logic processing device to perform directional beamforming based on the orbital schedule by applying different transfer functions to signals simultaneously received or transmitted by multiple antenna elements of the antenna array over time.

FIG. 16 is a side cross-section view of antenna element 902 positioned in an antenna array frame 1602, according to some embodiments. Illustrated in FIG. 16 is a connecting element 1116, which forms a central portion positioned centrally on and between the parasitic element 1010 and the excitation element 1020. Also illustrated is a base plane 1602 that allows the mounting of the ground plane 1658 and the antenna element 902. Ground plane 1658 may house circuitry such as PCBs to process RF signals between the probe region 1050 and the RF front end 115. Screws 1608 affix the ground plane 1658 to the base plane 1602. Screw 1610 affixes the antenna element 902 to the base plane 1602. M2 and/or M3 screws may be used for coupling components to the base plane 1602. The base plane 1602 allows the entire antenna array 900 to be affixed to a chassis of the LEO satellite 110. Defined about a geometrical centre of the antenna element 902 is an axis 1612. There is also provided a probing element 1630 that allows RF communication between the excitation element 1020 and an RF feed connecting the excitation element with the RF front end 115. The galvanic coupling in the probing element 1630 can be replaced by capacitive coupling, or by an aperture coupling where a slot is manufactured in the ground plane.

Both the parasitic element 1010 and the excitation element 1020 may comprise corrugations 1620 defined by ridges such as ridge 1622 and grooves such as groove 1624. The corrugations as defined in both the parasitic element 1010 and the excitation element 1020 are substantially parallel. The corrugations allow a longer antenna element to be positioned in a smaller space providing greater RF transmission or reception capability in a more confined space. In the LEO satellite 110, space for the positioning element of a chassis of the satellite is often limited and the corrugations allow maximization of the RF communication capability despite the limited space available for the antenna array. In some embodiments, a distance between two adjacent ridges 1622 may be from 8 mm to 14 mm. In some embodiments, a distance between two adjacent ridges may be from 10 mm to 12 mm. In some embodiments, a depth of the groove 1624 may be from 0.5 mm to 1.5 mm. In some embodiments, a depth of the groove 1625 may be around 1 mm. The corrugations 1620 may be defined at a shallow angle. For example, in some embodiments, the corrugations 1620 may be defined at an angle of 2 degrees to 20 degrees. In some embodiments, the corrugations 1620 may be defined at an angle of 5 degrees to 15 degrees. In some embodiments, the corrugations 1620 may be defined at an angle of 8 degrees to 12 degrees.

The parasitic element 1010 and the excitation element 1020 of some embodiments may not comprise any corrugations. The parasitic element 1010 and the excitation element 1020 of some embodiments may have a rectangular or square substantially planar profile.

As illustrated in FIG. 16, a gap 1642 is provided between elements 1020 and 1010. In some embodiments, the gap 1642 may be an air gap and no dielectric material may be present in the gap 1642.

The surface corrugations of the parasitic element 1010 and the excitation element 1020 may be aligned with each other so that separation of the antenna patch bodies is substantially constant in a direction parallel to the central axis 1612.

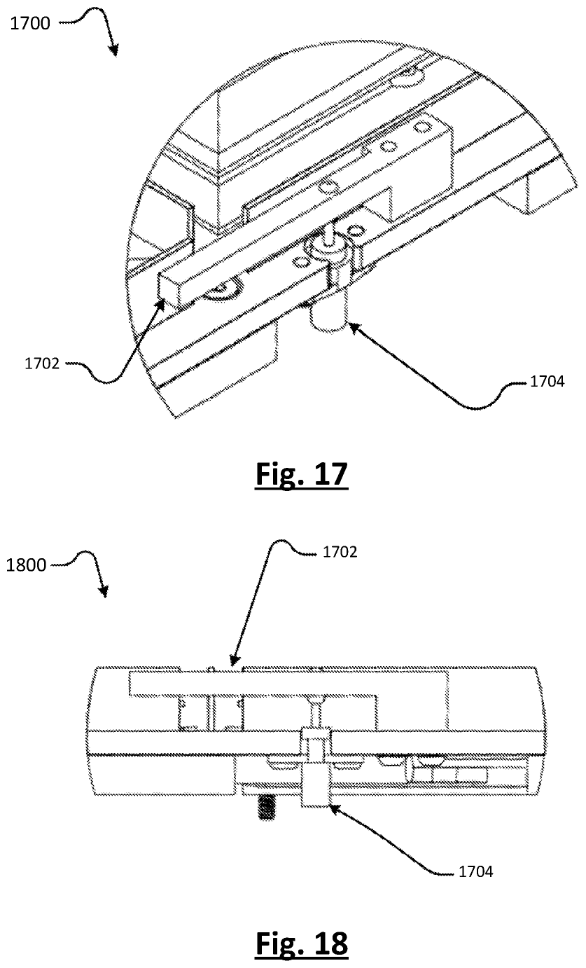

FIG. 17 illustrates a side view 1700 of a portion of the antenna array 900 as viewed from a side corresponding to the parasitic element 1010. FIG. 17 illustrates a tuning element 1702 in communication with the adapter 1704. The adapter 1704 in some embodiments may be constructed out of brass and is connected to an RF feed cable to convey signals between the tuning element 1702 and the RF front end 115.

FIG. 18 illustrates a side view 1800 showing a portion of the antenna array 900 illustrating the tuning element 1702 in communication with the adapter 1704.

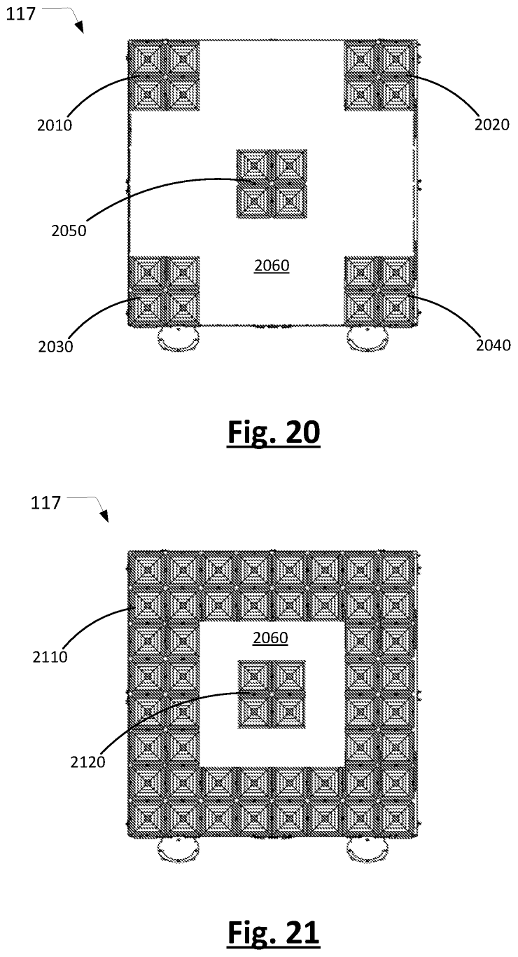

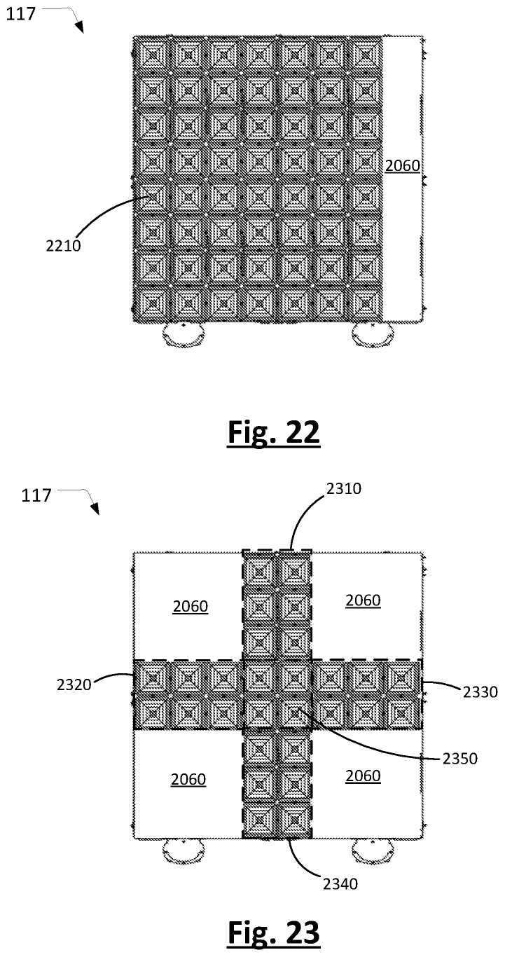

Various configurations of antenna array 117 are illustrated in FIG. 20, FIG. 21, FIG. 22, and FIG. 23, according to some embodiments. Antenna array 117 may include antenna subarrays comprising two-dimensional arrays of antenna elements 117a to 117n.

FIG. 20 illustrates an antenna array 117 configuration according to some embodiments comprising antenna subarrays 2010, 2020, 2030, 2040, and 2050, and non-antenna elements 2060. Antenna subarray 2010 is positioned in a first corner of the antenna array 117 adjacent to a first side and a second side of the LEO satellite 110. In a second corner of the antenna array 117, adjacent to the first side and a third side of the LEO satellite 110 is antenna subarray 2020. In a third corner of the antenna array 117, adjacent to the second side and a fourth side of the LEO satellite 110 is antenna subarray 2030. In a fourth corner of the antenna array 117, adjacent to the third side and the fourth side of the LEO satellite 110 is antenna subarray 2040. Positioned equidistant from antenna subarray 2010, 2020, 2030, and 2040 and centrally to the antenna array 117 is antenna subarray 2050 which is non-contiguous to antenna subarrays 2010, 2020, 2030, and 2040. Non-antenna space 2060 comprises space within the antenna array 117 that may be used for various alternate satellite related components. Non-antenna space 2060 consists of space within antenna array 117 that does not comprise an antenna element 117a to 117n. Any one of antenna subarray 2010, 2020, 2030, 2040, or 2050 may be omitted to produce an alternate antenna array configuration.

FIG. 21 illustrates an antenna array 117 configuration according to some embodiments comprising, antenna subarrays 2110 and 2120, and non-antenna element 2060. Antenna subarray 2110 is positioned adjacent to the four sides of LEO satellite 110. Antenna subarray 2110 includes contiguous antenna elements 117a to 117n, Positioned centrally to the antenna array 117 and the antenna subarray 2110 is antenna subarray 2120, which is non-contiguous to antenna subarray 2110. Non-antenna space 2060 comprises the space between antenna subarray 2110 and antenna subarray 2120. Non-antenna space 2060 forms a ring shape encompassing antenna subarray 2120, and is encompassed by antenna subarray 2110. Either one of antenna subarrays 2110 or 2120 may be omitted to produce an alternate antenna array configuration.

FIG. 22 illustrates an antenna array 117 configuration according to some embodiments comprising antenna subarray 2210 and non-antenna element 2060. Antenna subarray 2210 is adjacent to the first side, the second side, and the fourth side of the LEO satellite 110. In an alternate configuration, antenna subarray 2210 may be adjacent to any combination of three sides of the LEO satellite 110. Antenna subarray 2210 comprises one side not adjacent to a side of the LEO satellite 110, but adjacent to non-antenna space 2060. Non-antenna space 2060 is positioned between antenna subarray 2210 and the fourth side of the LEO satellite 110 non-adjacent to antenna subarray 2210.

FIG. 23 illustrates an antenna array 117 configuration according to some embodiments comprising antenna subarray 2310, 2320, 2330, 2340, and 2350, and non-antenna elements 2060. Antenna subarray 2350 is positioned centrally within antenna array 117, with each side of antenna subarray 2350 parallel with a side of the LEO satellite 110. Adjacent to a first side of antenna subarray 2350 and adjacent to the first side of LEO satellite 110 is antenna subarray 2310. On a second side of antenna subarray 2350 perpendicular to the first side of antenna subarray 2350 and adjacent to the second side of the LEO satellite 110 is antenna subarray 2320. On a third side of antenna subarray 2350 perpendicular to the first side of antenna subarray 2350, opposite the second side of antenna subarray 2350, and adjacent to the third side of the LEO satellite 110 is antenna subarray 2330. On a fourth side of antenna subarray 2350 perpendicular to the second and third sides of antenna subarray 2350, opposite the first side of antenna subarray 2350, and adjacent to the fourth side of the LEO satellite 110 is antenna subarray 2340. Positioned between adjoined perpendicular sides of antenna subarrays 2310, 2320, 2330, and 2340 and the adjoining side of the LEO satellite 110 is non-antenna space 2060. That is, in each corner of the front face of LEO satellite 110 and bordered by any one of antenna subarrays 2310, 2320, 2330, and 2340 is non-antenna space 2060. Any one of antenna subarray 2310, 2320, 2330, 2340, or 2350 may be omitted to produce an alternate antenna array configuration.

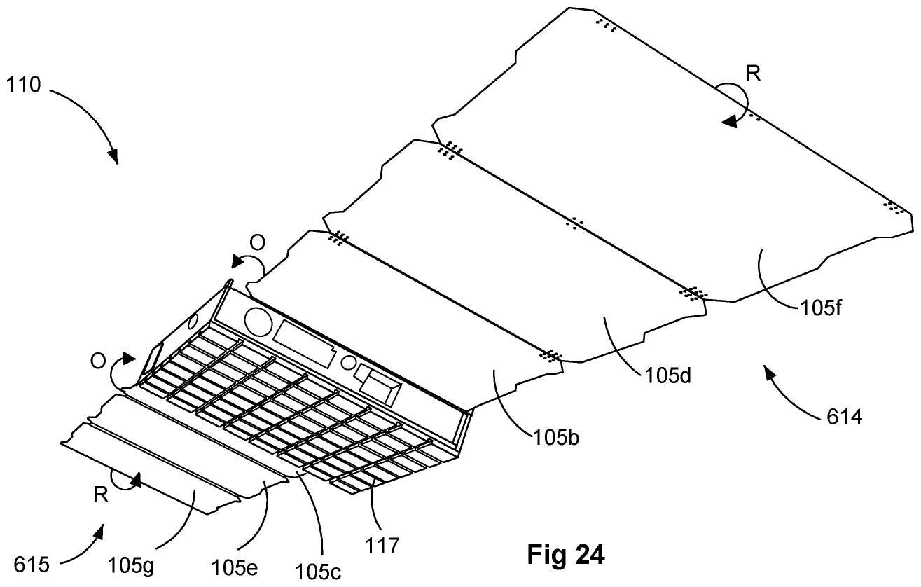

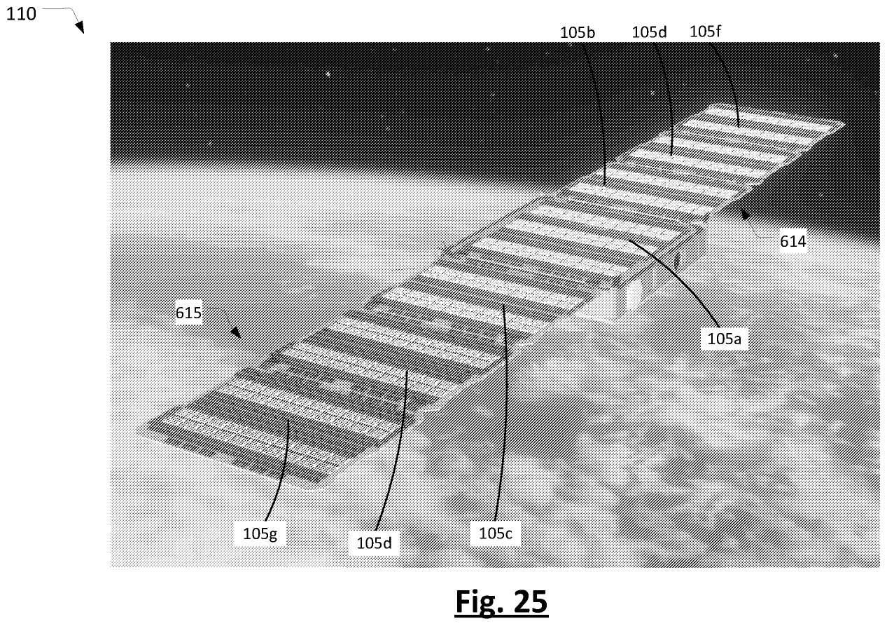

FIGS. 24 and 25 illustrate a three-dimensional view of an LEO satellite 110 according to some embodiments. As shown in FIGS. 24 and 25, the LEO satellite 110 includes a solar panel array comprising a solar panel 105a fixed to the back side of the LEO satellite 110, and two wings, 614 and 615, each comprising three solar panels, 105b to 105g. Solar panels 105a to 105n are coupled to one another by hinges 620 (FIG. 6). The hinges 620 may be spring-biased toward an open, extended position so that the panels 105b-105n can unfurl to the extended position once released to do so by a release mechanism (not shown) on the chassis. Each hinge 620 may include one or more conductors allowing electrical energy to pass from the solar panels 105b-105n to the electrical power system module 1911 (FIG. 19). In some embodiments, where each wing comprises an odd number of solar panels 105b to 105n, the solar panel of each wing pair distanced furthest from the body of the satellite will fold in a rotational direction towards the front side of the LEO satellite 110 as indicated by R. Each subsequent solar panel 105d to 105n, not including solar panels 105b and 105c, in each wing pair will fold in the same rotational direction towards the front side of the LEO satellite 110. Solar panels 105b and 105c will fold in an opposite direction towards the back side of LEO satellite 110 as indicated by O. This method of stowing the solar array 105 ready for deployment allows for a solar panel 105n to be facing away from the body of the LEO satellite 110 when in a stowed configuration.

In some embodiments, wherein each wing comprises an even number of solar panels 105b to 105n, the solar panel of each wing pair distanced furthest from the body of the satellite will fold in a rotation direction towards the front side of the LEO satellite 110 as indicated by R. Each subsequent solar panel 105b to 105n in each wing pair will rotate in an alternating order of direction O, then direction R. That is, the direction of rotation for a wing pair with an even number of solar panels, and beginning with the solar panel distanced furthest from the body of the LEO satellite 110, will be a continuous form of R, O, R, O, until the solar array 105 is in a stowed configuration. This method of stowing the solar array 105 ready for deployment allows for a solar panel 105n to be facing away from the body of the LEO satellite 110 when in a stowed configuration.

In some embodiments, solar panels 105b to 105n will fold so that when in a stowed configuration a solar panel 105n will be facing away from the body of the LEO satellite 110.

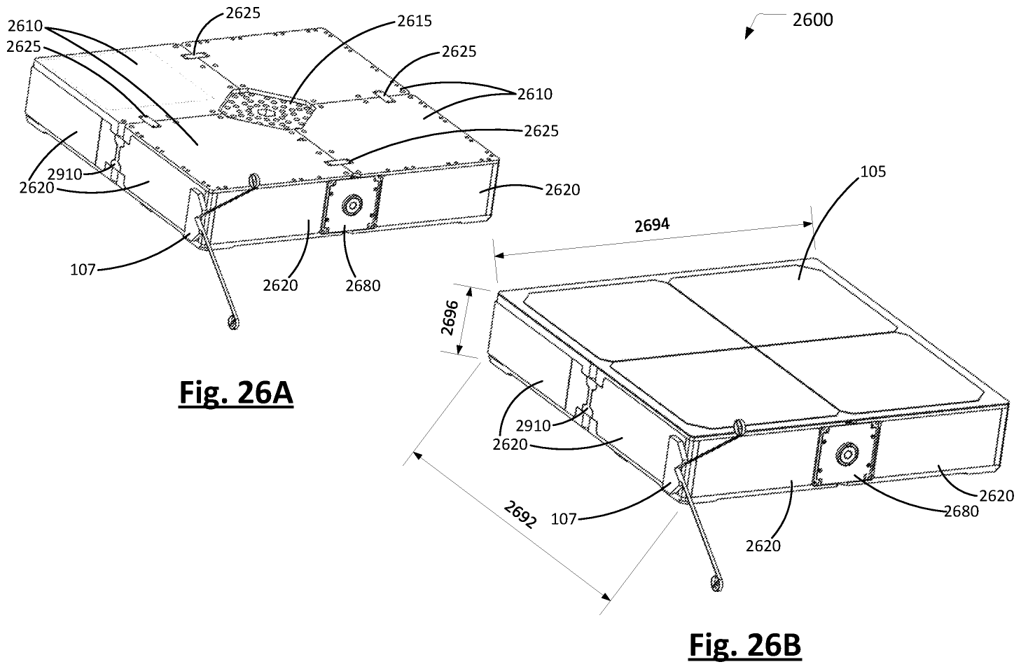

FIG. 26A shows a back perspective view of an alternate LEO satellite architecture of LEO satellite 110, according to some embodiments. The alternate LEO satellite architecture of LEO satellite 110 will be referred to as LEO satellite 2600 hereafter. In some embodiments, LEO satellite 2600 may be the same shape, size, and weight as previously described embodiments of LEO satellite 110. LEO satellite 2600 is similar to LEO satellite 110 in its form factor and functions but has a modified internal and external support structure and has an alternative antenna arrangement.

LEO satellite 2600 comprises a plurality of side panels 2620. In some embodiments, LEO satellite 2600 may comprise up to eight side panels 2620. In some embodiments, the side panels 2620 may be rectangular in shape, as shown in FIG. 26A. The side panels 2620 may be used to provide protection to components housed within the LEO satellite 2600, for example. That is, the side panels 2620 may form part of an external side face of the LEO satellite 2600, for example.

LEO satellite 2600 further comprises a plurality of back panels 2610. In some embodiments, LEO satellite 2600 may comprise up to four back panels 2610. In some embodiments, the back panels 2610 may be approximately square in shape (other than for a cut-out corner portion), as shown in FIG. 26A. The back panels 2610 may be used to provide structural support to the LEO satellite 2600. In some embodiments, the back panels 6210 may provide protection to internal components housed within the LEO satellite 2600, for example.

LEO satellite 2600 further includes a back connecting panel 2615. In some embodiments, back panels 2610 are arranged in a rectangular fashion around the back connecting panel 2615. Back panels 2610 may be partially mounted to the back connecting panel 2615, for example. In some embodiments, back connecting panel 2615 includes an aperture in its centre to allow for electrical wiring to pass through, for example. Joining, and mounted to, each adjacent pair of back panels 2610 is a respective joining plate 2625. In some embodiments, joining plates 2625 may be used to join each adjacent pair of back panels 2610 to one another. The back panels 2610 may define a back side, or a second major face of the satellite. The back side, or second major face, may be or define an outer surface of the LEO satellite 2600.

In some embodiments, the back connecting panel 2615 may be slightly recessed from the outer surface defined by the back panels 2610. In some embodiments, the back connecting panel 2615 may be generally flush with the outer surface defined by the back panels 2610. In some embodiments, the back connecting panel 2615 may be slightly proud of the outer surface defined by the back panels 2610.

LEO satellite 2600 further comprises a propulsion system 2680. In some embodiments, propulsion system 2680 may be a commercially available product, such as a Field-emission electric propulsion (FEEP) thruster from ‘Enpulsion’, for example.

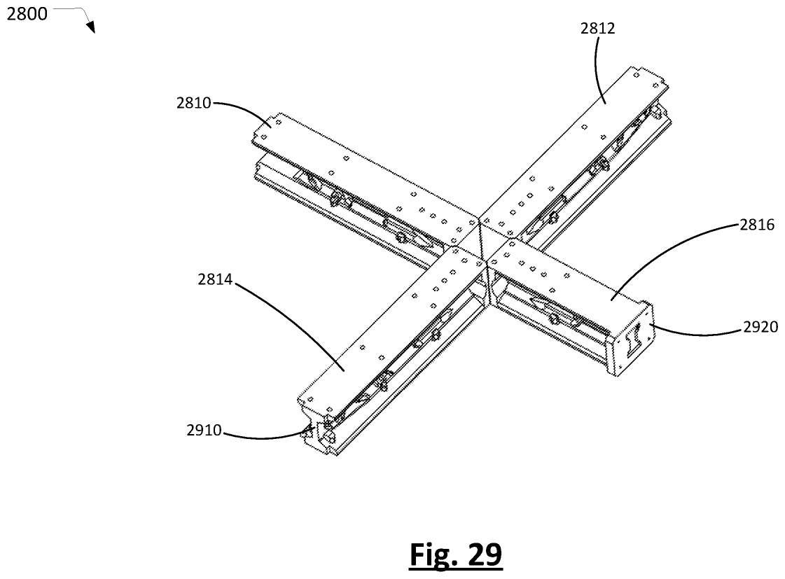

Referring to FIG. 26B, in some embodiments, LEO satellite 2600 may further include a solar array 105 coupled to the back of the LEO satellite 2600. That is, the solar array 105 may be coupled to the outer surface defined by the back panels 2610, for example. In some embodiments, a plurality of solar panels of solar array 105 may be coupled to any one or more of the back panels 2610, the back connecting panel 2615, the joining plates 2625, and/or a support structure 2800 (FIG. 29), for example. In some embodiments, a single solar panel of solar array 105 may be coupled to the back of the LEO satellite 2600. The single solar panel of solar array 105 may substantially cover the entire back side of the LEO satellite 2600, except for some side edge areas of the back side.

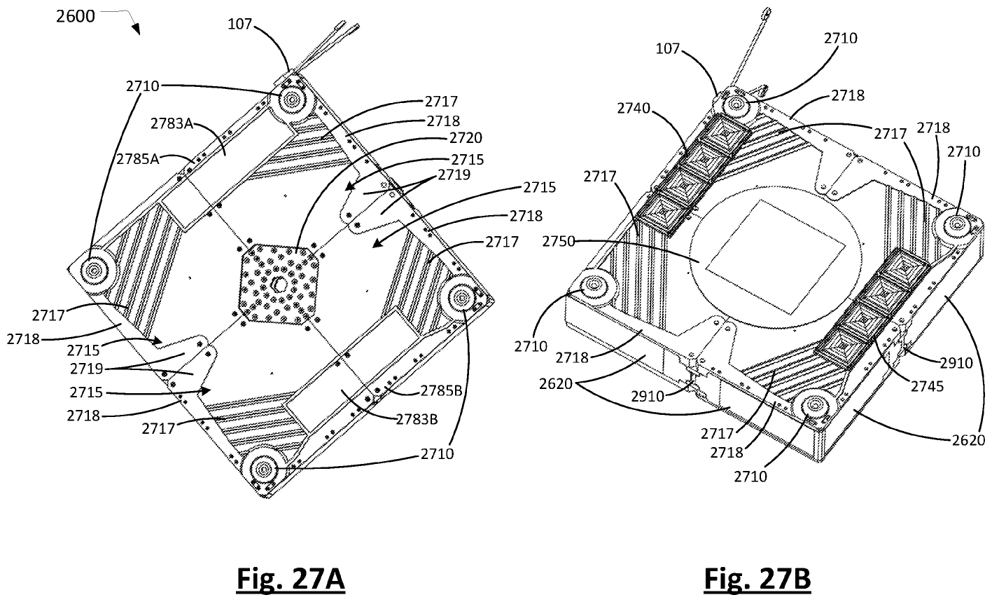

FIG. 27A shows a front perspective view of the alternate LEO satellite architecture, LEO satellite 2600, according to some embodiments. LEO satellite 2600 further comprises front panels 2715. In some embodiments, LEO satellite 2600 may comprise up to four front panels 2715. The front panels 2715 may be approximately square in shape (other than for a cut-out corner portion), as shown in FIG. 27A. The front panels 2715 may be used to provide structural support to the LEO satellite 2600. Front panels 2715 may redirect impact, vibrational, and/or load forces towards the support structure 2800. In some embodiments, the front panels 2715 may provide protection to internal components housed within the LEO satellite 2600, for example. LEO satellite 2600 may further include a plurality of mounting points 2710. Mounting points 2710 may be used during deployment to couple the LEO satellite 2600 to a deployment container 1300. In some embodiments, mounting points 2710 may be used during deployment to detachably couple the LEO satellite 2600 to a satellite launch vehicle 1500. That is, each mounting point 2710 is configured for releasable coupling of the LEO satellite 2600 to a deployment container, for example. LEO satellite 2600 may include four mounting points 2710 at respective corners, for example.

Referring to FIG. 26B, LEO satellite 2600 has a length 2692. The length 2692 of the LEO satellite 2600 of various embodiments may be within a range of about 270 mm to 1050 mm, 400 mm to 800 mm, or 500 mm to 600 mm, for example. Example lengths further include 275, 325, 350, 375, 425, 450, 475, 525, 550, 575, 625, 650, 675, 725, 750, 775, 825, 850, 875, 925, 950, 975, 1000 and 1025 mm.

Referring to FIG. 26B, LEO satellite 2600 has a width 2694. The width 2694 of the LEO satellite 2600 of various embodiments may be within a range of about 270 mm to 1050 mm, 400 mm to 800 mm, or 500 mm to 600 mm, for example. Example widths further include 275, 325, 350, 375, 425, 450, 475, 525, 550, 575, 625, 650, 675, 725, 750, 775, 825, 850, 875, 925, 950, 975, 1000 and 1025 mm.

Referring to FIG. 26B, LEO satellite 2600 has a depth 2696. The depth 2696 is a measurement from a first plane that generally coincides with the outer surface defined by the plurality of back panels 2610 to a second plane that generally coincides with the front outer surface defined by the plurality of front panels 2715, for example. The depth 2696 of the LEO satellite 2600 of various embodiments may be within a range of about 90 mm to 210 mm, 125 mm to 175 mm, or 140 mm to 160 mm, for example. Example depths further include 95, 105, 110, 115, 120, 125, 130, 135, 140, 145, 150, 155, 160, 165, 170, 175, 180, 185, 190, 195, and 205 mm. The depth of the LEO satellite 110 of various embodiments may be equal to or less than a third of the length or the width of the LEO satellite 110.

LEO satellite 2600 further comprises a front connecting panel 2720. In some embodiments, front panels 2715 are arranged in a rectangular fashion around the front connecting panel 2720. Each front panel 2715 may be partially mounted to the front connecting panel 2720, for example. In some embodiments, front connecting panel 2720 includes an aperture in its centre to allow for electrical wiring to pass through, for example. The front panels 2715 may define a front side, or a first major face of the satellite. The front side, or first major face, may be an outer surface of the LEO satellite 2600. In some embodiments, the front connecting panel 2720 may be slightly recessed from the outer surface defined by the front panels 2715. In some embodiments, the front connecting panel 2720 may be generally flush with the outer surface defined by the front panels 2715. In some embodiments, the front connecting panel 2720 may be slightly proud of the outer surface defined by the front panels 2715.

In some embodiments, each front panel 2715 may further include a thickened edge portion 2718. The thickened edge portion 2718 may assist in transferring impact, vibrational, and/or load forces from the plurality of mounting points to the support structure 2800. In some embodiments, the thickened edge portions 2718 may further define a part of the front side of the LEO satellite 2600. In some embodiments, the thickened edge portions 2718 of each front panel 2715 may include an inwardly extending lobe portion 2719. The inwardly extending lobe portion 2719 may extend from the outer edge of the front panel towards the centre of the front side. The inwardly extending lobe portion 2719 may strengthen the connection of its respective front panel to the underlying support structure 2800 when fastened thereto.

In some embodiments, the front panels 2715 of LEO satellite 2600 may further include reinforcers 2717. Reinforcers 2717 may be a plurality of ridges or ribs formed or disposed on the plurality of front panels 2715. That is, reinforcers 2717 may protrude in a direction away from the plurality of front panels 2715, for example. Reinforcers 2717 may assist in transferring impact, vibrational, and/or load forces from the plurality of mounting points to the support structure 2800. In some embodiments, reinforcers 2717 may also reduce the impact of heat radiation on the LEO satellite 2600 due to their indirect positioning relative to the Earth, for example.

In some embodiments, the reinforcers 2717 may define a part of the front side of the LEO satellite 2600. In some embodiments, reinforcers 2717 may be disposed diagonally at an angle across each front panel 2715. That is, reinforcers 2717 may run between adjacent side edges of the front side of the LEO satellite 2600, for example. In some embodiments, reinforcers 2717 may have an approximately triangular cross-sectional profile. In some embodiments, reinforcers 2717 may have an approximately trapezoidal cross-sectional profile. In some embodiments, reinforcers 2717 may be spaced from one another by about a distance equal to the width of the reinforcers 2717.

The front panels 2715 may further define a plurality of antenna mounting portions 2783 (2783A and 2783B). Antenna mounting portions 2783 may define mounting locations for a first antenna array 2740 or a second antenna array 2745 (FIG. 27B). The antenna mounting portions 2783 may be disposed over a single front panel 2715, for example. The antenna mounting portion 2783 may be disposed over a plurality of front panels 2715, for example. In some embodiments, antenna mounting portion 2783A is offset relative to antenna mounting portion 2783B. That is, antenna mounting portion 2783A may be asymmetrically positioned on the front side of the LEO satellite 2600, for example.

In some embodiments, antenna mounting portion 2783A may be inset from the outer side edge of the LEO satellite 2600 by edge portion 2785A. That is, edge portion 2785A may separate the actual edge of the LEO satellite 2600 from the edge of the antenna mounting portion 2783A, for example. In some embodiments, antenna mounting portion 2783B may be inset from the outer side edge of the LEO satellite 2600 by edge portion 2785B. That is, edge portion 2785B may separate the actual edge of the LEO satellite 2600 from the edge of the antenna mounting portion 2783B, for example. Edge portion 2785B may separate the actual edge of the LEO satellite 2600 from the edge of the antenna mounting portion 2783B by a distance different from (e.g. greater than) the distance of edge portion 2785A.

FIG. 27B shows a front perspective view of the alternate LEO satellite 2600 including a plurality of antennae, according to some embodiments. In some embodiments, LEO satellite 2600 may further include an antenna 2750 coupled to the outer surface defined by the front panels 2715 of the LEO satellite 2600. That is, the antenna 2750 may be coupled to the front side of the LEO satellite 2600, for example. In some embodiments, antenna 2750 may be a UHF radio antenna 107. That is, antenna 2750 may be configured to operate in a UHF frequency range, for example. In some embodiments, the antenna 2750 is configured to operate between about 350 MHz to about 470 MHz, for example. In some embodiments, the antenna 2750 is configured to have a bandwidth of about 100 MHz, for example. In some embodiments, antenna 2750 may weigh between about 2 kgs to about 3 kgs, for example. In some embodiments, antenna 2750 may weigh between about 2 kgs to about 2.5 kgs, for example.

In some embodiments, antenna 2750 may be a patch antenna. In some embodiments, antenna 2750 may be an antenna array, for example. In some embodiments, antenna 2750 may include multiple antennas, for example. In some embodiments, antenna 2750 may be a patch antenna array, as previously described in relation to FIGS. 8 and 9. The patch antenna array may have a corrugated patch configuration. The patch antenna array may be a cupped stacked patch antenna array. In some embodiments, the antenna 2750 may be manufactured in part, or completely, from aluminium.

In some embodiments, LEO satellite 2600 may further include a first antenna array 2740. In some embodiments, LEO satellite 2600 include a second antenna array 2745. The first antenna array 2740 may comprise a plurality of antenna elements 117a to 117n. The first antenna array 2740 may comprise four antenna elements 117a to 117d, for example. The second antenna array 2745 may comprise a plurality of antenna elements 117a to 117n. The second antenna array 2745 may comprise four antenna elements 117a to 117d, for example. In some embodiments, the first antenna array 2740 may be a patch antenna array, as previously described in relation to FIGS. 8 and 9. In some embodiments, the second antenna array 2745 may be a patch antenna array, as previously described in relation to FIGS. 8 and 9. The patch antenna array may have a corrugated patch configuration. The patch antenna array may be a cupped stacked patch antenna array.

In some embodiments, the first antenna array 2740 may be coupled to the outer surface defined by the front panels 2715. That is, the first antenna array 2740 may be coupled to the front side of the LEO satellite 2600, for example. In some embodiments, the first antenna array 2740 may be mounted within a first space defined by the antenna portions 2783. In some embodiments, the second antenna array 2745 may be coupled to the outer surface defined by the front panels 2715. That is, the second antenna array 2745 may be coupled to the front side of the LEO satellite 2600, for example. In some embodiments, the second antenna array 2745 may be mounted within a second space defined by the antenna portions 2783. In some embodiments, the first antenna array 2740 and the second antenna array 2745 or on opposite sides of the antenna 2750. That is, the first antenna array 2740 and the second antenna array 2745 may be spatially separated from one another by antenna 2750, for example.

In some embodiments, the first antenna array 2740 may be a transmitting antenna array. That is first antenna array 2740 may transmit radio signals, for example. In some embodiments, the first antenna array 2740 may be a receiving antenna array. That is first antenna array 2740 may receive radio signals, for example. In some embodiments, the first antenna array 2740 may be both a transmitting and receiving antenna array. That is first antenna array 2740 may transmit and receive radio signals, for example. In some embodiments, the first antenna array 2740 is configured to use the digital beamforming communication method of communications system 200, as previously described. In some embodiments, the first antenna array 2740 may be an S band antenna array.

In some embodiments, the second antenna array 2745 may be a transmitting antenna array. That is second antenna array 2745 may transmit radio signals, for example. In some embodiments, the second antenna array 2745 may be a receiving antenna array. That is second antenna array 2745 may receive radio signals, for example. In some embodiments, the second antenna array 2745 may be both a transmitting and receiving antenna array. That is second antenna array 2745 may transmit and receive radio signals, for example. In some embodiments, the second antenna array 2745 is configured to use the digital beamforming communication method of communications system 200, as previously described. In some embodiments, the second antenna array 2745 may be an S band antenna array.

In some embodiments, only one of the first antenna array 2740 or the second antenna array 2745 is configured to use the digital beamforming communication method of communications system 200, as previously described. That is, if the first antenna array 2740 is configured to use the digital beamforming communication method of communications system 200, then the second antenna array 2745 is not configured to use the digital beamforming communication method of communications system 200, for example. Similarly, if the second antenna array 2745 is configured to use the digital beamforming communication method of communications system 200, then the first antenna array 2740 is not configured to use the digital beamforming communication method of communications system 200, for example.

In some embodiments, the first antenna array 2740 and the second antenna array 2745 may be offset from one another. In some embodiments, the first antenna array 2740 and the second antenna array 2745 may be offset from one another to allow room for a third antenna array. That is, either the first antenna array 2740 or the second antenna array 2745 may be offset from the other to provide more room for an additional third antenna array. In some embodiments, any one of or more of the first antenna array 2740, the second antenna array 2745, and/or the third antenna array may be recessed into the front panels 2715, for example. In embodiments where the first antenna array 2740 is configured to act as both a transmit antenna array and a receive antenna array, it may be beneficial to position it closer to the DBF payload 1923, due to electrical communication limitations. In some embodiments, the surface area of the front panels 2715 not covered by any one of the antenna 2750, the first antenna array 2740, the second antenna array 2745, and/or the third antenna array is non-antenna space 2060. Non-antenna space 2060 is as previously described in relation to FIGS. 20 to 23.

In some embodiments, antenna 2750 may cover about 50% to about 75% of the outer front surface defined by the plurality of front panels 2715, for example. In some embodiments, antenna 2750 may cover about 55% to about 70% of the outer surface defined by the plurality of front panels 2715, for example. In some embodiments, antenna 2750 may cover about 60% to about 65% of the outer surface defined by the plurality of front panels 2715, for example. In some embodiments, antenna 2750 may cover about 50% to about 60% of the outer surface defined by the plurality of front panels 2715, for example.

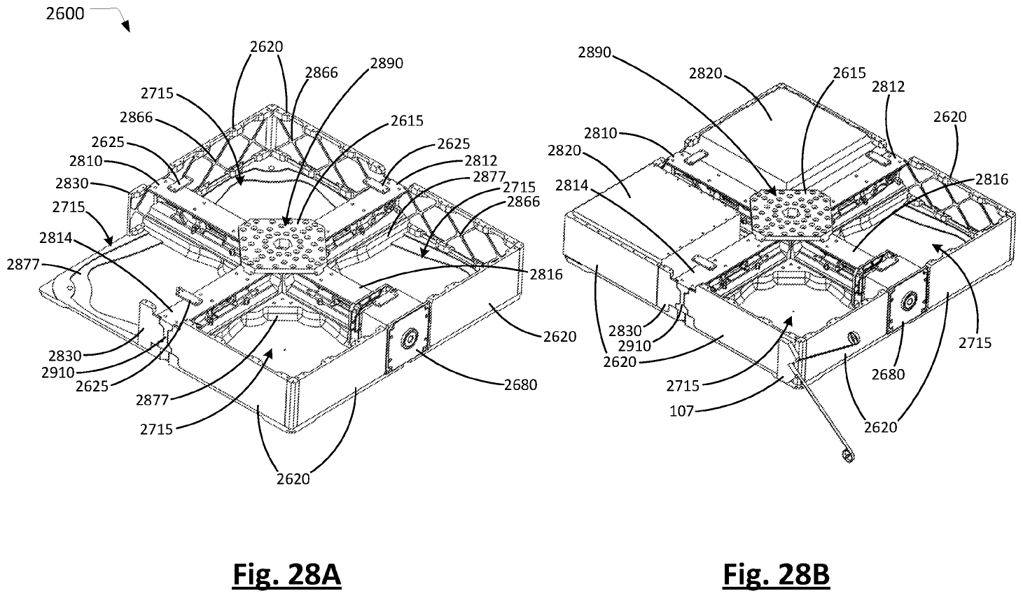

FIGS. 28A and 28B show back perspective views of the LEO satellite 2600, according to some embodiments. LEO satellite 2600 may further include a plurality of support beams 2810, 2812, 2814, and 2816. The plurality of support beams 2810, 2812, 2814, and 2816 form a support structure 2800. The support structure 2800 may be arranged in a ‘cross’ formation as shown in FIG. 29. In some embodiments, the plurality of support beams 2810, 2812, 2814, and 2816 are coupled together via both the front connecting plate 2720 and the back connecting plate 2615, for example. In some embodiments, support beams 2810, 2812, 2814, and 2816 may all be the same shape, length, and size.

In some embodiments, support beam 2816 may have a shorter length than support beams 2810, 2812, and 2814 to allow room for propulsion system 2680. Support beam 2816 may further include a coupling plate 2920 (FIG. 29) on one end to couple the propulsion system 2680 to the support structure 2800. Propulsion system 2680 may be coupled to support beam 2816 so that the external surface of the propulsion system 2680 is flush with the adjacent side panels 2620, for example. That is, the propulsion system 2680 may extend internally in the direction of support beam 2816 into the LEO satellite 2600, for example. In some embodiments, propulsion system 2680 may be centrally positioned relative to the support structure. That is, the propulsion system 2680 may be coupled to support beam 2816 at a symmetrical axis of the support structure 2800, for example. In some embodiments, the side panels 2620 positioned adjacent to the propulsion system 2680 may be of a shorter length to accommodate the propulsion system 2680.

In some embodiments, the plurality of support beams 2810, 2812, 2814, and 2816 may include a plurality of ‘cut-outs’ where webbing material of the support beams 2810, 2812, 2814, and 2816 is omitted. That is, portions of the web of the support beams 2810, 2812, 2814, and 2816 may be omitted, for example. The plurality of cut-outs may reduce the weight of the support structure 2800 whilst also maintaining its structural integrity. Support beams 2810, 2812, and 2814 each comprise an end face 2910. End face 2910 may form part of the external side face of the LEO satellite 2600. That is, end face 2910 may be flush with side panels 2620, for example.

In some embodiments, the front connecting panel 2720 may be coupled to the back connecting panel 2615. That is, the front connecting panel 2720 and the back connecting panel 2615 may be coupled together, sandwiching the support structure 2800 between them. The assembled structure of the front connecting panel 2720, the back connecting panel 2615, and the support structure 2800 results in a central hub 2890 at a centre of the LEO satellite 2600. In some embodiments, the plurality of front panels 2715 may be coupled to the plurality of back panels 2610. That is, the plurality of front panels 2715 and the plurality of back panels 2610 may be coupled together, sandwiching the front connecting panel 2720, the support structure 2800, and the back connecting panel 2615, for example.

In some embodiments, side panels 2620 may further include support truss 2866. Support truss 2866 may provide additional structural support to the side panels 2620, increasing their load bearing capacities. In some embodiments, each of the front panels 2715 may further comprise ridged portions 2877. Ridge portions 2877 may increase structural integrity and load bearing capability of the front panels 2715. Ridge portions 2877 may better facilitate load transfer through each front panel 2715 to the support structure 2800. In some embodiments, each of the back panels 2610 may further comprise ridged portions 2877. Ridge portions 2877 may increase structural integrity and load bearing capability of the back panels 2610. Ridge portions 2877 may better facilitate load transfer through each back panel 2610 to the support structure 2800.

In some embodiments, the front connecting panel 2720 may be coupled to the support structure 2800 using fasteners. That is, the front connecting panel 2720 may be coupled to the plurality of support beams 2810, 2812, 2814, and 2816 using bolts, for example. In some embodiments, the back connecting panel 2615 may be coupled to the support structure 2800 using fasteners. That is, the back connecting panel 2615 may be coupled to the plurality of support beams 2810, 2812, 2814, and 2816 using bolts, for example. In some embodiments, the front connecting panel 2720 and the back connecting panel 2615 may share the same fasteners to couple to the support structure 2800.

In some embodiments, each front panel 2715 may be coupled to the support structure 2800 using fasteners. That is, each front panel 2715 may be coupled to the support structure 2800 using bolts, for example. In some embodiments, each front panel 2715 is coupled to at least two of the plurality of support beams 2810, 2812, 2814, and 2816. In some embodiments, each front panel 2715 may also be coupled to the front connecting panel 2720 using fasteners.

In some embodiments, each back panel 2610 may be coupled to the support structure 2800 using fasteners. That is, each back panel 2610 may be coupled to the support structure 2800 using bolts, for example. In some embodiments, each back panel 2610 is coupled to at least two of the plurality of support beams 2810, 2812, 2814, and 2816. In some embodiments, each back panel 2610 may also be coupled to the back connecting panel 2615 using fasteners. In some embodiments, each front panel 2720 and its respective directly opposing back panel 2610 may share the same fasteners to couple to the support structure 2800 and/or the front connecting panel 2720, and/or the back connecting panel 2615.

In some embodiments, each side panel 2620 may be coupled to a front panel 2720, a back panel 2610, and one of the plurality of support beams 2810, 2812, 2814, and 2816. That is, each side panel 2620 may be coupled to a front panel 2720 and its respective directly opposing back panel 2610, and one of the plurality of support beams 2810, 2812, 2814, or 2816 adjacent to the side panel 2620 using bolts, for example.

LEO satellite 2600 further includes a plurality of payload receiving spaces for housing various payloads, such as DBF payload 1923 or another satellite communications payload or a hosted payload, for example, as previously described in relation to FIGS. 7 and 19. The plurality of payload spaces may be defined by the area between adjacent support beams 2810, 2812, 2814, and 2816, the front panels 2715, and the back panels 2610, for example. For example, a payload receiving space may be defined by the area between adjacent support beams 2810 and 2812, the adjacent front panel 2715 and the adjacent back panel 2610. In some embodiments, a payload 2820 may be housed within one of the plurality of payload receiving spaces, as shown in FIG. 28B. In some embodiments, an external housing of the payload 2820 may also act as at least part of a side panel 2620, as shown in FIG. 28B. In embodiments where the payload 2820 acts as a side panel 2620, the LEO satellite 2600 further comprises a plurality of short side panels 2830. Short side panels 2830 may be used to couple a payload 2820 to the corresponding adjacent support beams 2810, 2812, 2814, and/or 2816 and assist to enclose an internal space of the satellite body, for example. In some embodiments, short side panels 2830 may be flush with side panels 2620 and/or end faces 2910. Short side panels 2830 may form part of the external side face of the LEO satellite 2600.

In some embodiments, each short side panel 2830 may be coupled to a front panel 2720, a back panel 2610, and one of the plurality of support beams 2810, 2812, 2814, and 2816. That is, each short side panel 2830 may be coupled to a front panel 2720 and its respective directly opposing back panel 2610, and one of the plurality of support beams 2810, 2812, 2814, or 2816 adjacent to the short side panel 2830 using bolts, for example.

In some embodiments, LEO satellite 2600 may comprise four payload receiving spaces. In some embodiments, internal subsystems 1900 may be housed within one of the plurality of payload receiving spaces. In some embodiments, where LEO satellite 2600 includes a DBF payload 1923, it is preferable that the DBF payload 1923 is housed in a payload space closest to the antenna array that is configured to use the digital beamforming communication method. That is, if the first antenna array 2740 is configured to use the digital beamforming communication method of communications system 200, then the DBF payload 1923 will be ideally positioned in a payload space closest to the first antenna array 2740, for example. Similarly, if the second antenna array 2745 is configured to use the digital beamforming communication method of communications system 200, then the DBF payload 1923 will be ideally positioned in a payload space closest to the second antenna array 2745, for example.

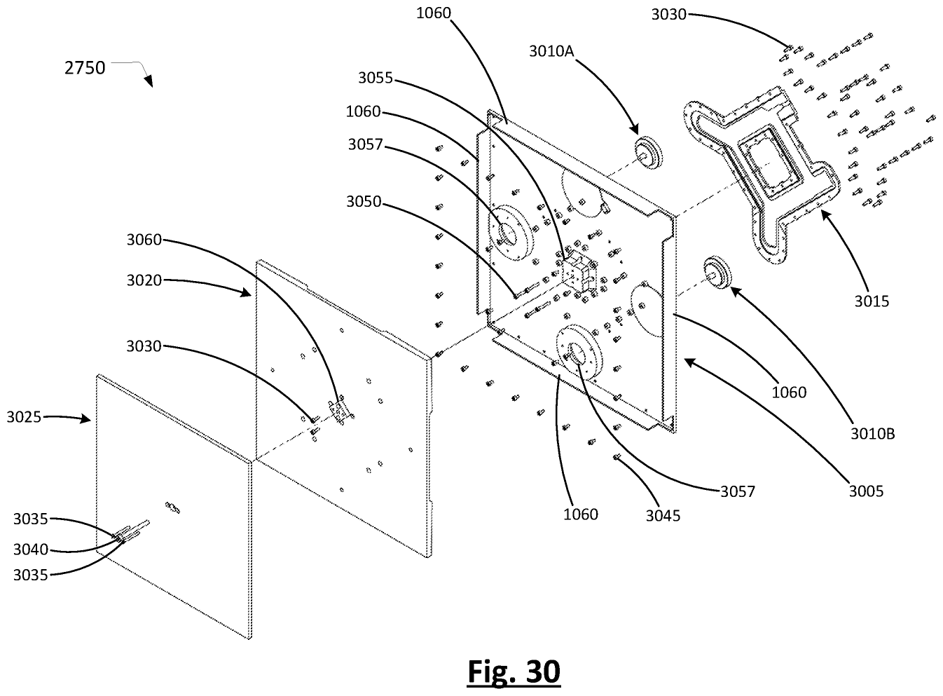

FIG. 30 shows an example exploded-view of an antenna 2750, according to some embodiments. In some embodiments, antenna 2750 has a cupped stacked patch configuration. In some embodiments, antenna 2750 may have a corrugated patch configuration. The antenna 2750 comprises two coaxial probes 3010A and 3010B. The probes 3010A and 3010B are orthogonal to each other (i.e. angularly separated by about 90 degrees relative to a bottom centre post portion 3055) and may be axially fixed to withstand vibrations during a launch of the LEO satellite 110. Probes 3010 may further include at least two washers. Probes 3010 may function similarly to probes 910 and 920, as previously described. The probes 3010A and 3010B may be sandwiched between a ground plane 3005 and a PCB cover 3015. The PCB cover 3015 may provide protection to various components coupled to the ground plane 3005. PCB cover 3015 is coupled to the ground plane via a plurality of fasteners 3030.

The ground plane 3005 acts as a simulated electrical ground. The ground plane 3005 may be embedded in or positioned on or incorporated in an outer part or subframe of a chassis of the LEO satellite 2600, for example. The ground plane 3005 may function similarly to cup 1030, as previously described. The ground plane 3005 further comprises four walls 3080 that extend in a direction away from the satellite body. Each wall 3080 of the ground plane 3005 is oriented to longitudinally extend perpendicular to the two adjacent walls 3080. Each wall 3080 may have a height of about 22.45 mm. Each wall 3080 effectively covers a side edge of the lower most patch 3020 of the antenna 2750.

Antenna 2750 comprises a first (upper) parasitic element/patch 3025 and a second (lower) excitation element/patch 3020. In some embodiments, patch 3025 and patch 3020 may function similarly to patch 1010 and patch 1020, respectively, as previously described. The ground plane 3005 has two openings 3057 through which the probes 3010A and 3010B pass towards the patches 3025 and 3020. The two patches 3025 and 3020 are mechanically supported by a centre post, the centre post comprising a middle centre post portion 3060 and a bottom centre post portion 3055. The lower patch 3020 is galvanically excited via the two orthogonal coaxial probes 3010A and 3010B. In some embodiments, the lower patch 3020 can be excited by contactless electromagnetic couplings either by a proximity probe (capacitive coupling excitation) or through a slot manufactured in the ground plane (aperture coupled excitation).

In some embodiments, underneath patch 3020 lies a microstrip hybrid network (not shown). The microstrip hybrid network may create two ports, one Right Hand Circular Polarised (RHCP) port and another Left Hand Circular Polarised (LHCP) port. Accordingly, some embodiments use left hand or right hand circular polarisation of transmissions. Incorporation of left hand or right hand circular polarisation of transmissions allows for a simultaneous transmission of two independent signals, a first signal using the RHCP port and a second signal using the LHCP port. The two simultaneously transmitted signals comprise oscillations in planes orthogonal to each other, as opposed to oscillation in a singularly polarised transmission. Circularly polarised transmissions are more robust in response to problems associated with signal reflection or lack of a clear line of sight to a transmission target.

The lower patch 3020 and the ground plane 3005 are coupled together via fastening means, such as at least two fasteners 3030. The at least two fasteners 3030 attach to the bottom centre post portion 3055 of the ground plane 3005 via the middle centre post portion 3060 of the lower patch 3020. The at least two fasteners 3030 may be ISO 4762 M3x10-10N bolts, for example. The upper patch 3025 is coupled to the lower patch 3020 and the ground plane 3005 via fastening means, such as two fasteners 3035. Fasteners 3035 attach to the bottom centre post portion 3055 via both the middle centre post portion 3060 and the upper patch 3025. Fasteners 3035 may also assist in coupling the lower patch 3020 to the ground plane 3005. The two fasteners 3035 may be ISO 10642 M3x30-18N bolts, for example.

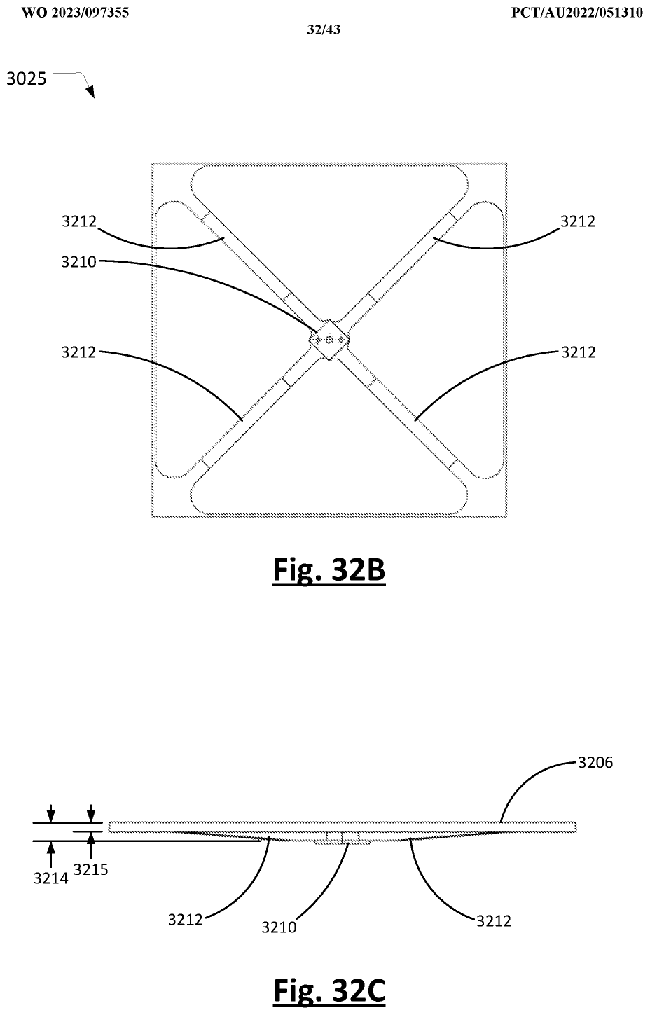

Antenna 2750 may be coupled to the plurality of front panels 2715 via fastening means, such as a plurality of fasteners 3045. The plurality of fasteners 3045 attach to the plurality of front panels 2715 via the ground plane 3005. The plurality of fasteners 3045 may be ISO 4762 M3x6-6N bolts, for example. The antenna 2750 may be coupled to the support structure 2800 and/or the front connecting panel 2720 via fastening means, such as a plurality of fasteners 3050. Fasteners 3050 attach to the support structure and/or the front connecting panel 2720 via attachment means, such as the bottom centre post portion 3055. In some embodiments, there may be four fasteners 3050. The fasteners 3050 may be ISO 4762 M3x20-20N bolts, for example. A fastener 3040 may further be used to couple the antenna 2750 to the support structure 2800 and/or the front connecting panel 2720. Fastener 3040 attaches to the support structure and/or the front connecting panel 2720 via attachment means, such as the bottom centre post portion 3055, the middle centre post portion 3060, and an upper centre post portion 3210 (FIG. 32B). The fastener 3040 may be ISO 4762 M5x50-22N bolt, for example.

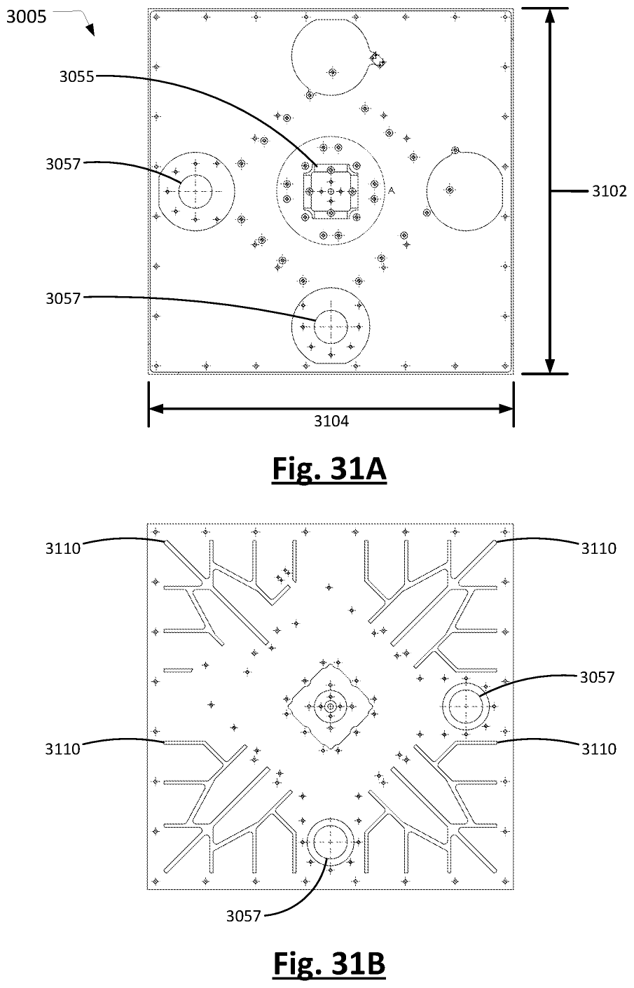

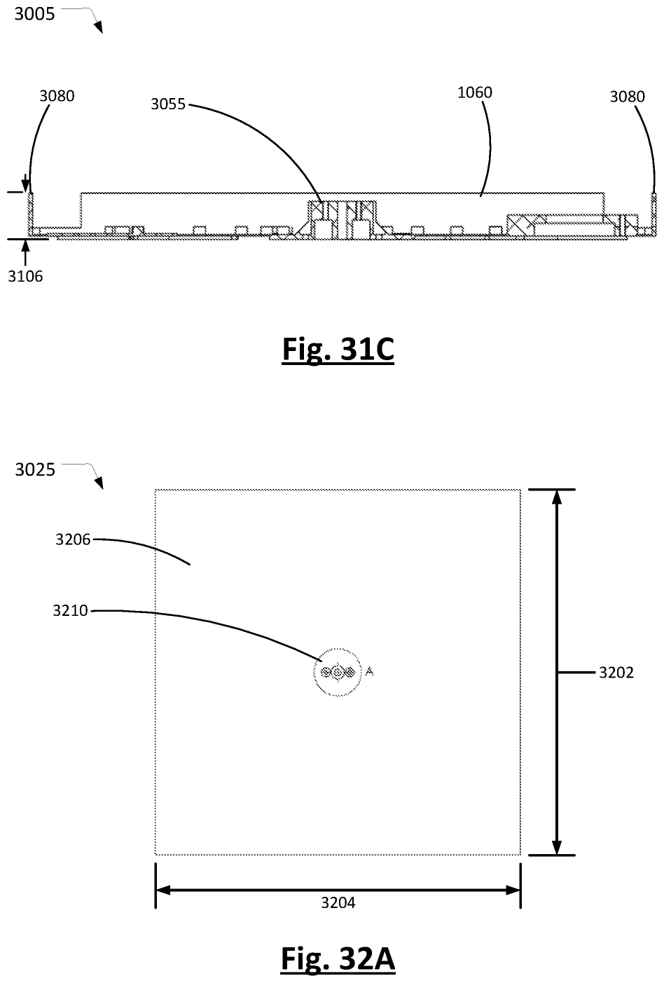

FIGS. 31A, 31B, and 31C show top, bottom, and side-section views, respectively, of the ground plane 3005. The ground plane 3005 has a length 3102. The ground plane 3005 has a width 3104. The ground plane 3005 has a height 3106. The length 3102 and the width 3104 may be approximately the same. The length 3102 may be between about 300 mm and about 450 mm, for example. The length 3102 may be about 340.2 mm, for example. The width 3104 may be between about 300 mm and about 450 mm, for example. The width 3104 may be about 340.2 mm, for example. The height 3106 may be between about 20 mm and about 30 mm, for example. The height 3106 may be about 25.26 mm, for example.

Referring to FIG. 31B, the ground plane 3005 further comprises a plurality of structural ribs 3110, for example in the form of branches. Structural ribs 3110 provide the ground plane 3005 with structural stability whilst also minimising weight. In some embodiments, ground plane 3005 may include four groups or sets of structural ribs 3110. The groups or sets of structural ribs 3110 may be arranged symmetrically on the bottom side of the ground plane 3005, for example.

FIGS. 32A, 32B, and 32C show top, bottom, and side-section views, respectively, of the upper patch 3025. The upper patch 3025 has a length 3202. The upper patch 3025 has a width 3204. The upper patch 3025 has a height 3214. The upper patch 3025 has a patch thickness 3215. The length 3202 and the width 3204 may be approximately the same. The length 3202 may be between about 250 mm and about 300 mm, for example. The length 3202 may be about 278 mm, for example. The width 3204 may be between about 250 mm and about 300 mm, for example. The width 3204 may be about 278 mm, for example. The height 3214 may be between about 20 mm and about 30 mm, for example. The height 3214 may be about 25 mm, for example. The patch thickness 3215 may be between about 4 mm and about 8 mm, for example. The patch thickness 3215 may be about 6 mm, for example.

Upper patch 3025 includes an outer radiating antenna surface 3206. The upper patch 3025 is configured such that the outer radiating antenna surface 3206 is directed away from the LEO satellite 2600. In some embodiments, the upper patch 3025 may be structurally reinforced by a plurality of structural rib portions 3212. The plurality of structural rib portions 3212 provide the upper patch 3025 with structural stability whilst also minimising weight. In some embodiments, the structural rib portions 3212 may be arranged symmetrically about the upper centre post portion 3210 on the non-radiating antenna surface of the upper patch 3025. In some embodiments, the structural rib portions 3212 extend diagonally across the approximate square shape of the upper patch 3025. In some embodiments, the structural rib portions 3212 may get thinner (taper) as they get further away from the upper centre post portion 3210.

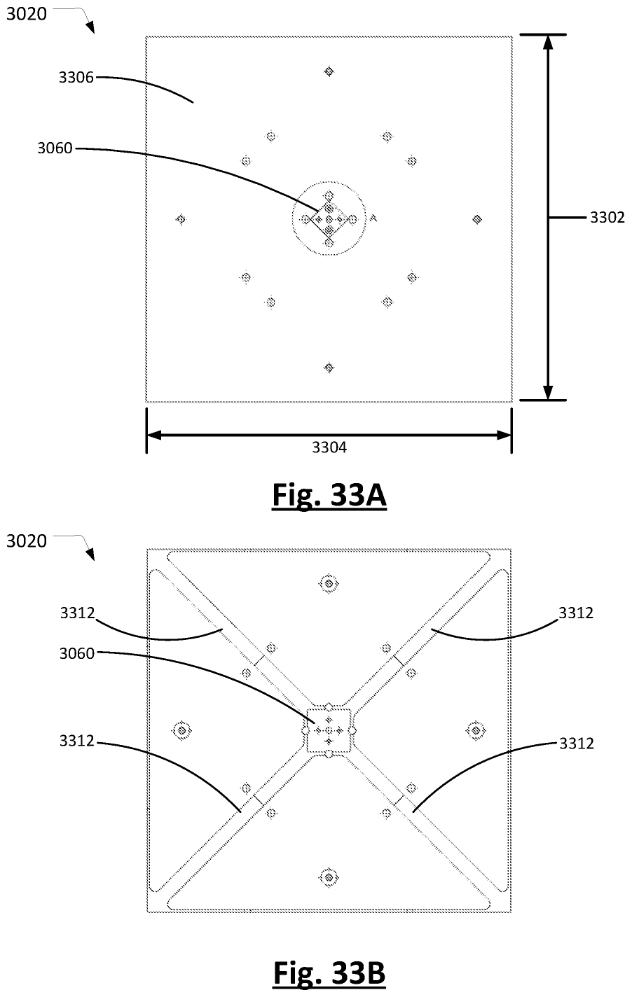

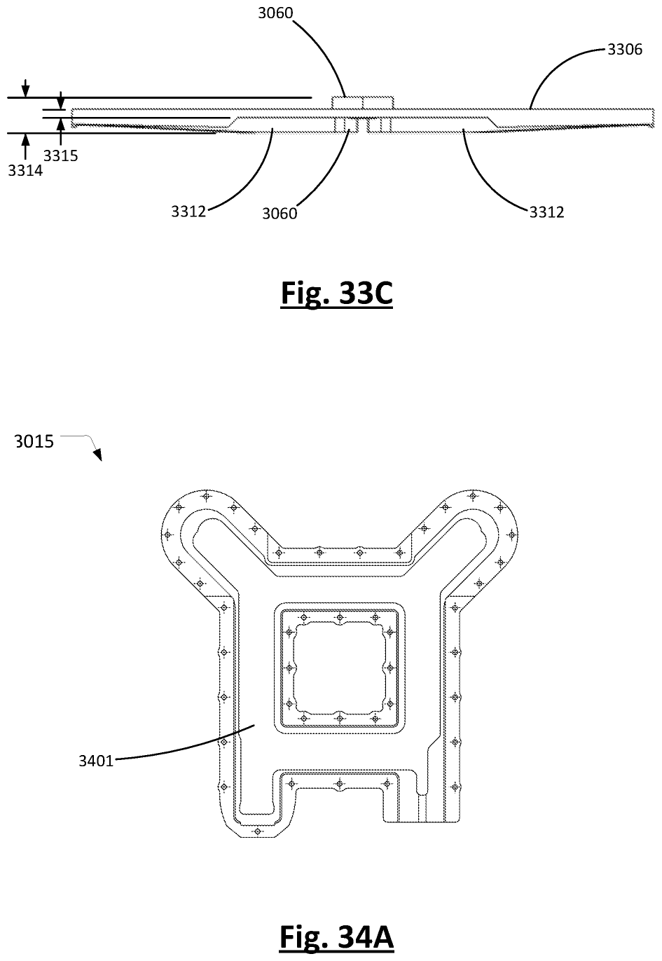

FIGS. 33A, 33B, and 33C show top, bottom, and side-section views, respectively, of the lower patch 3020. The lower patch 3020 has a length 3302. The lower patch 3020 has a width 3304. The lower patch 3020 has a height 3314. The lower patch 3020 has a patch thickness 3315. The length 3302 and the width 3304 may be approximately the same. The length 3302 may be between about 280 mm and about 344 mm, for example. The length 3302 may be about 312 mm, for example. The width 3304 may be between about 280 mm and about 344 mm, for example. The width 3304 may be about 312 mm, for example. The height 3314 may be between about 15 mm and about 23 mm, for example. The height 3314 may be about 19 mm, for example. The patch thickness 3315 may be between about 3 mm and about 7 mm, for example. The patch thickness 3315 may be about 5 mm, for example.

Lower patch 3020 includes a radiating antenna surface 3306. The lower patch 3020 is configured such that the radiating antenna surface 3306 is directed away from the LEO satellite 2600. In some embodiments, the lower patch 3020 may be structurally reinforced by a plurality of structural rib portions 3312. The plurality of structural rib portions 3312 provide the lower patch 3020 with structural stability whilst also minimising weight. In some embodiments, the rib structural portions 3312 may be arranged symmetrically about the middle centre post portion 3060 on the non-radiating antenna surface of the lower patch 3020. In some embodiments, the structural rib portions 3212 extend diagonally across the approximate square shape of the lower patch 3020. In some embodiments, the structural rib portions 3212 may get thinner (taper) as they get further away from the middle centre post portion 3060.

In some embodiments, patches 3020 and 3025 of antenna 2750 may have surface variations similar to those shown and described in relation to patch antennae elements 117. For example, patches 3020 and 3025 of antenna 2750 may have a corrugated surface. In other words, the patches of UHF antenna 2750 may have a substantially similar shape to the stacked patches shown and described in relation to FIGS. 10 and 11.

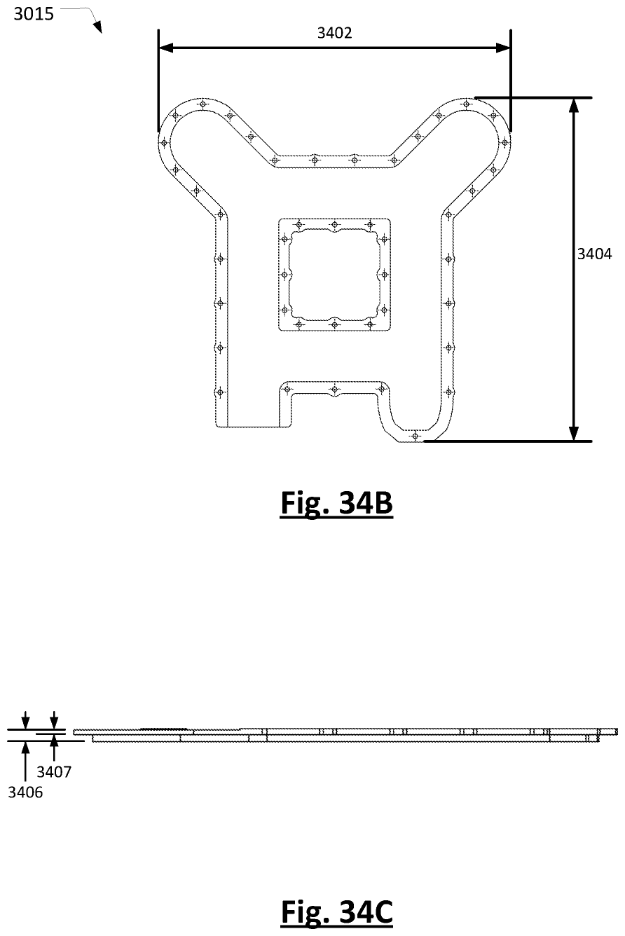

FIGS. 34A, 34B, and 34C show top, bottom, and side-section views, respectively, of the PCB cover 3015. The PCB cover 3015 has a length 3402. The PCB cover 3015 has a width 3404. The PCB cover 3015 has a height 3406. In some embodiments, the PCB cover 3015 may have an internal depth 3407. The internal depth 3407 may be the depth of a recessed portion 3401 of the PCB cover 3407. The length 3402 and the width 3404 may be approximately the same. The length 3402 may be about 238 mm, for example. The width 3304 may be about 232 mm, for example. The height 3314 may be about 5.5 mm, for example. The internal depth 3407 may be about 2.5 mm, for example.

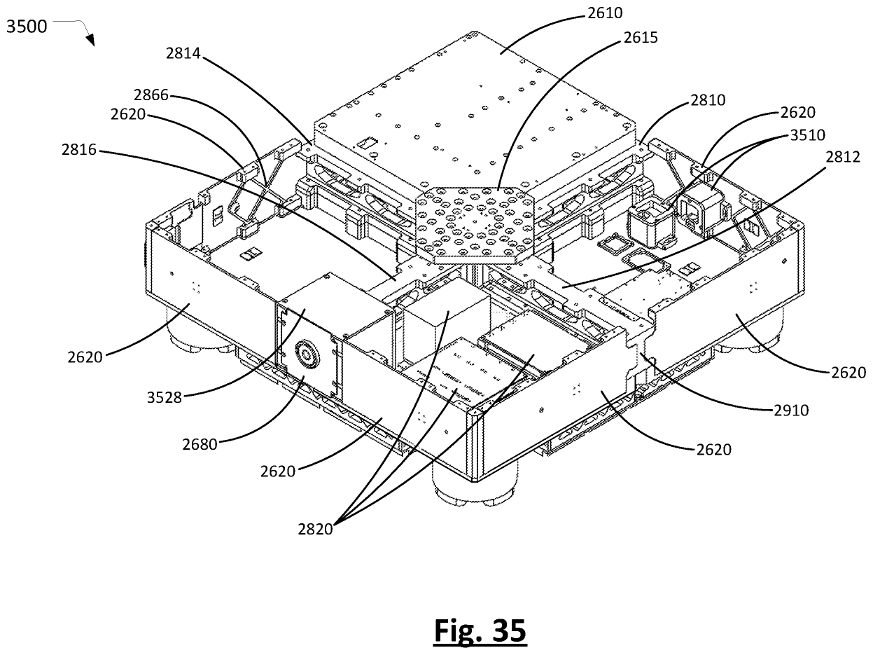

FIG. 35 shows a back perspective view of an alternate LEO satellite architecture of LEO satellite 110, according to some embodiments. The alternate LEO satellite architecture of LEO satellite 110 will be referred to as LEO satellite 3500 hereafter. In some embodiments, LEO satellite 3500 may be approximately the same shape, size, and weight as previously described embodiments of LEO satellite 110 and/or LEO satellite 2600. LEO satellite 3500 is similar to LEO satellite 110 and/or LEO satellite 2600 in its form factor and functions but has a modified internal and external support structure and has an alternative antenna arrangement.

The mass of the LEO satellite 3500 of various embodiments may be within a range of about 1 kg to about 100 kg, about 10 kg to about 90 kg, or about 20 kg or 25 kg to about 80 kg, or about 25 kg to about 40 kg, for example. The mass of the LEO satellite 3500 of various embodiments may be within a range of 25 kg to 50 kg, for example. Example masses further include 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 and 100 kg. A satellite with a mass between 10 kg to 100 kg may be referred to as a microsatellite. A satellite with a mass between 1 kg to 10 kg may be referred to as a nanosatellite.

In some embodiments, LEO satellite 3500 may further include a plurality of cameras 3510. Cameras 3510 may be mounted to either or both of a side panel 2620 or a front panel 2715. In some embodiments, LEO satellite 3500 may further include a propulsion mounting bracket 3528. Propulsion mounting bracket 3528 may be coupled to coupling plate 2920, for example. Propulsion mounting bracket 3528 may be used to improve the transfer of forces from the propulsion system 2680 to the support structure 2800, for example.

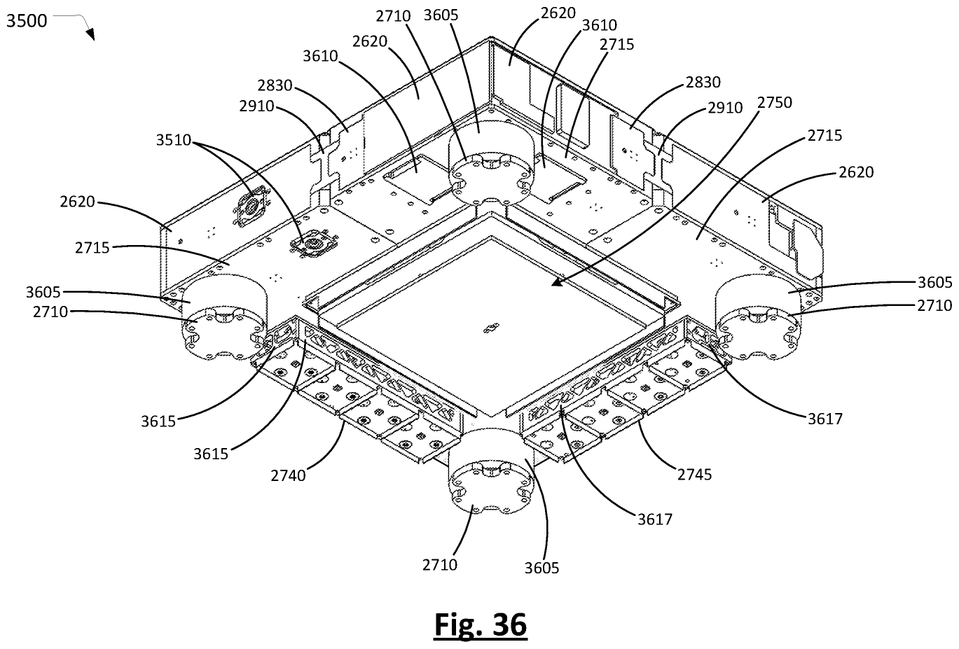

FIG. 36 shows a front perspective view of the LEO satellite 3500, according to some embodiments. FIG. 36 may only show the cup 1030 and ground plane of each antenna element 117 of the first antenna array 2740, however this is not intended to restrict any of the described embodiments. FIG. 36 may only show the cup 1030 and ground plane of each antenna element 117 of the second antenna array 2745, however this is not intended to restrict any of the described embodiments.

In some embodiments, LEO satellite 3500 may further include a first antenna mounting structure 3615 and a second antenna mounting structure 3617. The antenna mounting structures 3615, 3617 may be in the form of rails arranged in a rectangular shape. The first antenna mounting structure 3615 acts to distance the first antenna array 2740 from the outer surface defined by the front panels 2715. That is, the first antenna mounting structure 3615 protrudes from the outer surface defined by the front panels 2715, for example. The second antenna mounting structure 3617 acts to distance the second antenna array 2745 from the outer surface defined by the front panels 2715. That is, the second antenna mounting structure 3617 protrudes from the outer surface defined by the front panels 2715, for example.

In some embodiments, the first antenna mounting structure 3615 may protrude a distance (not shown) from the outer surface defined by the front panels 2715 so that an outer part of the first antenna array 2740 generally aligns with an outer surface of the upper patch 3025 of the antenna 2750. In some embodiments, the distance that the first antenna mounting structure 3615 protrudes from the outer surface defined by the front panels 2715 may be about 10 mm to about 35 mm, for example. In some embodiments, the distance that the first antenna mounting structure 3615 protrudes from the outer surface defined by the front panels 2715 may be about 15 mm to about 30 mm, for example. In some embodiments, the distance that the first antenna mounting structure 3615 protrudes from the outer surface defined by the front panels 2715 may be about 20 mm to about 25 mm, for example.

The distance that the first antenna mounting structure 3615 protrudes from the outer surface defined by the front panels 2715 may be about 20 mm, for example. In some embodiments, protrusion of the first antenna array 2740, from the outer surface defined by the front panels 2715, may reduce interference between the first antenna array 2740 and the antenna 2750.

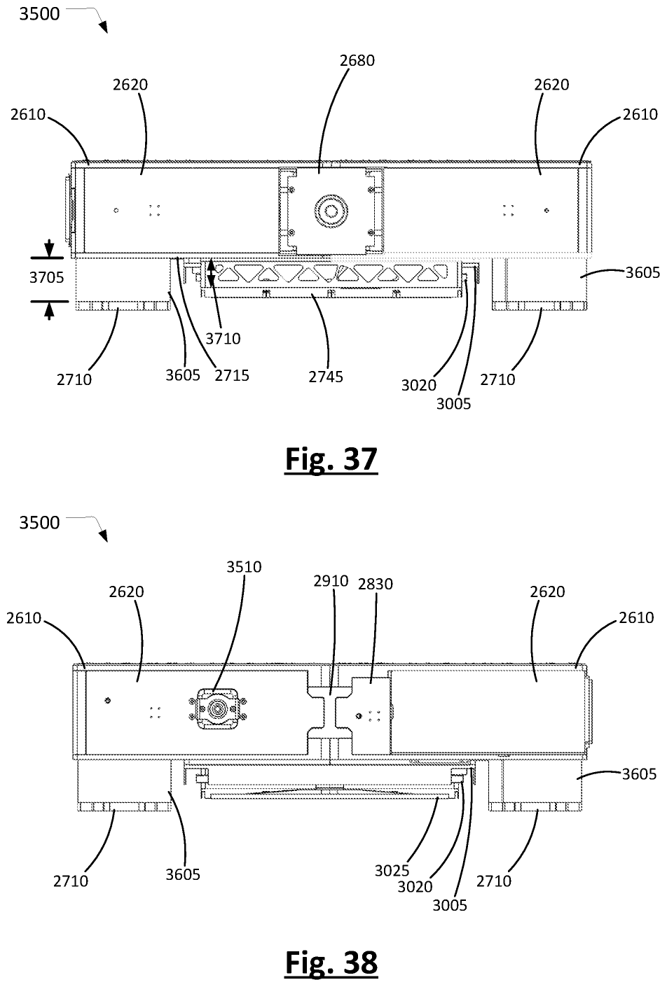

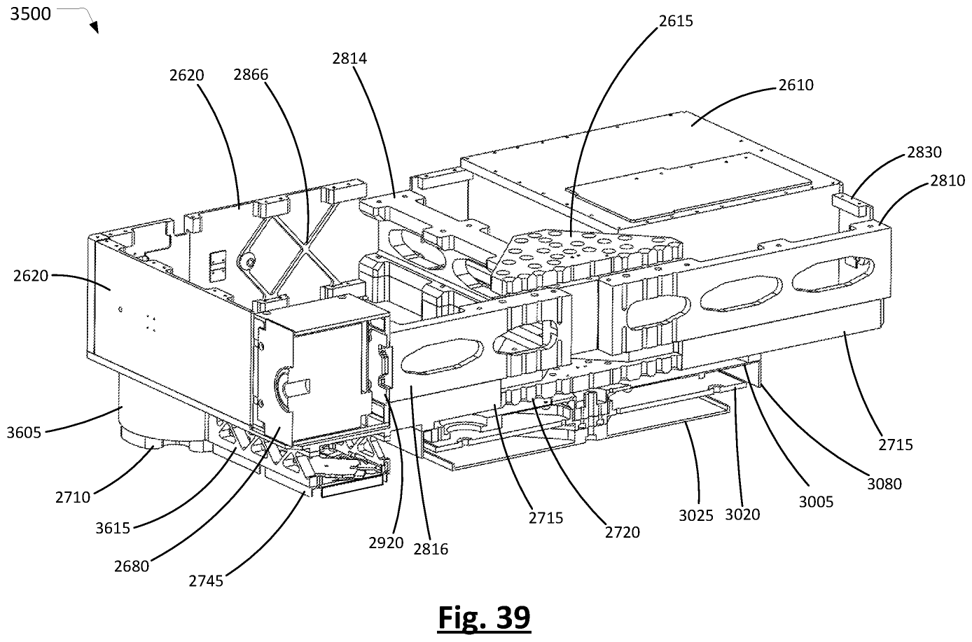

In some embodiments, the second antenna mounting structure 3617 may protrude a distance 3710 (FIG. 37) from the outer surface defined by the front panels 2715 so that the second antenna array 2745 aligns with the upper patch 3025 of the antenna 2750, as shown in FIG. 39. In some embodiments, the distance 3710 that the second antenna mounting structure 3617 protrudes from the outer surface defined by the front panels 2715 may be about 10 mm to about 35 mm, for example. In some embodiments, the distance 3710 that the second antenna mounting structure 3617 protrudes from the outer surface defined by the front panels 2715 may be about 15 mm to about 30 mm, for example. In some embodiments, the distance 3710 that the second antenna mounting structure 3617 protrudes from the outer surface defined by the front panels 2715 may be about 20 mm to about 25 mm, for example. The distance 3710 that the second antenna mounting structure 3617 protrudes from the outer surface defined by the front panels 2715 may be about 20 mm, for example.

In some embodiments, the distance that the first antenna mounting structure 3615 protrudes from the outer surface defined by the front panels 2715 may be about the same as the distance 3710 that the second antenna mounting structure 3617 protrudes from the outer surface defined by the front panels 2715, for example. In some embodiments, protrusion of the second antenna array 2745, from the outer surface defined by the front panels 2715, may reduce interference between the second antenna array 2745 and the antenna 2750.

In some embodiments, the first antenna mounting structure 3615 may protrude from the outer surface defined by the plurality of front panels 2715 such that the antenna 2750 is positioned proud of the first antenna array 2740. In some embodiments, the first antenna mounting structure 3615 may protrude from the outer surface defined by the plurality of front panels 2715 such that the first antenna array 2740 is positioned proud of the antenna 2750. In some embodiments, the second antenna mounting structure 3617 may protrude from the outer surface defined by the plurality of front panels 2715 such that the antenna 2750 is positioned proud of the second antenna array 2745. In some embodiments, the second antenna mounting structure 3617 may protrude from the outer surface defined by the plurality of front panels 2715 such that the second antenna array 2745 is positioned proud of the antenna 2750.

In some embodiments, the first antenna array 2740 and the second antenna array 2745 of the LEO satellite 3500 may be arranged to each have a long axis that extends at right angles to each other. That is, the long axis of the first antenna array 2740 and the long axis of the second antenna array 2745 of the LEO satellite 3500 may be positioned at a 90° angle to one another, for example. In some embodiments, the first antenna array 2740 of the LEO satellite 3500 is positioned adjacent to the antenna 2750. In some embodiments, the second antenna array 2745 of the LEO satellite 3500 is positioned adjacent to the antenna 2750, for example.

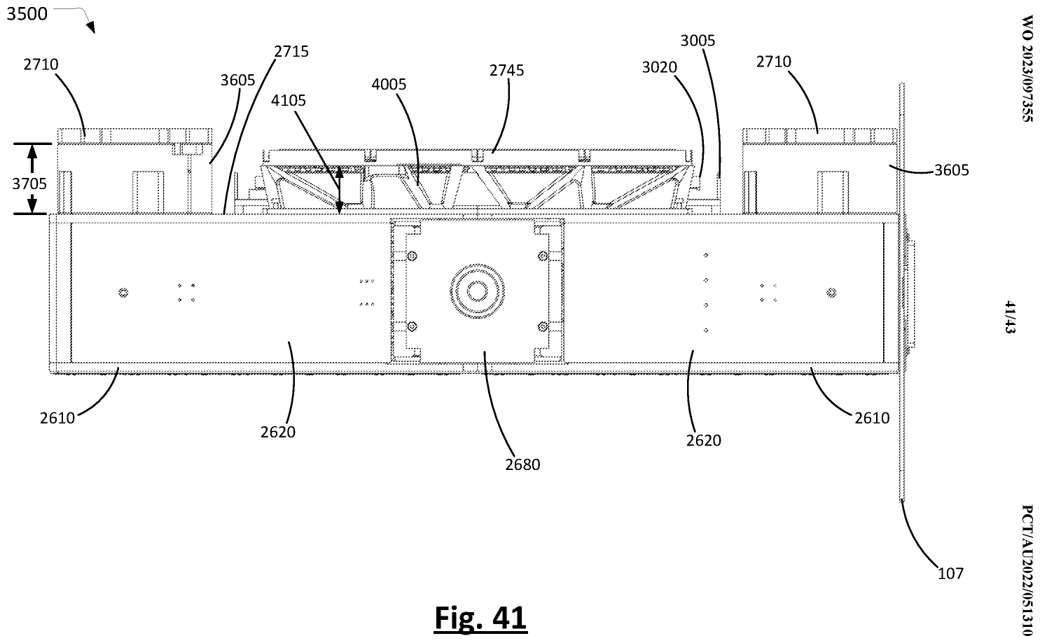

In some embodiments, LEO satellite 3500 further includes a plurality of mounting point spacers 3605. The plurality of mounting point spacers 3605 act to distance the plurality of mounting points 2710 from the outer surface defined by the plurality of front panels 2715. Referring to FIG. 37 and FIG. 41, the plurality of mounting point spacers 3605 have a height 3705. In some embodiments, the height 3705 may be set such that the mounting points 2710 are proud of the various components disposed on the outer surface defined by the front panels 2715, such as the antenna 2750 (as shown in FIGS. 37 and 38), for example. The height 3705 may be about 10 mm to 50 about mm, for example. The height 3705 may be about 15 mm to about 45 mm, for example. The height 3705 may be about 20 mm to about 40 mm, for example. The height 3705 may be about 25 mm to about 35 mm, for example. The height 3705 may be about 20 mm, for example.

In some embodiments, LEO satellite 3500 further includes at least one patch antenna 3610. The at least one patch antenna 3610 may be disposed on the surface of at least one of the plurality of front panels 2715, for example. In some embodiments, the at least one patch antenna 3610 may be coupled directly to the surface of the at least one of the plurality of front panels 2715. In some embodiments, the at least one patch antenna 3610 may be substantially flat. In some embodiments, the LEO satellite 3500 includes two patch antennas 3610. The at least one patch antenna 3610 may be positioned on a different front panel 2715 of the plurality of front panels 2715 to the first antenna array 2740 and the second antenna array 2745. That is, the at least one patch antenna 3610 may be positioned adjacent to a different side of the antenna 2750 to the first antenna array 2740 and the second antenna array 2745, for example. In some embodiments, the at least one patch antenna 3610 may be an S band patch antenna.

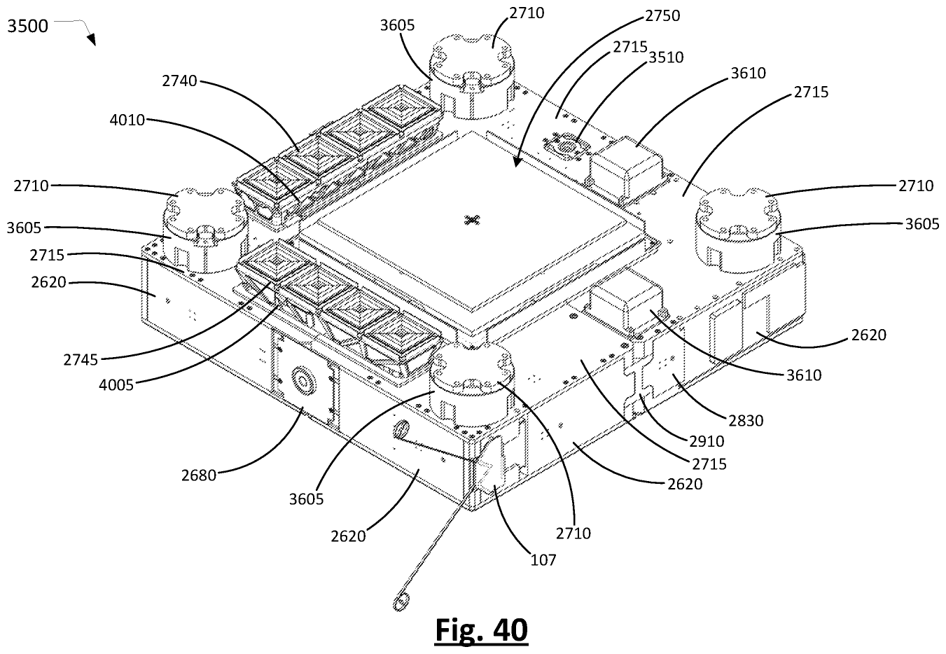

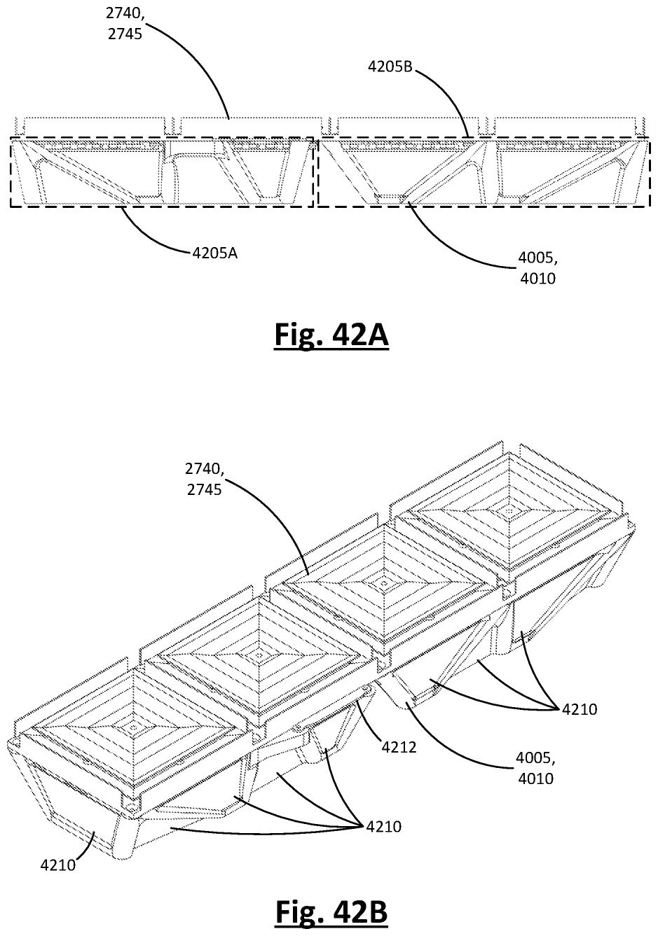

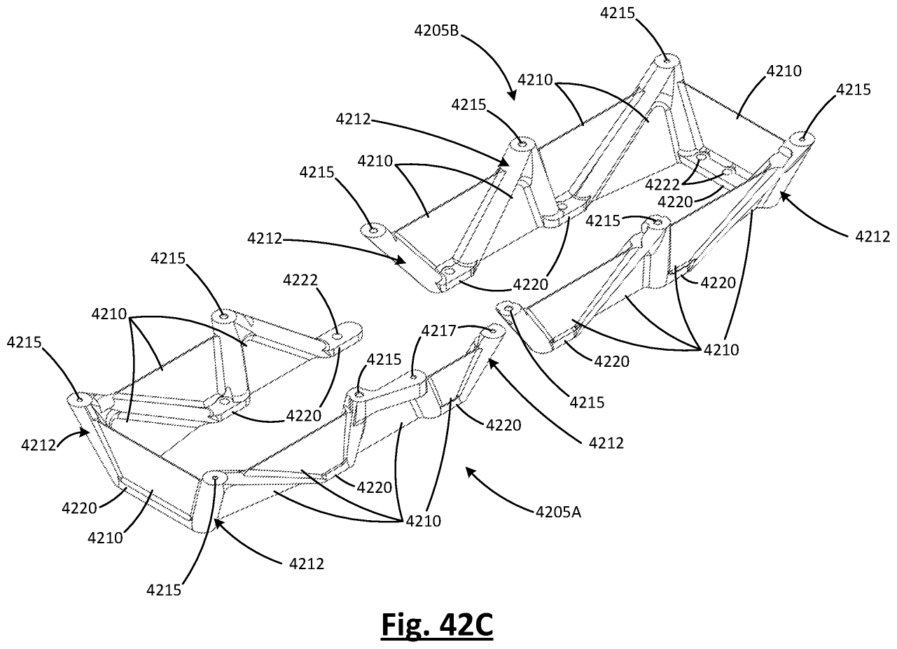

FIG. 40 shows an alternate front perspective view of the LEO satellite 3500, according to some embodiments. LEO satellite 3500 of FIG. 40 may further comprise antenna mounting structure 4005 for mounting the first antenna array 2740 or the second antenna array 2745 to the front panel 2715 outer surface. LEO satellite 3500 of FIG. 40 may further comprise antenna mounting structure 4010 for mounting the first antenna array 2740 or the second antenna array 2745 to the front panel 2715 outer surface. FIGS. 42A, 42B, and 42C show a side view, a perspective view, and an alternate perspective view, respectively, of the antenna mounting structures 4005, 4010. The antenna mounting structures 4005, 4010 may function similarly to the antenna mounting structure 3615, 3617, as previously described. The antenna mounting structures 4005, 4010 may be in the form of rails arranged in a somewhat rectangular shape or having an approximately rectangular footprint.

In some embodiments, the antenna mounting structures 4005, 4010 may each comprise a first antenna mounting portion 4205A and a second antenna mounting portion 4205B. The first antenna mounting portion 4205A and the second antenna mounting portion 4205B may be structurally separate from one another even while such portions are coupled to the first antenna array 2740 or the second antenna array 2745. In some embodiments, the antenna mounting structures 4005, 4010 may be formed in multiple pieces, such as two pieces, optionally two different pieces. That is, each antenna mounting portion 4205A, 4205B of the antenna mounting structures 4005, 4010 may be manufactured separately from one another, for example. The antenna mounting portions 4205A, 4205B may each have a shape that is different from the other.

The antenna mounting structure 4005 acts to distance the first antenna array 2740 from the outer surface defined by the front panels 2715. That is, the antenna mounting structure 4005 protrudes from the outer surface defined by the front panels 2715, for example. The antenna mounting structure 4010 acts to distance the second antenna array 2745 from the outer surface defined by the front panels 2715. That is, the antenna mounting structure 4010 protrudes from the outer surface defined by the front panels 2715, for example.

In some embodiments, the antenna mounting structure 4005 may protrude a distance 4105 (FIG. 41) from the outer surface defined by the front panels 2715 so that the second antenna array 2745 aligns with the upper patch 3025 of the antenna 2750, as shown in FIG. 41. In some embodiments, the distance 4105 that the antenna mounting structure 4005 protrudes from the outer surface defined by the front panels 2715 may be about 10 mm to about 35 mm, for example. In some embodiments, the distance 4105 that the antenna mounting structure 4005 protrudes from the outer surface defined by the front panels 2715 may be about 15 mm to about 30 mm, for example. In some embodiments, the distance 4105 that the antenna mounting structure 4005 protrudes from the outer surface defined by the front panels 2715 may be about 20 mm to about 25 mm, for example.

The distance that the antenna mounting structure 4005 protrudes from the outer surface defined by the front panels 2715 may be about 20 mm, for example. In some embodiments, protrusion of the first antenna array 2740, from the outer surface defined by the front panels 2715, may reduce interference between the first antenna array 2740 and the antenna 2750.

In some embodiments, the antenna mounting structure 4010 may protrude a distance (not shown) from the outer surface defined by the front panels 2715 so that an outer part of the first antenna array 2740 generally aligns with an outer surface of the upper patch 3025 of the antenna 2750. In some embodiments, the distance that the antenna mounting structure 4010 protrudes from the outer surface defined by the front panels 2715 may be about 10 mm to about 35 mm, for example. In some embodiments, the distance that the antenna mounting structure 4010 protrudes from the outer surface defined by the front panels 2715 may be about 15 mm to about 30 mm, for example. In some embodiments, the distance that the antenna mounting structure 4010 protrudes from the outer surface defined by the front panels 2715 may be about 20 mm to about 25 mm, for example. The distance that the antenna mounting structure 4010 protrudes from the outer surface defined by the front panels 2715 may be about 20 mm, for example.

In some embodiments, the distance 4105 that the antenna mounting structure 4005 protrudes from the outer surface defined by the front panels 2715 may be about the same as the distance that the antenna mounting structure 4010 protrudes from the outer surface defined by the front panels 2715, for example. In some embodiments, protrusion of the second antenna array 2745, from the outer surface defined by the front panels 2715, may reduce interference between the second antenna array 2745 and the antenna 2750.

In some embodiments, the antenna mounting structure 4005 may protrude from the outer surface defined by the plurality of front panels 2715 such that the antenna 2750 is positioned proud of the first antenna array 2740. In some embodiments, the antenna mounting structure 4005 may protrude from the outer surface defined by the plurality of front panels 2715 such that the first antenna array 2740 is positioned proud of the antenna 2750. In some embodiments, the antenna mounting structure 4010 may protrude from the outer surface defined by the plurality of front panels 2715 such that the antenna 2750 is positioned proud of the second antenna array 2745. In some embodiments, the antenna mounting structure 4010 may protrude from the outer surface defined by the plurality of front panels 2715 such that the second antenna array 2745 is positioned proud of the antenna 2750.

In some embodiments, the antenna mounting structures 4005, 4010 may include a plurality of solid and continuous antenna support walls 4210 extending between thickened support rib portions 4212, where webbing material of the antenna mounting structure 4005, 4010 are included. That is, portions of the structure of the antenna mounting structures 4005, 4010 are included, for example. The thickened support rib portions 4212 may provide the main structural strength of the antenna mounting structures 4005, 4010. The plurality of antenna support walls 4210 may provide stiffness to the antenna mounting structures 4005, 4010, and may shield cables from radiation and debris, for example. In some embodiments, the antenna mounting structures 4005, 4010 may include a plurality of ‘cut-outs’ where webbing material of the antenna mounting structures 4005, 4010 is omitted. That is, portions of the structure of the antenna mounting structures 4005, 4010 may be omitted, for example. The plurality of cut-outs may reduce the weight of the antenna mounting structures 4005, 4010 whilst also maintaining its structural integrity.

In some embodiments, the antenna mounting structures 4005, 4010 may include or define a plurality of threaded holes 4215 embedded in a top surface of some or each of the thickened support rib portions 4212. The plurality of threaded holes 4215 may be used to couple the antenna arrays 2740, 2745 to their respective antenna mounting structures 4005, 4010. That is, the plurality of threaded holes 4215 may be used to couple the first antenna array 2740 and the second antenna array 2745 to the top surface of the antenna mounting structures 4005, 4010, respectively, via a plurality of fasteners. In some embodiments, the antenna mounting structures 4005, 4010 may include a plurality of base ribs or plates 4220. Each base rib or plate 4220 may include or define at least one hole 4222 (not all shown) to facilitate coupling of the antenna mounting structures 4005, 4010 to the LEO satellite 3500. That is, the plurality of base ribs or plates 4220 may be used to couple the antenna mounting structures 4005, 4010 to the plurality of front panels 2715, via the at least one hole of each base rib or plate 4220 and a plurality of fasteners. Each base rib or plate 4220 may couple to and extend between two thickened support rib portions 4212.

In some embodiments, the antenna mounting structures 4005, 4010 may further comprise a side plate 4212. The side plate 4212 may be coupled to the first antenna mounting portion 4205A via at least two threaded holes 4217 embedded in the top surface of the antenna mounting structures 4005, 4010 and at least two fasteners. In some embodiments, the side panel 4212 may support or accommodate a tuning element 1702.

In some embodiments, the antenna mounting structures 4005, 4010 may provide atomic oxygen protection to various components of the LEO satellite 3500. That is, the antenna mounting structures 4005, 4010 may provide components such as the antenna cables of the plurality of front panels 2715 with protection from oxygen erosion, for example.

In some embodiments, the satellite 110, 2600 or 3500 may be configured for deployment into low Earth orbit. In some embodiments, the satellite 110, 2600 or 3500 may be configured for deployment into Earth's orbit. In some embodiments, the satellite 110, 2600 or 3500 may be configured for deployment beyond Earth's orbit. Configuration for Earth or beyond Earth orbits will need to account for variations in required thermal characteristics and communications performance.

Some embodiments relate to a method for forming an antenna patch body, including transmitting to a 3D printer a print model executable by the 3D printer to print the antenna patch body. Alternate embodiments include a method for forming multiple antenna patch bodies, or an antenna body array, including transmitting to a 3D printer a print model executable by the 3D printer to print an array of antenna patch bodies.

Some embodiments relate to a method for forming an antenna array, including transmitting to a 3D printer a print model executable by the 3D printer to print the antenna array. In alternate embodiments, the antenna array is 3D printed in its entirety, for example. In alternate embodiments, the various components of the antenna array are 3D printed separately and assembled to form the antenna array in its entirety, for example. In alternate embodiments, various elements of the antenna array are 3D printed and assembled in combination with non 3D printed elements, for example.

In some embodiments, various structural components of the LEO satellite 110 may be 3D printed. The chassis of the LEO satellite 110 may be 3D printed, for example. Examples of components that may be 3D printed may further include housing panels, solar panels or panel substrates, and electronic circuit boards.

Some embodiments relate to a method for providing a satellite communication service, comprising providing a LEO satellite of any one of the embodiments as a payload to a satellite launch vehicle.

Some embodiments relate to a method for providing a satellite communication service, comprising launching the satellite launch vehicle configured to release the LEO satellite of any one of the embodiments for travel in a low Earth orbit.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A small satellite, including:
a satellite body having a rectangular tile shape, with a substantially flat front side having a length and width and being separated from a substantially parallel back side by a depth, wherein the depth is equal to or less than a third of the length and the width;
an antenna array on the front side; and
a solar array including at least one solar panel extendable from the back side in a generally lateral direction.

2. The satellite of claim 1, wherein the at least one solar panel is extendable from the back side in a direction generally parallel to a plane of the front side.

3. The satellite of claim 1, wherein the at least one solar panel includes multiple solar panels, wherein the multiple solar panels include a first wing extendable from a first lateral side of the back side and a second wing extendable from an opposite second lateral side of the back side; and
wherein each of the first and second wings included at least one solar panel.

4. (canceled)

5. The satellite of claim 3, wherein the first wing is configured to lie over the back side when the first wing is in a stowed position and the second wing is configured to lie over the back side when the second wing is in a stowed position; and
wherein the first wing is configured to lie over the second wing when the first wing and the second wing are in the stowed position.

6. (canceled)

7. The satellite of claim 3, wherein in an extended position of the first wing and the second wing, the first wing and the second wing extend generally laterally from the back side.

8. (canceled)

9. The satellite of claim 1, wherein the solar array includes a solar panel fixed to the back side and wherein, in a non-extended position of the solar array, one solar panel faces away from the satellite body.

10. (canceled)

11. The satellite of claim 1, wherein one or more of:
the antenna array includes a patch antenna array;
wherein the patch antenna array includes between 4 and 625 patch antennas;
wherein each patch antenna has a corrugated patch configuration; or
wherein each patch antenna is a cupped stacked patch antenna.

12-14. (canceled)

15. The satellite of claim 1, wherein the antenna array covers substantially a whole of the front side.

16. The satellite of claim 1, wherein one or more of:
the depth of the satellite body is between about 90 mm and about 220 mm;
wherein the length of the satellite body is between about 270 mm and about 1050 mm; or
wherein the wirth of the satellite body is between about 270 mm and about 1050 mm.

17-20. (canceled)

21. The satellite of claim 1, further including a microsatellite or nanosatellite chassis housing at least one processor, a memory accessible to the at least one processor, the memory storing an orbital schedule of the LEO satellite, and a communication sub-system accessible to the at least one processor;
wherein the communication sub-system comprises a reconfigurable digital logic processing device in communication with the antenna array;
wherein the at least one processor is in communication with the reconfigurable digital logic processing device, and
wherein the at least one processor is configured to dynamically reconfigure the reconfigurable digital logic processing device to perform directional beamforming based on the orbital schedule by applying different transfer functions to signals simultaneously received or transmitted by multiple antenna elements of the antenna array over time.

22. The satellite of claim 21, wherein one or more of:
the at least one processor is configured to perform directional beamforming using all antenna elements of the antenna array simultaneously;
wherein the at least one processor is further configured to dynamically reconfigure the reconfigurable digital logic processing device to perform directional beam-nulling based on the orbital schedule by applying different transfer functions to signals received and transmitted by multiple antenna elements of the antenna array over time;
wherein the directional beamforming and/or beam-nulling is performed simultaneously across multiple frequency channels; or
wherein the directional beamforming and/or beam-nulling is performed simultaneously in multiple different directions.

23-25. (canceled)

26. The satellite of claim 21, wherein the orbital schedule data comprises one or more antenna array configuration records, each antenna array configuration record comprising:
an ephemeris record indicating a scheduled position of the LEO satellite in orbit over a period of time; and
array factor coefficients associated with each of the two or more antenna elements defined in relation to the ephemeris record.

27. The satellite of claim 21, further comprising a signal channeliser for channelising signals before processing by the reconfigurable digital logic processing device; and/or
wherein the reconfigurable digital logic processing device comprises a Field Programmable Gate Array (FPGA).

28. (canceled)

29. The satellite of claim 21, wherein when the satellite receives signals from multiple directions of interest, the at least one processor dynamically reconfigures the reconfigurable digital logic processing device to level amplitudes of signals received from the multiple directions of interest; and wherein when the satellite transmits signals to multiple directions of interest, the at least one processor dynamically reconfigures the reconfigurable digital logic processing device to level amplitudes of signals transmitted to the multiple directions of interest.

30. The satellite of claim 1, wherein the satellite has a mass in the range of 5 kg to 500 kg.

31. (canceled)

32. The satellite of claim 1, wherein the satellite is configured for deployment into low Earth orbit.

33. (canceled)

34. A method for providing a satellite communication service, including:
providing the satellite of claim 1 as a payload to a satellite launch vehicle.

35-57. (canceled)

58. A small satellite, including:
a satellite body having a rectangular tile shape, with a substantially flat front side having a length and width and being separated from a substantially parallel back side by a depth, wherein the depth is equal to or less than a third of the length and the width;
an antenna on the front side, wherein the antenna occupies 50% to 75% of the surface area of the front side; and
a solar panel on the back side.

59-65. (canceled)

66. A small satellite, including:
a satellite body having a rectangular tile shape, with a substantially flat front side having a length and width and being separated from a substantially parallel back side by a depth, wherein the depth is equal to or less than a third of the length and the width;
a support structure having a cross-like shape, the support structure including a plurality of support beams and a first connecting panel and a second connecting panel coupled to the plurality of support beams;
a plurality of antennae on the front side; and
a solar panel on the back side.

67-73. (canceled)

74. A small satellite, including:
a housing containing satellite electronic components for controlling operation of the small satellite, the housing comprising a chassis and defining a first major face having a length and a width, a second major face opposite the first major face having the same length and the same width, and four minor side faces extending between the first and second major faces by a depth, wherein the depth is equal to or less than a third of the length and the width;
a first antenna array, a second antenna array, and a third antenna array spatially separated from each other on the first major face; and
a solar panel on the second major face.

75-117. (canceled)
